(19) United States
(12) Patent Application Publication
(10) Pub. No.: US 2012/0044722 A1
(43) Pub. Date: Feb. 23, 2012

(54) ISOLATED SWITCHING CONVERTER

(76) Inventor: SLOBODAN CUK, LAGUNA NIGUEL, CA (US)

(21) Appl. No.: 13/031,596

(22) Filed: Feb. 21, 2011

Related U.S. Application Data
(60) Provisional application No. 61/275,701, filed on Feb. 23, 2010.

(51) Int. Cl. H02M 3/335

(52) U.S. Cl. 363/21.03

(57) ABSTRACT

The isolated voltage step-down switching DC-DC converter has one magnetic component, the isolation transformer, and two small size resonant inductors. The transformer is built on a magnetic core with no air-gap, hence no DC storage and thus results in fast load transient response. Two active switches on the primary side have voltage stresses equal to input voltage and two current rectifiers on secondary side have voltage stresses equal to output DC voltage under all operating duty ratio conditions. The converter operates with two independent resonance's, one coinciding with the ON-time interval and the other coinciding with the OFF-time interval resulting in all switches being turned ON and turned OFF at zero current. Primary side high voltage switches operate with zero-voltage switching for all load currents. Despite the two resonance's, the output voltage is controlled by use of the variable duty ratio, constant switching frequency PWM method.

### CROSS-REFERENCE TO RELATED APPLICATIONS

### Field of Invention

The general field of invention is switching PWM DC-DC converters and Resonant DC-DC converters with isolation and step-down DC voltage gain.

The present invention uses also in a novel resonant way the capacitive energy storage and transfer first introduced in (1, 2). The classical, so called true resonant converters, are covered in detail in (3). The resonant conversion using resonant switches is investigated in (4). Finally, Quasi-Resonant switching converters are analyzed thoroughly in (5).

The present invention opens up a new category of isolated DC-DC converter topology with only one magnetic component, the isolation transformer, and with no inductors. The isolation transformer does not store any DC energy at any operating duty ratio point as opposed to presently known isolated DC-DC converters which do store DC energy in either transformer or the inductors, or in both.

The present invention also marks a new type of converter topologies which uses new methods of resonant conversion with two independent and well defined resonance's: one resonance is started and completed during the ON-time interval, while the other resonance is started and completed during the OFF-time interval. Despite the two resonance's, the control method is based on constant switching frequency and variable duty ratio control in direct contrast to variable switching frequency method of other presently know resonant DC-DC conversion methods.

### Definitions and Classifications

The following notation is consistently used throughout this text in order to facilitate easier delineation between various quantities:
1. DC—Shorthand notation historically referring to Direct Current but by now has acquired wider meaning and refers generically to circuits with DC quantities;
2. AC—Shorthand notation historically referring to Alternating Current but by now has acquired wider meaning and refers to all Alternating electrical quantities (current and voltage);
3. i₁, v₂—The instantaneous time domain quantities are marked with lower case letters, such as i₁ and v₂ for current and voltage;
4. I₁, V₂—The DC components of the instantaneous periodic time domain quantities are designated with corresponding capital letters, such as I₁ and V₂;
5. ΔV—The AC ripple voltage on resonant capacitor Cᵣ;
6. f_{S}—Switching frequency of converter;
7. T_{S}—Switching period of converter inversely proportional to switching frequency f_{S};
8. T_{ON}—ON-time interval T_{ON}=DT_{S} during which switch S is turned-ON;
9. T_{OFF}—OFF-time interval T_{OFF}=D′T_{S} during which switch S is turned-OFF;
10. S₁—Controllable switch with two switch states: ON and OFF;
11. D—Duty ratio of the main controlling switch S;
12. S₂—switch which operates in complementary way to switch S: when S is closed S₂ is open and opposite, when S is open S₂ is dosed;
13. D′—Complementary duty ratio D′=1−D of the switch S complementary to main controlling switch S;
14. fᵣ—Resonant switching frequency defined by resonant inductor Lᵣ and resonant capacitor Cᵣ;
15. Tᵣ—Resonant period defined as Tᵣ=1/fᵣ;
16. tᵣ—One half of resonant period Tᵣ;
17. CR₁—Two-terminal Current Rectifier whose ON and OFF states depend on controlling S₁ switch states and resonant conditions.
18. CR₂—Two-terminal Current Rectifier whose ON and OFF states depend on controlling S₂ switch states and resonant conditions.
19. The quadrant definition of the switches is given in FIG. 2a-e.

### BRIEF DESCRIPTION OF THE DRAWINGS

FIG. 1a shows a prior-art buck converter, FIG. 1b illustrates the state of the switches for the buck converter of FIG. 1a, and FIG. 1c shows DC voltage gain characteristic of the buck converter of FIG. 1a.

FIG. 2a shows ideal four-quadrant mechanical switch which can conduct current of either direction and block the voltage of either polarity, FIG. 2b shows a bipolar active three-terminal electronic switch implanted as an NPN bipolar transistor or MOSFET operating in the first quadrant, FIG. 2c shows one-quadrant switch implemented by a two-terminal passive device current rectifier CR (diode) operating in second quadrant, FIG. 2d shows a two-quadrant Current Bi-directional switch operated in first and fourth quadrant implemented with a single MOSFET switch and internal body diode, and FIG. 2e shows a two-quadrant Voltage Bi-directional switch (VBS) operating in first and second quadrant and implemented as a composite switch, consisting of a series connection of a transistor (bipolar or MOSFET) and the current rectifier (diode).

FIG. 3a shows inductor current of the buck converter in FIG. 1a, and FIG. 3b illustrates inductor current transient from 25% load to 100% load current for the buck converter of FIG. 1a.

FIG. 4a shows a magnetic core with the air-gap needed for inductor of buck converter in FIG. 1a, and FIG. 4b shows the inductor current with DC-bias and corresponding flux linkages.

FIG. 5a illustrates the volt-second requirements for the inductor of the buck converter in FIG. 1a and FIG. 5b shows the volt-seconds as a function of the duty ratio D.

FIG. 6a shows the prior-art forward converter, FIG. 6b shows DC voltage gain characteristic of the forward converter of FIG. 6a, and FIG. 6c shows the AC flux per turn and relative to output voltage V as a function of the duty ratio D.

FIG. 7a shows the voltage stress of primary side switches relative to input DC voltage with shaded area indicating preferred operating range for the forward converter of FIG. 6a, and FIG. 7b shows the voltage stress of secondary side switches relative to output DC voltage for the forward converter of FIG. 6a with shaded area indicating a preferred lower voltage stress operating region.

FIG. 8a illustrates a prior-art asymmetric half bridge converter, and FIG. 8b shows the DC voltage gain characteristic for the converter of FIG. 8a.

FIG. 9a shows the currents' directions in current rectifiers and output inductor on the secondary side of the isolation transformer, FIG. 9b illustrates the voltage waveforms on current rectifiers of FIG. 9a, and FIG. 9c illustrates the current waveforms through current rectifiers of FIG. 9a

FIG. 10a illustrates a primary side of the prior-art full-bridge converter, FIG. 10b illustrates a primary side of prior-art half-bridge converter, and FIG. 10c illustrates a primary side of prior-art push-pull (center-tap) converter.

FIG. 11a illustrates the state of the switches for the regulated full-bridge converter of FIG. 10a, and FIG. 11b illustrates the state of the switches for the regulated half-bridge and push-pull (center-tap) converters of FIG. 10b and FIG. 10c.

FIG. 12a illustrates the secondary side single-sided rectification with two current rectifiers, FIG. 12b illustrates the center-tap secondary side of the isolation transformer with two current rectifiers, FIG. 12c illustrates the secondary side of the isolation transformer with four current rectifiers for full-bridge rectification.

FIG. 13a illustrates the state of the switches with fixed 50% duty ratio for the full-bridge converter of FIG. 10a, and FIG. 13b illustrates the state of the switches with fixed 50% duty ratio for the half-bridge and center-tap converters of FIG. 10b and FIG. 10c.

FIG. 14a illustrates the center-tap configuration with two current rectifiers and without output inductor on the secondary side of the isolation transformer, and FIG. 14b illustrates the full-bridge configuration without output inductor on the secondary side of the isolation transformer.

FIG. 15a illustrates the first embodiment of the present invention, and FIG. 15b illustrates the states of two controllable switches and two current rectifiers for the converter of FIG. 15a.

FIG. 16a illustrates another embodiment of the present invention, and FIG. 16b shows the DC voltage gain characteristic of converters in FIG. 15a and FIG. 16a as a function of variable duty ratio D of switch S₁.

FIG. 17a shows that voltage stress on primary side switches does not change with duty ratio D and does not exceed the input voltage in the converters of FIG. 15a and FIG. 16a, and FIG. 17b shows that voltage stress on secondary side switches does not change with duty ratio D and does not exceed the output voltage in the converters of FIG. 15a and FIG. 16a.

FIG. 18a illustrates the circuit configuration of converter in FIG. 17c when switch S₁ is turned ON and switch S₂ is turned OFF, FIG. 18b illustrates an equivalent AC circuit model of configuration in FIG. 18a, FIG. 18c illustrates further simplified equivalent AC circuit of FIG. 18b, and FIG. 18d illustrates a final resonant circuit model of configuration in FIG. 18c.

FIG. 19a illustrates the circuit configuration of converter in FIG. 17c when switch S₁ is turned-OFF and switch 5₂ is turned-ON, FIG. 19b illustrates an equivalent AC circuit model of configuration in FIG. 19a, FIG. 19c illustrates further simplified equivalent AC circuit model of FIG. 19b, and FIG. 19d illustrates a final resonant circuit model of configuration in FIG. 19c.

FIG. 20a illustrates another embodiment of the present invention with first and second resonant inductors, FIG. 20b shows the primary and secondary currents waveforms, and FIG. 20c shows the resonant ripple voltage waveform.

FIG. 21a illustrates in shaded area the flux requirements for the primary and secondary of the isolation transformer in the converter of FIG. 20a, and FIG. 21b shows in heavy lines the flux as a function of the duty ratio D for the converter of FIG. 20a while dotted line represents the flux of prior-art converters.

FIG. 22a illustrates the flux density requirements of the prior-art converters and FIG. 22b shows an order of magnitude lower flux density requirement of the converter in FIG. 20a.

FIG. 23a illustrates the single-ended transformer configuration of forward converter and FIG. 23b shows the power transfer through transformer is only when the current rectifier CR₁ is conducting.

FIG. 24a shows a true AC transformer of the converter in FIG. 20a, and FIG. 24b shows that the power flows through this transformer at all times making full utilization of the winding and available magnetic core flux.

FIG. 25a shows the practical implementation of the AC transformer of FIG. 24a utilizing a toroidal magnetic core, with primary winding wound around the toroidal core and a single-turn secondary made as a cylindrical copper tube, and FIG. 25b shows the copper plate attachment of secondary single turn to the Printed Circuit Board.

FIG. 26 shows the comparison of the BH loop of the transformer of present invention (marked new converter) with the BH loop of the transformer in forward and flyback converter.

FIG. 27a shows another embodiment of present invention with input and output capacitors having the role of an effective equivalent resonant capacitor, FIG. 27b shows the resonant inductor current and primary and secondary transformer currents of the 1:1 transformer in FIG. 27a, and FIG. 27c shows the salient features of both input current i_{g} and output current iₒ.

FIG. 28a shows yet another embodiment of present invention with the resonant capacitor Cᵣ added in series with the primary winding of the transformer and the resonant inductor in series with the secondary winding of the transformer and FIG. 28b confirms the waveform predicted for the output current i₀.

FIG. 29a shows the voltage v_{C3} of one of the output capacitors in FIG. 28a with its DC value and superimposed AC ripple, FIG. 29b shows the voltage v_{C4} of the other output capacitor with its DC value and superimposed AC ripple, and FIG. 29c shows the output voltage as their sum v_{C3}+v_{C4} with their AC ripples canceling.

FIG. 30a shows an equivalent circuit model which confirms that the resonant current iᵣ₁ is split in half between the two resonant capacitors and likewise for the input side, and FIG. 30b shows an equivalent circuit model which confirms that the resonant current iᵣ₂ is split in half between the two resonant capacitors and likewise for the input side.

FIG. 31a shows the measurement of the three voltage waveforms (DC and superimposed AC ripple) for the converter of FIG. 28a, and FIG. 31b shows the measurements of respective AC ripple voltages only.

FIG. 32a shows the same measurements as in FIG. 31a but with the resonant inductor changed from 12 μH to 1 μH, and FIG. 32b shows the same measurement but when the duty ratio is changed to reduce the output DC voltage.

FIG. 33a shows the zero current switching of input switch S₁, FIG. 33b shows zero current switching of diode rectifier CR₁, FIG. 33c shows zero current switching of input switch S₂, and FIG. 33d shows the zero current switching of diode rectifier CR₂.

FIG. 34a shows the high voltage input switches with their parasitic drain-to-source capacitances C_{S1} and C_{S2} respectively, and FIG. 34b shows the primary resonant current when the switching frequency is slightly raised above resonant frequency and the switch drives adjusted to create appropriate matching dead-time for the two natural transitions t_{N1} and t_{N2} to accomplish zero voltage switching of both active switches.

FIG. 35a shows equivalent circuit model during first transition interval t_{N1} and FIG. 35b shows the voltages of the two active switches during this transition, FIG. 35c shows equivalent circuit model during second transition interval t_{N2}, and FIG. 35d shows the voltages of the two active switches during this transition.

FIG. 36a shows another embodiment of present invention for high voltage application DC-DC conversion with resonant capacitor and resonant inductor included on the primary side and FIG. 36b shows that the resonant inductor can be replaced by the built-in leakage inductance of the isolation transformer.

FIG. 37a shows yet another embodiment of present invention with all transistor implementation for application for low voltage outputs, and FIG. 37b shows how the primary and secondary side MOSFET switches can be driven with the respective high side driver circuits.

FIG. 38 shows yet another embodiment with all MOSFET transistors and resonant capacitor on primary side.

FIG. 39a shows yet another implementation with the leakage inductance of the isolation transformer and a small air-core one-turn inductor L_{SH} in the branch with S₃ switch; this configuration is also used for duty ratio control of the output DC voltage through the special timing control of switch S₃ given by diagrams in FIG. 39b and FIG. 39c.

FIG. 40a shows the resonant current of the converter prototype in FIG. 39a adjusted for zero current crossovers at duty ratio of 0.66 and switching frequency of 36 kHz and FIG. 40b shows the DC gain characteristic measured on this prototype as a function of duty ratio D and for two DC load currents.

FIG. 41a shows the resonant current for the converter of FIG. 15a when the duty ratio is reduced below 0.66 resulting in output DC voltage reduction, FIG. 41b shows the resonant current during ON-time interval and corresponding equivalent circuit model, FIG. 41c shows the transition interval during which both resonant inductors are conducting and corresponding circuit model, and FIG. 41d shows the resonant current during remaining part of the cycle.

FIG. 42a shows the salient waveforms during the reduction of duty ratio and output DC voltage and FIG. 42b shows the same waveforms during further reduction of duty ratio and output DC voltage.

FIG. 43a shows the salient waveforms during the increase of duty ratio above 0.66, which also results in reduction of output DC voltage, and FIG. 43b shows further increase of duty ratio and further reduction of output DC voltage.

FIG. 44a shows another method of reduction of output DC voltage for the converter of FIG. 16a operating at 50% duty ratio but controlled by increasing the switching frequency above resonant frequency, and FIG. 44b shows further increase of switching frequency and further reduction of DC output voltage.

FIG. 45 shows the schematic of a prototype of a 120V to 5V, 15 A converter with four MOSFET switches and with the special timing for switch S₃ which is made to conduct during the same time as its own body diode (shown highlighted in FIG. 45) conducts so that the control and regulation of output DC voltage can be achieved.

FIG. 46a shows the isolation transformer of the prototype in FIG. 45 using two stacked toroidal cores, and FIG. 46b shows the assembly connecting center one turn secondary to the secondary side MOSFET devices.

FIG. 47a shows the resonant current of the prototype in FIG. 45 adjusted for zero current crossings operation at 0.66 duty ratio and switching frequency of 47 kHz, and FIG. 47b shows the enlarged portion of the resonant current waveform.

FIG. 48a shows the resonant current when the switching frequency is increased to 52 kHz, and FIG. 48b shows the enlarged portion of the resonant current waveform indicating positive and negative currents used for zero voltage switching of primary side switches.

FIG. 49a shows the enlarged first transition, and FIG. 49b shows the enlarged second transition.

FIG. 50 shows the efficiency measurements of the prototype of FIG. 45 for 72V input voltage.

FIG. 51a shows the output voltage transient response (second trace) to the 5A step-up DC load current change (top trace) and the resonant current during the transient, and FIG. 51b shows the output voltage transient during the 5A current step-down.

FIG. 52a shows the output ripple voltage for 120V nominal DC input voltage, and FIG. 52b shows the reduced output ripple voltage, when a small 150 nH inductance and 450 μF output filter is added.

FIG. 53a is another embodiment with a single-ended switch connection on the primary side and with the isolation transformer implemented as in FIG. 53b with a small air-gap to increase the magnetizing current.

FIG. 54a is the magnetizing current of the converter in FIG. 53a with a small air-gap in transformer and FIG. 54b is ideal resonant capacitor current when the magnetizing current is zero and FIG. 54c is the actual resonant capacitor current and primary current of isolation transformer, which include the effect of the finite magnetizing current of the transformer.

FIG. 55 is another embodiment of the present invention with both primary and secondary side switches in single ended configuration.

FIG. 56a is schematic of the application for AC-DC conversion with composite converter consisting of front-end boost converter followed up by present invention operated at 50% duty ratio and with all MOSFET switches and FIG. 56b illustrates 50% operation of all switches and FIG. 56c shows the isolation transformer current.

FIG. 57a shows another embodiment with the center-tap secondary rectification and FIG. 57b shows yet another embodiment with the full-bridge rectification on the secondary side.

FIG. 58a shows another embodiment of the present invention, which consists of three modules operated at 50% duty ratio but phase displaced in time so that both input and output ripple currents are minimal at about 5% of respective DC currents and FIG. 58b shows the converter module used in three-module converter of FIG. 58a.

FIG. 59a is a diagram showing the time displacement of the composite currents of each of the three modules in the converter of FIG. 58a and FIG. 59b illustrates the individual input and output currents of each module and how they add together to DC currents with a small relative ripple.

### OBJECTIVE

The prior-art DC-DC power conversion topologies based on square-wave, resonant, and quasi-resonant switching power conversion all store the DC energy in their magnetic components, either in the inductor, such as non-isolated buck and buck-derived isolated converters (such as forward converter and bridge type converters), in the transformer itself, such as the flyback converter, or in both, such as asymmetric half-bridge (AHB) converter and many others.

The main objective of this invention is to provide a new storageless switched-mode power conversion method, which provides a host of DC-DC converter topologies with the galvanic isolation feature, but with the main magnetic component, the isolation transformer, which does not store the DC energy and two small resonant inductors. Elimination of DC energy storage results not only in substantial reduction of the size and weight of the isolation transformer but simultaneously also in large reduction of losses, inherent fast transient response to sudden large DC load current changes, as well as much reduced Electromagnetic Interference Problems (EMI) and low stresses on the switches (“stressless” switching).

Although the comparison will be made throughout with the prior-art isolated converters, the prior-art non-isolated buck converter is reviewed first in the next Prior-art section, as many isolated conventional converters are effectively derived from it and trace their origin and need for DC storage to the buck converter. The prior-art review section is then concluded with the more detailed review of a number of prior-art isolated converters in which their DC storage need and other deficiencies are highlighted.

This is then followed by the detailed description of the new power conversion method with galvanic isolation, composed of two independent switched-mode resonances and their corresponding control and concludes with a number of new and useful isolated converter topologies.

The main objective is to replace the current isolated switching converters, which invariably have also large DC energy storage PWM inductors in addition to isolation transformer with a new converter topologies without any PWM inductors but with small resonant inductors and with the transformer which does not store DC energy. The new converter topology will therefore provide simultaneously higher efficiency, much reduced size, weight and cost, and secure the fast transient response as well.

### Prior Art

Prior-Art Buck Converter

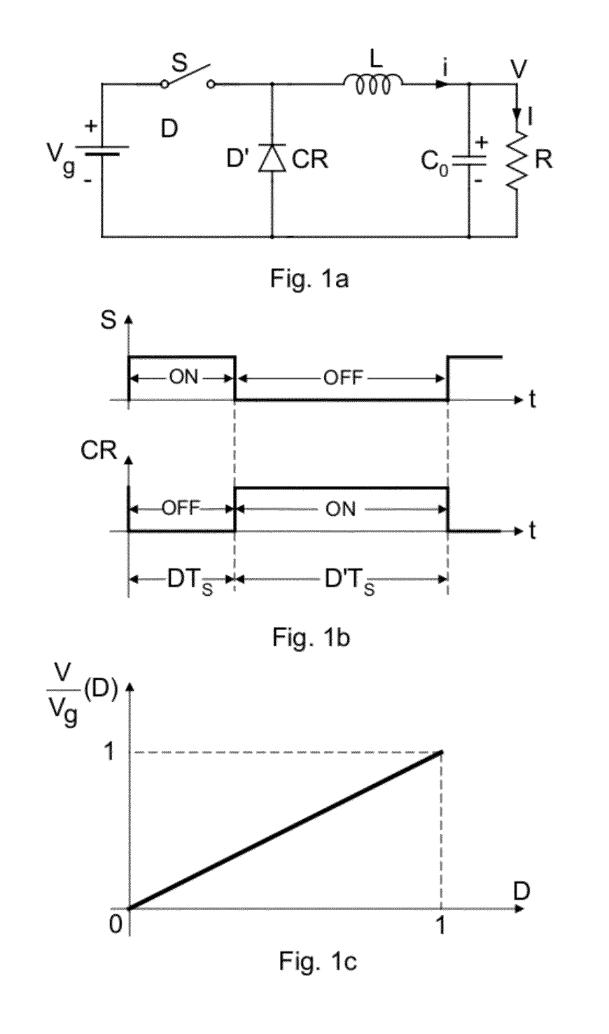

The non-isolated prior-art Pulse Width Modulated (PWM) buck switching converter shown in FIG. 1a consists of two complementary switches S and CR: when S is ON, CR is OFF and vice versa as shown by the switch states in FIG. 1b. A Buck converter is capable only to step-down the input DC voltage and its voltage conversion is dependent in continuous conduction mode only on duty ratio D, which is defined as the ratio of the ON time of switch S, DT_{S}, and switching period T_{S}. The DC voltage conversion ratio M(D) is given by well known formula:

M(D)=V/V_{g}=D (1)

This linear DC conversion gain of buck converter is illustrated in FIG. 1c.

### Switch Implementations

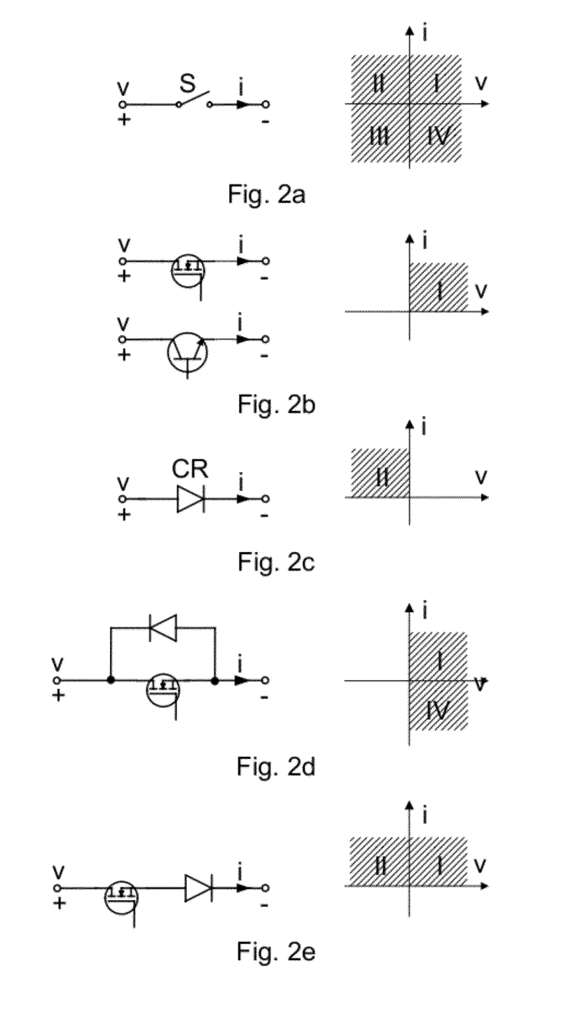

Both switches in the buck converter of FIG. 1a could be implemented by ideal four quadrant switch S defined in FIG. 2a as capable of conducting current in either direction and blocking voltage of either polarity imposed by the switching converter itself However, the practical electronic applications of the switches by use of semiconductor switching devices require, for cost and simplicity reasons, the least complex implementation of the switches. Thus, the minimum switch realization of the buck converter in FIG. 1a uses a single-quadrant active switch of FIG. 2b (either bipolar or MOSFET transistors) and a single quadrant passive switch (diode rectifier CR) of FIG. 2c. For the special application requiring small size and thus operation at high switching frequency of 20 kHz or higher, a MOSFET switching transistor is used for main switch S even though this switch as shown in FIG. 2d is effectively a two-quadrant Current Bi-directional Switch (CBS) due to built-in body diode, shown explicitly as separate parallel diode in FIG. 2d. This function could be also emulated by a parallel connection of a bipolar transistor and diode rectifier CR. In low voltage applications the built-in body diode of the MOSFET switch is bypassed by the low resistance path through the transistor itself to reduce substantial conduction losses, which would be incurred by either body diode or discrete diode rectifier of FIG. 2c.

Finally, another composite switch, the two-quadrant Voltage Bi-directional Switch (VBS) is shown in FIG. 2e. Such composite switch is capable of blocking the voltage of either polarity but allows the current flow in only one direction.

### Inductor DC Energy Storage and Transient Response

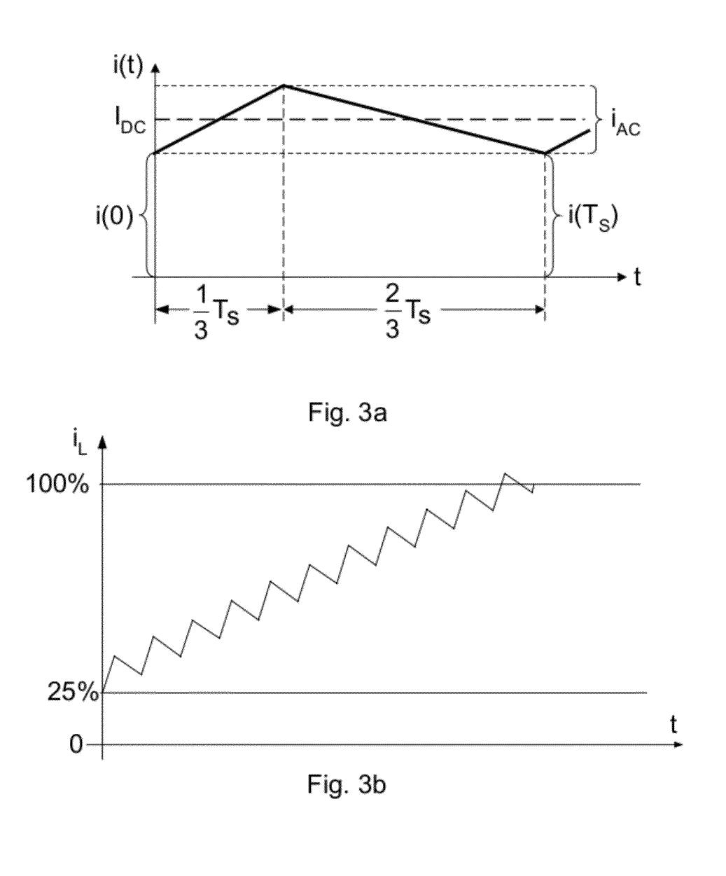

The inductor L in the buck converter of FIG. 1a, must conduct a full DC load current so that instantaneous inductor current waveform i(t) shown on FIG. 3a must have a DC-bias equal to DC load current and a superimposed AC triangular ripple current. This implies that the inductor L must store a DC energy W equal to:

W=½LI² (2)

Herein lies one of the major limitations of the prior-art buck converter and other conventional switching converters based on or derived from it: they all must store this substantial DC energy in the inductor during every cycle. As a direct consequence, the converter cannot respond immediately to a sudden change of the load current demand, such as from 25% of the load to the full 100% load as illustrated in FIG. 3b. Instead, the buck converter must pass through a large number of switching cycles before the instantaneous inductor current settles at the new steady state level which has a full DC load current.

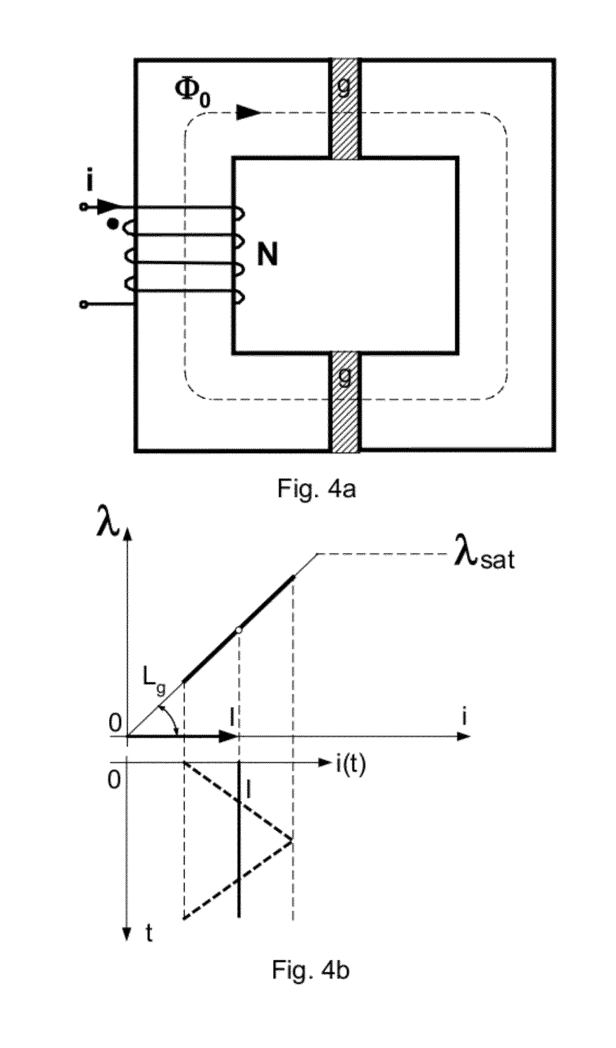

In order to store the DC energy given by (2), inductor must be built with an air-gap such as shown in FIG. 4a. The length of the air-gap is directly proportional to the DC energy, which needs to be stored. Clearly, addition of the air-gap reduces the inductance L dramatically. Therefore to obtain needed inductance one is resorted to use a larger magnetic core cross-section to make up for the loss of inductance due to the presence of the large air-gap so that an acceptable AC ripple current of around 20% peak to peak relative to DC current I is provided. Ultimately, for a very large DC currents (100 A or more), the air-gap needed is so large, that the magnetic core only increases inductance of the winding by a small factor of two to three compared to an inductor winding of the same size without core material. Considering that present day ferrite materials have a relative permeability of 2,000 or more, this results in reduction of inductance by a factor of 1000 or more.

### Large AC Flux and Magnetic Core Saturation

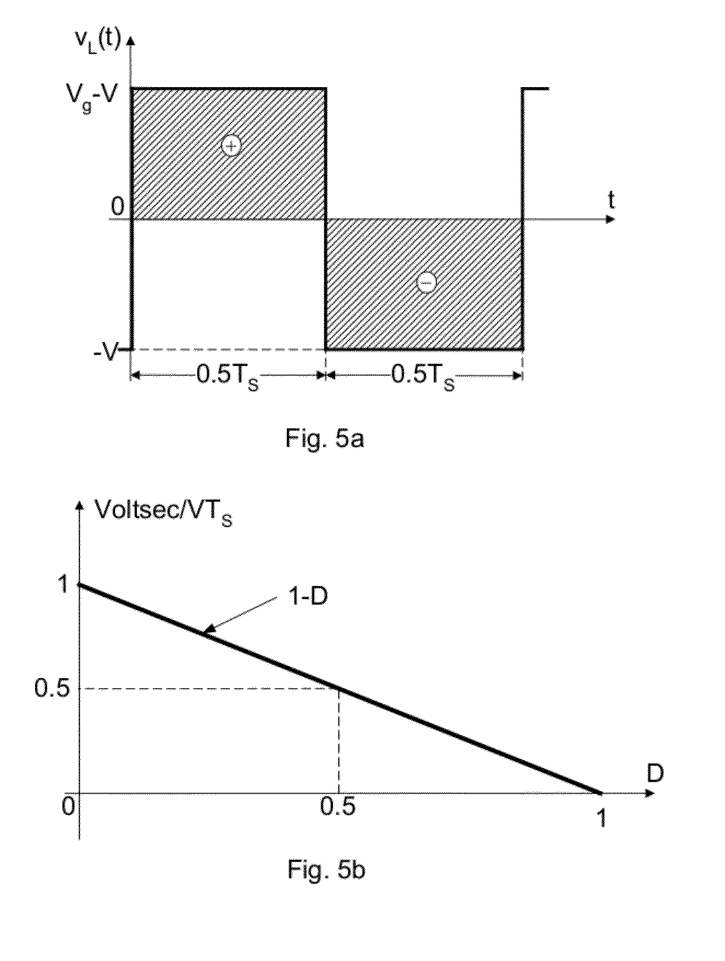

Size of the inductance is therefore severely affected by its need to store the DC energy (2). In addition, very large size inductor is required because it must also support a superimposed AC flux as seen in FIG. 4b and still not result in magnetic core saturation. This AC flux (Volt-seconds) of the buck converter is illustrated in FIG. 5a and shown by shaded area. The core flux Δφ imposed on the magnetic core is calculated from:

Δφ/VT_{S}=1−D (3)

and the graph of duty ratio D dependence in FIG. 5b. Clearly, for large duty ratios such as 0.95 or higher the core flux and core size could be small. Unfortunately, that also leads to the very small step-down conversion close to 1.0. For most application where large step-down is needed the large core flux is needed so that for the typical applications when the duty ratio is lower than D=0.5 the only way to reduce the core flux and core size is to decrease switching period and therefore increase switching frequency. This is precisely how buck type and other converters handle a large core flux requirements.

In summary, the size of the inductor L in the prior-art buck converter is very large due to the two basic requirements:
a) need for large DC energy storage;
b) large AC volt-seconds imposed on the inductor.

### Prior-art Single-ended Isolated Extensions of the Buck Converter

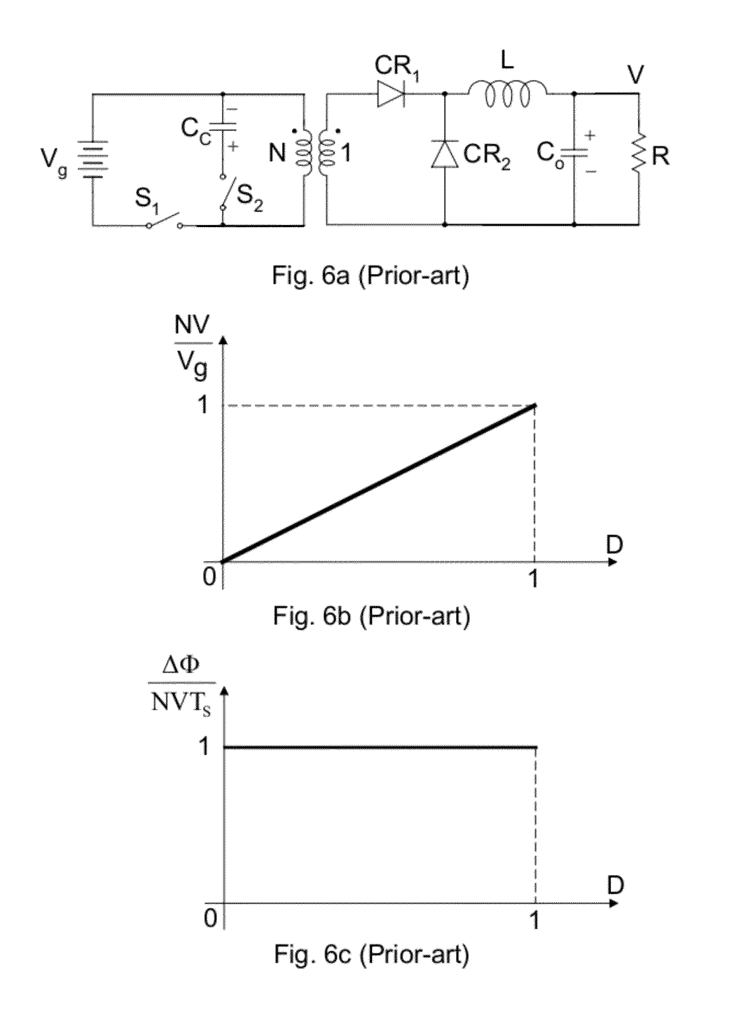

A single-ended isolated extension of the buck converter is the forward converter shown in FIG. 6a, with the same DC-gain dependence on duty ratio (FIG. 6b). The transformer flux can be evaluated as:

Δφ=NVT_{S} (4)

Note that, unlike (3), the transformer flux now has no dependence on duty ratio D as expressed by the graph of FIG. 6c. Therefore, at all operating conditions, no matter what duty ratio is chosen, the same high AC core flux for transformer is present and therefore the large magnetic core is needed. The only remedy to reduce transformer size is therefore to increase the switching frequency.

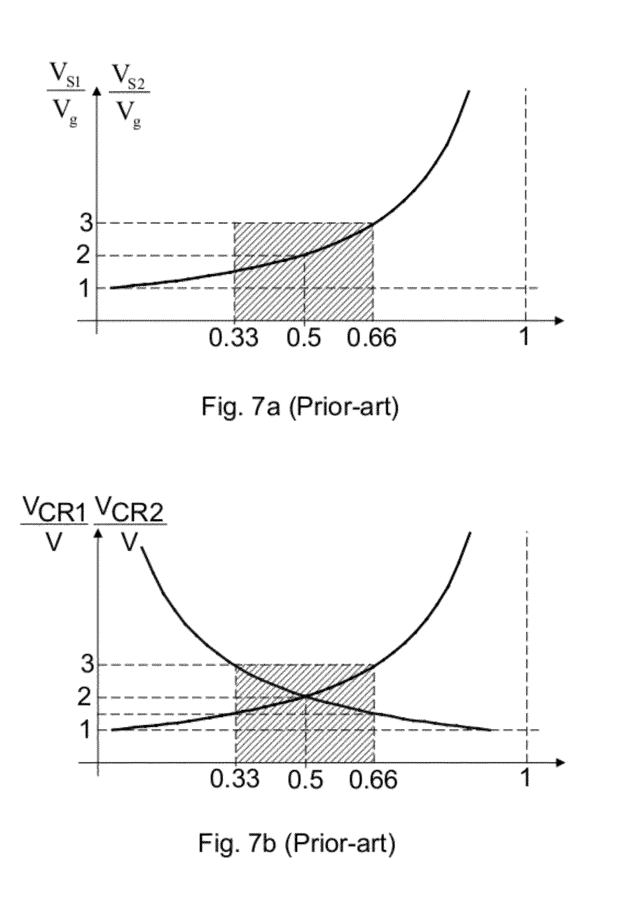

The insertion of the isolation transformer in the buck converter is also responsible for another undesirable characteristic highlighted in FIG. 7a and FIG. 7b: the high voltage stresses imposed on the switches of both primary and secondary side and the resulting limited input voltage range. Note, for example, that for the optimum operating range around D=0.5, the 2:1 input voltage range requires that the voltage stresses on output switching devices must exceed the regulated DC output voltage V by a factor of 2 to 3 times. As a direct result of the presence of the buck type output inductor and the regulation requirement the voltage stresses of the output switches relative to output DC voltage V are then given by:

V_{CR1}/V=1/D (5)

V_{CR2}/V=1/(1−D) (6)

For high efficiency and low cost it would be desirable that neither of the two output diode rectifiers exceed the output DC voltage. This is accomplished in the isolated switching converter topologies of the present invention as described in later section.

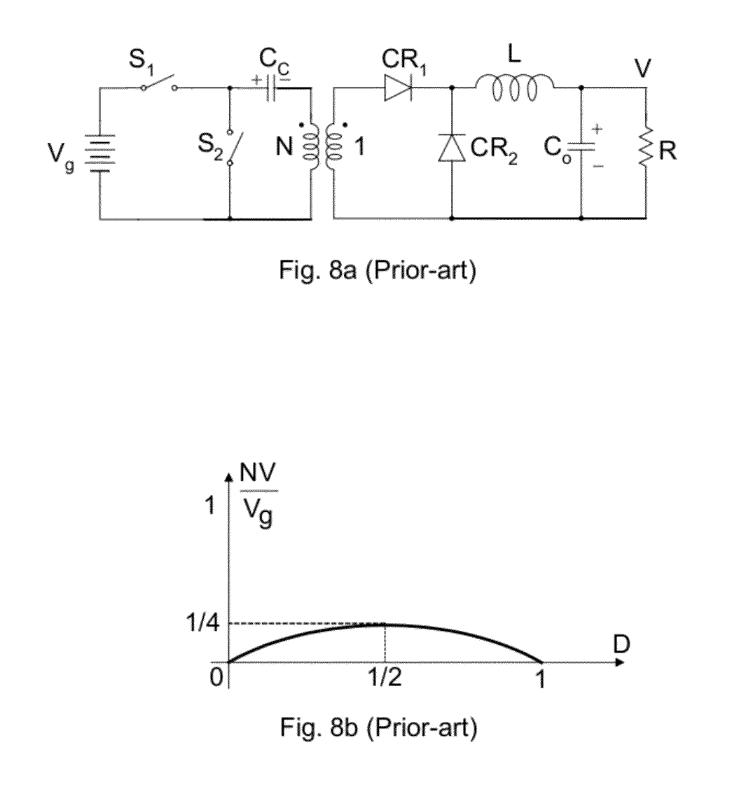

Another single ended extension of the buck converter is the Asymmetric Half-Bridge (AHB) converter shown in FIG. 8a. Despite its nonlinear DC-gain conversion ratio shown in FIG. 8b, its transformer flux requirements are governed by the same equation (4) and result in the same graph given by FIG. 6c once again requiring the large magnetic core for its transformer.

### Problems of the Single-ended Rectification

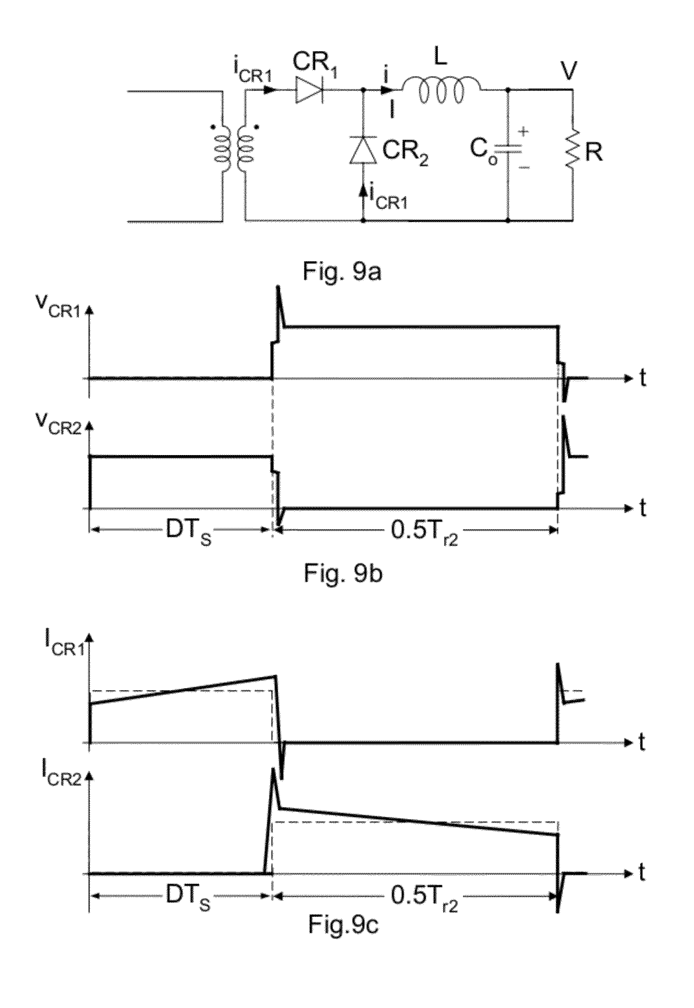

The forward, AHB, and other isolated prior-art converters based on the buck type output inductor and a single-ended rectification shown in FIG. 9a have another serious performance problem especially evident for high DC load currents. Note the presence of large voltage spikes in FIG. 9b at the instant of both switching transitions, which lead to high switching noise and undesirable further increase in device voltage stresses. This is caused by the erratic switching transitions due to the need of high inductor current to switch its conduction from one rectifier to the other very quickly (FIG. 9c) as the state where both diodes are off is not allowed as inductor current cannot be interrupted. This therefore leads to the very short and yet very undesirable interval during which both rectifiers conduct resulting in current and voltage spikes and power loss due to circulating current. In the present invention, the simultaneous conduction of the both rectifiers is not only allowed but actually provides well defined and controlled transitional state, which results in a very smooth switching of both rectifiers and additional performance advantages as described in later sections.

### Prior-Art Bridge-Type Isolated Extensions of the Buck Converter

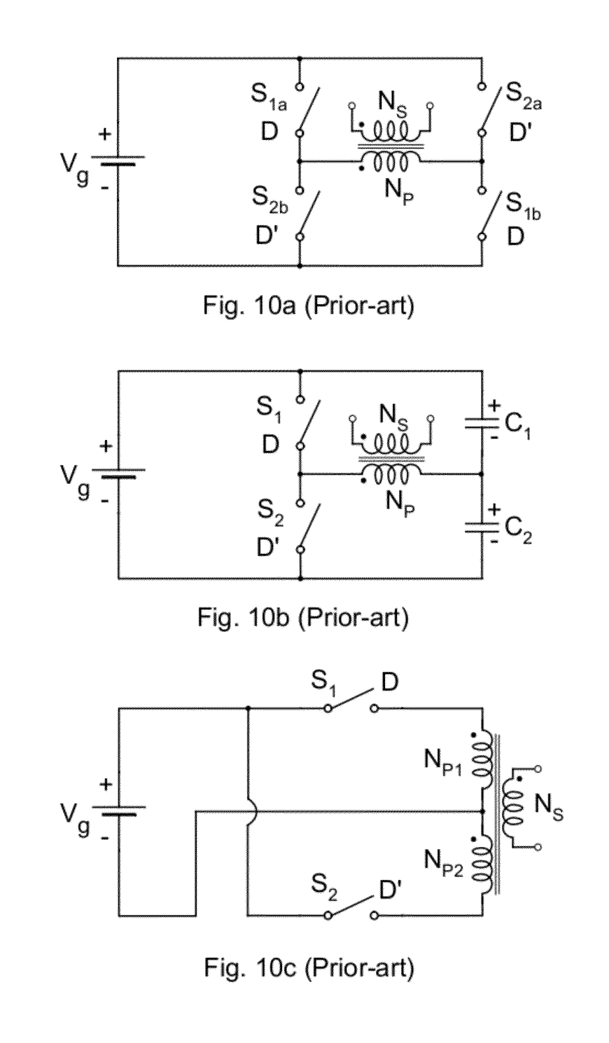

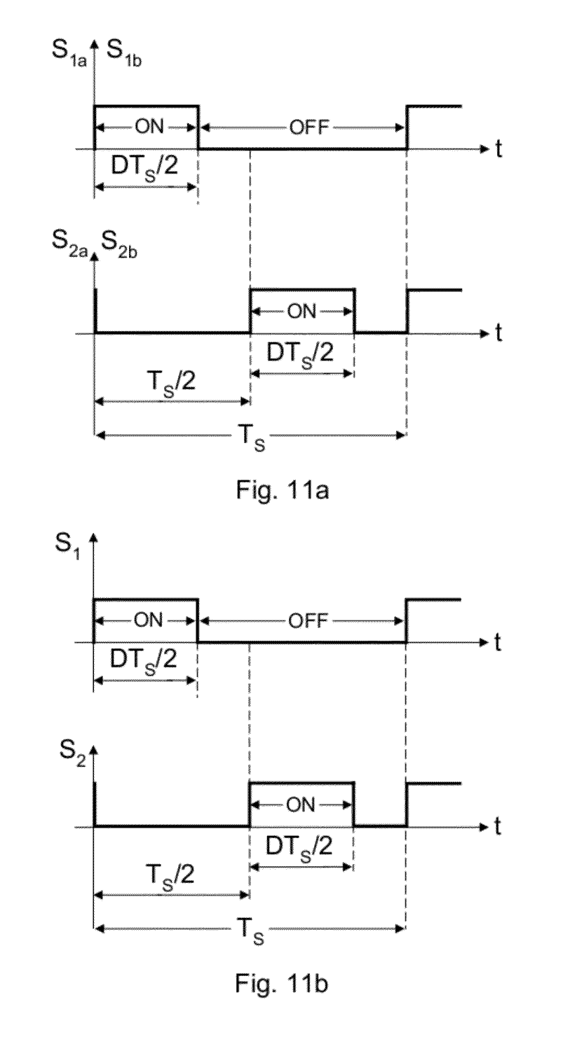

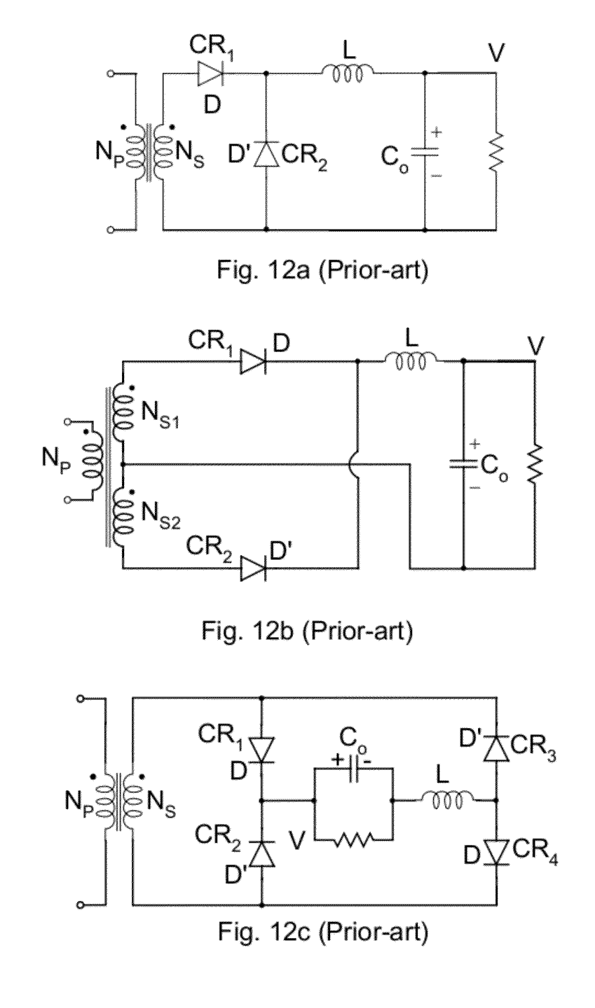

The galvanic isolation of the prior-art buck converter of FIG. 1a can be provided by use of the bridge-type switching schemes for the primary side, as illustrated in FIG. 10a, FIG. 10b and FIG. 10c, often referred to, respectively, as full-bridge, half-bridge and center-tap push-pull configuration. The respective duty ratio drive controls are shown in FIG. 11a and FIG. 11b so that any of the primary side switching could be combined with any of the secondary side rectification scheme shown in FIG. 12a, FIG. 12b and FIG. 12c and often referred to respectively, as single-ended rectification, center-tap (double-ended) and bridge (full-wave rectification). Note the presence of the buck-type inductor in all these switching converters would result in the same DC-gain characteristic of the buck converter of FIG. 1c verifying that these isolated configurations are derived from the buck converter.

Clearly, the presence of the buck-type DC energy storage inductor in all these switching converters results in the same DC storage limitations described for the non-isolated buck converter. Further analysis also reveals the same AC flux constraining equation (4) and corresponding independence of the operating point duty ratio D shown in FIG. 6c. The isolation transformer has additional undesirable features:
a) the poor winding utilization as under duty ratio control windings conduct current and power to the load only during a portion of the switching interval;
b) center-tap secondary rectification is very undesirable for high-switching frequency, as only one secondary winding conducts at a given time resulting in additional AC coupled losses in the other secondary winding.
   The equation (4) applicable for all prior-art converters introduced so far is also applicable to many other switching converters currently in use limiting the size of their transformers.

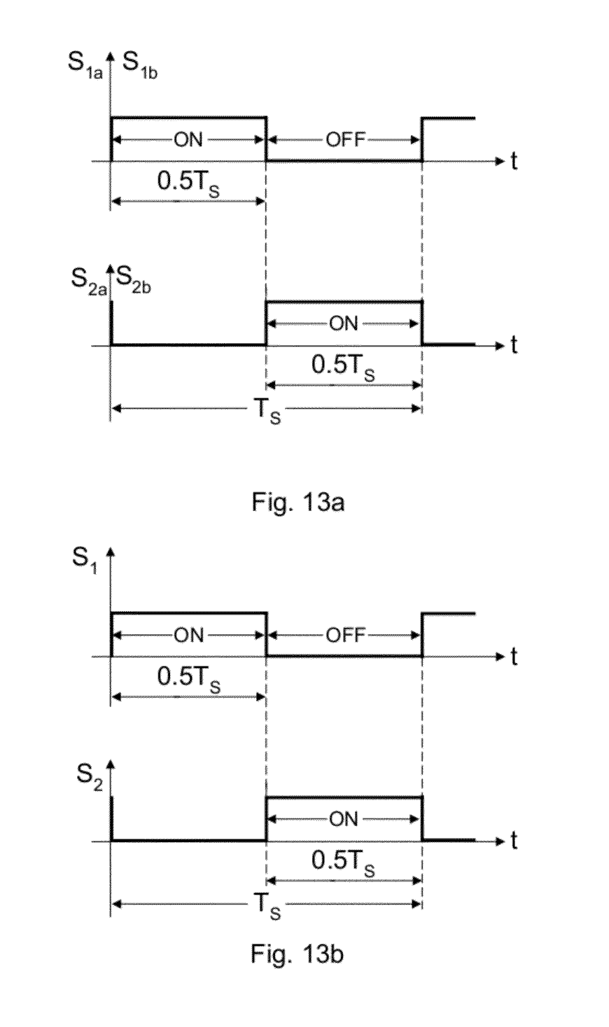

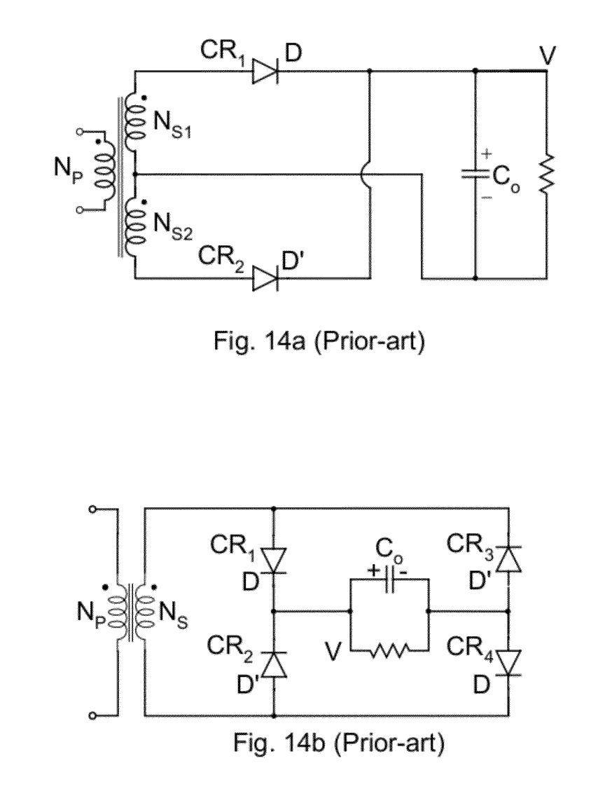

The output inductors of the bridge-type converters are eliminated in the 50% driven bridge-type converters, which utilize the fixed 50% duty ratio for secondary side rectifications as shown in FIG. 13 and FIG. 13b and result in prior-art converters of FIG. 14 and FIG. 14b. Clearly, limitation to 50% duty ratio results in only a fixed DC conversion ratio and inability to regulate the output DC voltage in the face of any input DC voltage changes and/or any DC load current changes.

### SUMMARY OF THE INVENTION

### New Method Based on Two Independent Resonance's

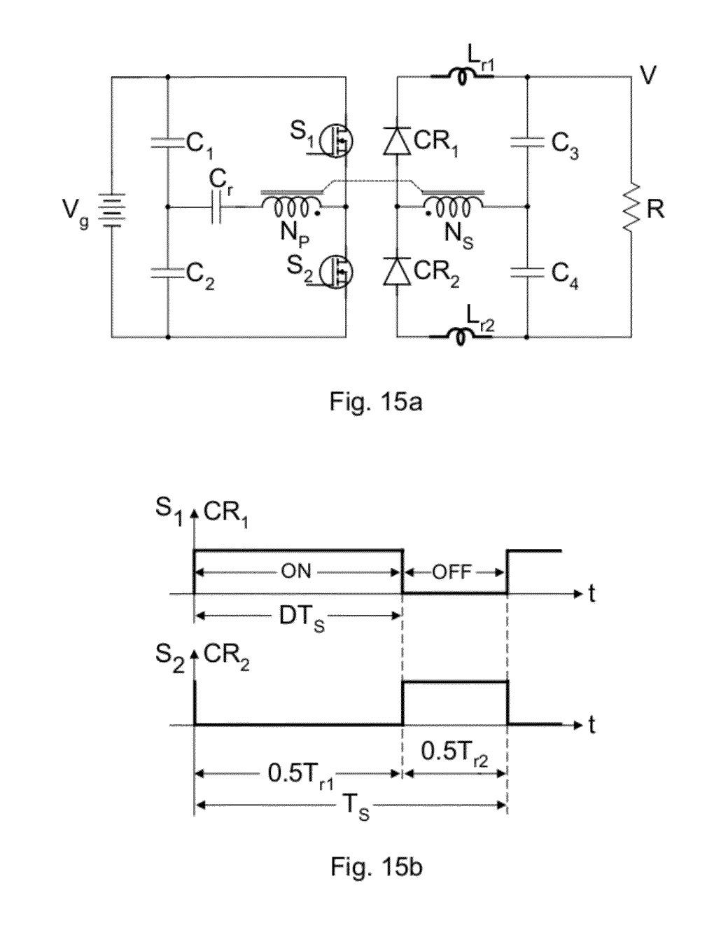

The new method is based on the two independent resonance's and is illustrated on the new switching converter topology of FIG. 15a although the same double resonance method can be practiced with equal benefits on a number of embodiments illustrated later and those which can be derived by those skilled in the art utilizing the principles of operation disclosed herein and topology requirements outlined herein.

The key distinguishing feature is the presence of the two resonant inductors, designated Lᵣ₁ and Lᵣ₂ respectively and marked in thick lines on FIG. 15a. Note the rather unlikely position of the two resonant inductors, as each is placed in series with the respective diode. The conventional switched-mode power conversion theory excludes a priory presence of inductors in the branches with the switches based on the fact that inductor current could not be interrupted without bad consequences (excessive voltage spike on the switch due to switch current interruptions and consequently the blowing up of the switch in which the inductor is placed). However, this is not the case in the converter of FIG. 15a as each resonant inductor is placed in the respective diode switch branch. Therefore, the half-sinusoidal resonant inductor current in the current rectifier switch flows until reaching zero current level at which point the respective current rectifier does turn-OFF. Note that the same holds true for the other current rectifier switch with the second resonant inductor.

Note that in the prior-art forward converter of FIG. 6a the two current rectifiers must be both turned-ON for a short and uncontrollable transitional time resulting in short circuit currents and undesirable losses. In the present invention, the two current rectifiers are indeed allowed to conduct at the same time, resulting in well-defined transitional time and no losses as well as in elimination of voltage and current spikes.

Another distinguishing feature is that the corresponding current rectifiers operate on the secondary side in synchronism with primary side active switches so that when S₁ switch is turned ON during ON-time interval DT_{S} the corresponding current rectifier CR₁ is also turned ON during this time as also indicated by the switching state diagram of FIG. 15b while the resonant inductor Lᵣ₁ becomes also part of the first ON-time interval switched circuit and forms the first independent resonant circuit. Likewise, when switch S₂ is turned-ON during OFF-time interval (1−D)T_{S} the corresponding secondary side rectifier CR₂ is also turned-ON while the resonant inductor Lᵣ₂ is also part of the second OFF-time interval switched circuit and forms the second independent resonant circuit.

Note the independence of the two resonant circuits described above. Although they do use the same common resonant capacitor Cᵣ, each resonant inductor, Lᵣ₁ and Lᵣ₂, define their own resonant periods Tᵣ₁ and Tᵣ₂. Note also that each of two resonant circuits has a current rectifier, which allows only positive half of the sinusoidal resonant current to flow. If the ON-time interval is adjusted to be equal to the half of the first resonant period, and the OFF-time is adjusted to be equal to half of the second resonant period then each resonance is both started and completed within the respective ON-time interval and respective OFF-time interval. This is clear and distinguishing feature of this resonant method in comparison with the resonant methods with the conventional resonant converters, which are using either a parallel or series single resonance which extends over the whole switching cycle and, in fact, interferes with the single resonant current.

The sum of the two half-resonant periods then form in the present invention one switching cycle T_{S}. Another fundamental feature of the new resonant method employed in the present invention of FIG. 15a is that the primary control of output voltage is by the duty ratio control at the constant switching frequency. All prior-art resonant converters cannot operate in that way and can only control the output voltage by keeping duty ratio fixed at 50% and operating with variable switching frequency over the wide frequency range.

### Basic Operation of Isolated Step-down Switching DC-DC Converter

One converter topological implementation of the novel independent double-resonance method is illustrated in FIG. 15a, which consists of an isolation transformer and two resonant inductors. The two resonant inductors could, in some cases, be eliminated to result in only one magnetic component, the isolation transformer, whose leakage inductance plays the role of the resonant inductor. The converter also has the two active switches on the primary side of the transformer, two current rectifier switches on the secondary of the isolation transformer, the input capacitors C₁ and C₂ forming an effective half-bridge configuration with the active switches on the primary side and the output capacitors C₃ and C₄ forming an effective half-bridge configuration with the current rectifier switches on the secondary side of the transformer. The isolation transformer provides either step-up or step-down voltage conversion based on its primary to secondary turns ratio N_{P}:N_{S}. Thus, converter is equally suitable for large conversion step-down, such as for example, 150V input DC voltage to 5V output (30:1 voltage step-down), as well as for large DC voltage step-up, such as 150V DC input to 4,500V output (1:30 voltage step-up).

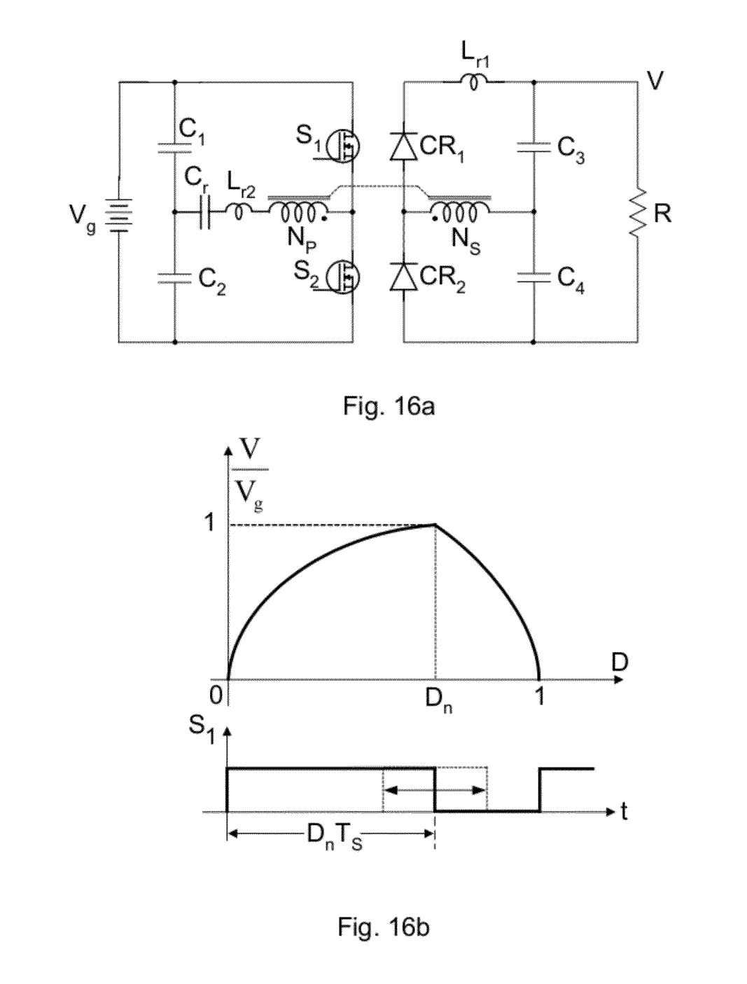

Another embodiment of the present invention is shown in FIG. 16a illustrating one of several possible placements of the two resonant inductors. In FIG. 16a the resonant inductor Lᵣ₂ is moved from its placement with the current rectifier CR₂ into primary of the isolation transformer and in series with the resonant capacitor Cᵣ. This also changes the operation of the converter, as with this configuration, there is no overlapping conduction of the two current rectifiers since current rectifier CR₂ can now turn ON only after the rectifier CR₁ current is reduced to zero.

Nevertheless, in either case, the output DC voltage can be controlled by a simple change of the duty ratio D of the main controlling switch S₁ on the primary side to result in the DC conversion gain characteristic of FIG. 16b. Note the two regions of the step-down conversion gain, one for operating duty ratio D lower than Dₙ and the other for duty ratio D higher than Dₙ.

### Low Voltage Stresses of All Switches

Even the cursory examination of the switches in the converter of FIG. 15a and that of FIG. 16a reveals their voltage stresses to be:

V_{S1}=V_{S2}=V_{g} (7)

V_{CR1}=V_{CR2}=V (8)

where V_{g} and V are input and out DC voltages respectively. Thus, a unique performance feature is obtained which is heretofore not available in any other isolated switching converter:
a) two switches on primary side have voltage ratings equal to input DC voltage V_{g} for any operating duty ratio D;
b) two switches on secondary side have voltage ratings equal to the output DC voltage V for any operating duty ratio D.

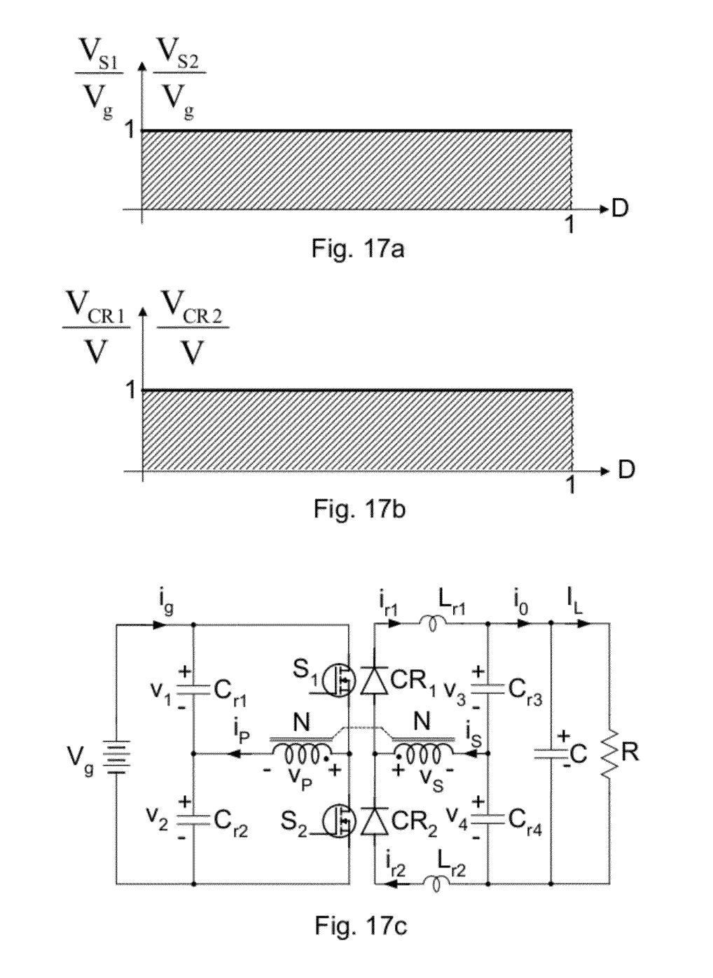

This is further illustrated on the diagrams of FIG. 17a and FIG. 17b, showing that the voltage stresses on switches never exceed either the input voltage or the output voltage throughout the duty ratio operating range. Clearly, this results in the wide input voltage regulation range without any excessive voltage stresses on the switches. This should be compared with the operating region of the forward converter, for example, illustrated earlier in FIG. 7a and FIG. 7b in which shaded area represent the allowed operating region for 2:1 input voltage range. Should the operation under abnormal conditions such as short circuit, etc, lead to operation outside of this shaded region, the switches will fail due to excessive voltage stresses. Not so in the converter topologies of the present invention, as the entire duty ratio range is a safe operating range. Thus, a more reliable operation is secured naturally.

Clearly, the use of the lower voltage rated switches on both input and output results in much reduced losses as ON-resistance of the MOSFETs is substantially reduced with reduced voltage ratings.

### Analysis of Two Resonant Circuits

Yet another embodiment of the present invention is shown in FIG. 17c. Here the previously mentioned input and output capacitors are small in value and together play the role of previous resonant capacitor Cᵣ that is now removed from the converter (shorted). Note also that a larger input capacitor Cᵢₙ is added on input side and another larger capacitor C is added on the output side. This special configuration is suitable for the detailed resonant circuit analysis, which exposes all salient waveforms in the present invention.

We now undertake the analysis of the converter in FIG. 17c by analyzing separately two resonant circuits: first resonant circuit applicable for ON-time interval and second resonant circuit applicable for OFF-time interval. To simplify the analytical results we will assume a transformer with 1:1 turns ratio (N_{P}=N_{S}=N).

We also rename the previous input and output capacitors as the capacitors Cᵣ₁, Cᵣ₂ Cᵣ₃, and Cᵣ₄ and thus reveal their role as resonant capacitors in the converter of FIG. 17c. In the following analysis we will also assume that:

Cᵢₙ>>Cᵣ₃ Cᵢₙ>>Cᵣ₄ (9)

C>>Cᵣ₃ C>>Cᵣ₄ (10)

where a factor of 2 or 3 will be sufficient to satisfy the above inequalities.

### First Resonant Circuit Model

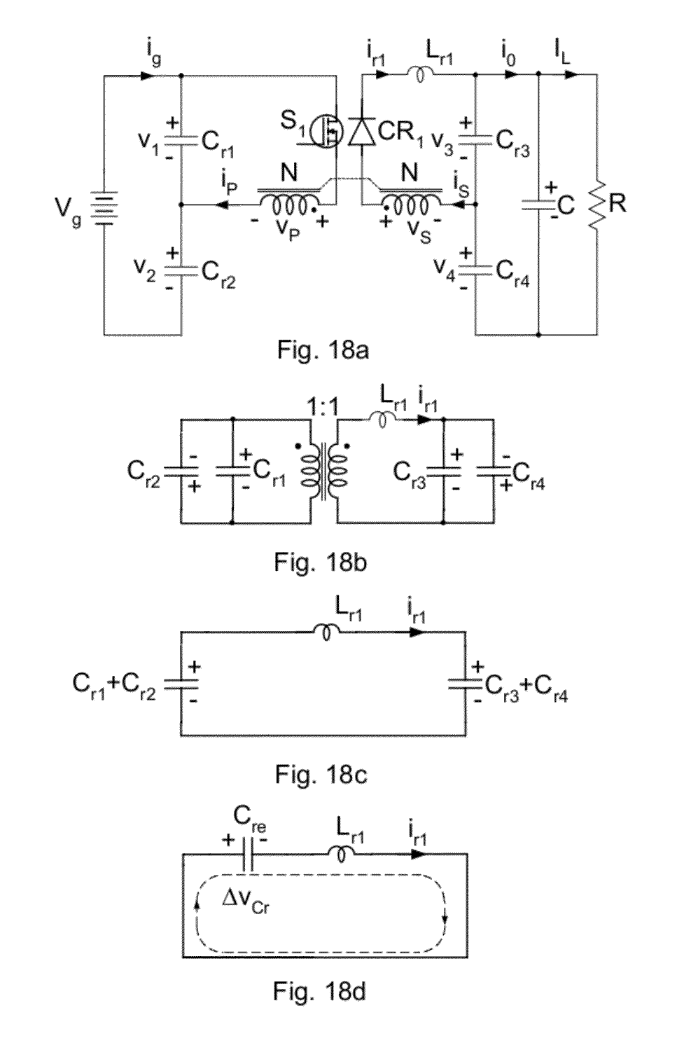

The first resonant circuit is obtained when the switch S₁ is turned ON, which, in turn, forces current rectifier CR₁ to turn ON, as it is effectively in series with the switch S ₁ to result in the first resonant circuit model shown in FIG. 18a. Note how the presence of the current rectifier CR₁ restricts the resonant current flow to only one direction. The resonant switching circuit of FIG. 18a can be further simplified to the AC circuit model of FIG. 18b by shorting the capacitor Cᵢₙ based on assumption (9) and by shorting the capacitor C based on assumption (10). The voltage polarity of the resonant capacitors is intentionally left in the equivalent circuit model of FIG. 18b, to point out the nature of their respective resonant voltages and currents: while capacitor Cᵣ₁ is discharging, the capacitor Cᵣ₂ is charging, and while capacitor Cᵣ₃ is charging, the capacitor Cᵣ₄ is discharging. This equivalent model, in turn, after removing ideal 1:1 turns ratio transformer, results in equivalent circuit model of FIG. 18c which can be used to identify the equivalent resonant capacitor Cᵣₑ of the final resonant circuit model of FIG. 18d as the series connection of capacitors (Cᵣ₁+Cᵣ₂) and (Cᵣ₃+Cᵣ₄) so that:

1/Cᵣₑ=1/(Cᵣ₁+Cᵣ₂)+1/(Cᵣ₃+Cᵣ₄) (11)

For the series resonant circuit of FIG. 18d we can write two first order differential equations as:

Lᵣ₁diᵣ₁/dt=−vᵣ (12)

Cᵣₑdvᵣ/dt=iᵣ₁ (13)

the solution of which is given by:

iᵣ₁(t)=Iₘ₁ sin(ωᵣ₁t) (14)

vᵣ₁(t)=−Δvᵣ₁ cos(ωᵣ₁t) (15)

where

R_{N1}=√Lᵣ₁/Cᵣₑ (16)

is a natural resistance of the first resonant circuit and Δvᵣ₁ is the half of peak-to-peak AC ripple voltage on resonant capacitor during ON-time interval and given by

Δvᵣ₁=R_{N1}Iₘ₁ (17)

Although the equation for resonant inductor current (14) obviously has both positive and negative current parts, only the positive current is allowed to flow in the actual converter circuit due to the current flow restriction to positive part only imposed by the current rectifier CR₁ in circuit model of FIG. 18a and the actual converter of FIG. 15a. In fact, here the current rectifier CR₁ restricts the current flow to only one direction.

Thus, the solution (14) must be limited to positive part only, so that:

iᵣ₁(t)=|Iₘ₁ sin(ωᵣ₁t)| (18)

where parallel bars indicate positive value only. This therefore imposes that the first resonant current flow will be limited to the ON-time interval DT_{S} only, so that:

DT_{S}=0.5Tᵣ₁ (19)

where resonant period L₁ is given by:

Tᵣ₁==1/fᵣ₁ (20)

in which fᵣ₁ is the first resonant frequency given by:

ωᵣ₁=2πfᵣ₁ (21)

The factor 0.5 in equation (19) signifies that resonant current flows only during one half of the total resonant period Tᵣ₁.

Note from (18) that the resonant current is made to flow starting from zero current level and completing its half resonance at zero current level but after time DT_{S} has elapsed. This now makes an ideal point to start the second resonance at the start of the OFF-time interval (1−D)T_{S} as the first resonance has just been completed and stopped by the diode rectifier CR₁.

### Second Resonant Circuit Model

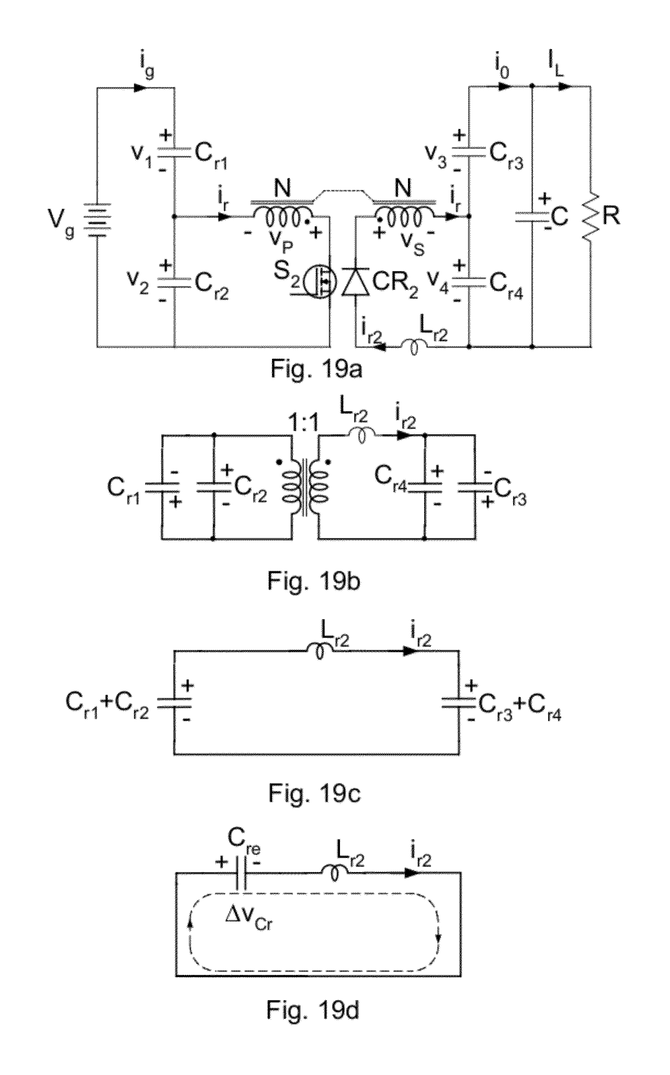

The second resonant circuit is obtained when the first switch S₁ is turned OFF and simultaneously second switch S₂ is turned ON, which, in turn, forces current rectifier CR₂ to turn ON, as it is effectively in series with the switch S₂ to result in the switched circuit model shown in FIG. 19a. Note how the presence of the current rectifier CR₂ restricts once again the resonant current flow to only one direction. The resonant switching circuit of FIG. 19a can be further simplified to the AC circuit model of FIG. 19b by shorting the capacitor Cᵢₙ based on assumption (9) and by shorting the capacitor C based on assumption (10). The voltage polarity of the resonant capacitors is intentionally left in the equivalent circuit model of FIG. 19b, to point out the nature of their respective resonant voltages and currents such as: while capacitor Cᵣ₃ is discharging, the capacitor Cᵣ₄ is charging, and while capacitor Cᵣ₁ is charging, the capacitor Cᵣ₂ is discharging. This equivalent model, in turn, after removing ideal 1:1 turns ratio transformer, results in equivalent circuit model of FIG. 19c which can be used to identify the equivalent resonant capacitor Cᵣₑ of the final resonant circuit model of FIG. 19d as the series connection of capacitors (Cᵣ₁+Cᵣ₂) and (Cᵣ₃+Cᵣ₄) and as given before in (11).

For the series resonant circuit of FIG. 19d we can write two first order differential equations as:

Lᵣ₂diᵣ₂/dt=−vᵣ (22)

Cᵣₑdvᵣ₂/dt=iᵣ₂ (23)

the solution of which is given by:

iᵣ₂(t)=Iₘ₂ sin(ωᵣ₂t) (24)

vᵣ₂(t)=−Δvᵣ₂ cos(ωᵣ₂t) (25)

where

R_{N2}=√Lᵣ₂/Cᵣₑ (26)

is a natural resistance of the second resonant circuit and Δvᵣ₂ is the half of peak-to-peak AC ripple voltage on resonant capacitor during OFF-time interval and given by

Δvᵣ₂R_{N2}Iₘ₂ (27)

Same as before the equation for resonant inductor current (24) obviously has both positive and negative current parts, but only the positive current is allowed to flow in the actual converter circuit due to the current flow restriction to positive part only imposed by the current rectifier CR₂ in circuit model of FIG. 19a and the actual converter of FIG. 15a. Thus, the solution (25) must be limited to positive part only, so that:

iᵣ₂(t)=|Iₘ₂ sin(ωᵣ₂t)|(28)

where parallel bars indicate positive value only. This therefore imposes that the second resonant current flow will be limited to the OFF-time interval DT_{S} only, so that:

(1−D)T_{S}=0.5Tᵣ₂ (29)

where resonant period Tᵣ₂ is given by:

Tᵣ₂=1/fᵣ₂ (30)

in which fᵣ₂ is the second resonant frequency given by:

ωᵣ₂=2πfᵣ₂ (31)

The factor 0.5 in equation (20) signifies that resonant current flows only during one half of the total resonant period Tᵣ₂.

Note from (29) that the resonant current is made to flow starting from zero current level and completing its half resonance at zero current level but after time (1−D)T_{S} has elapsed. This now makes an ideal point for the first resonance to start again for the subsequent ON-time interval DT_{S}.

### Combining the Two Independent Resonance's

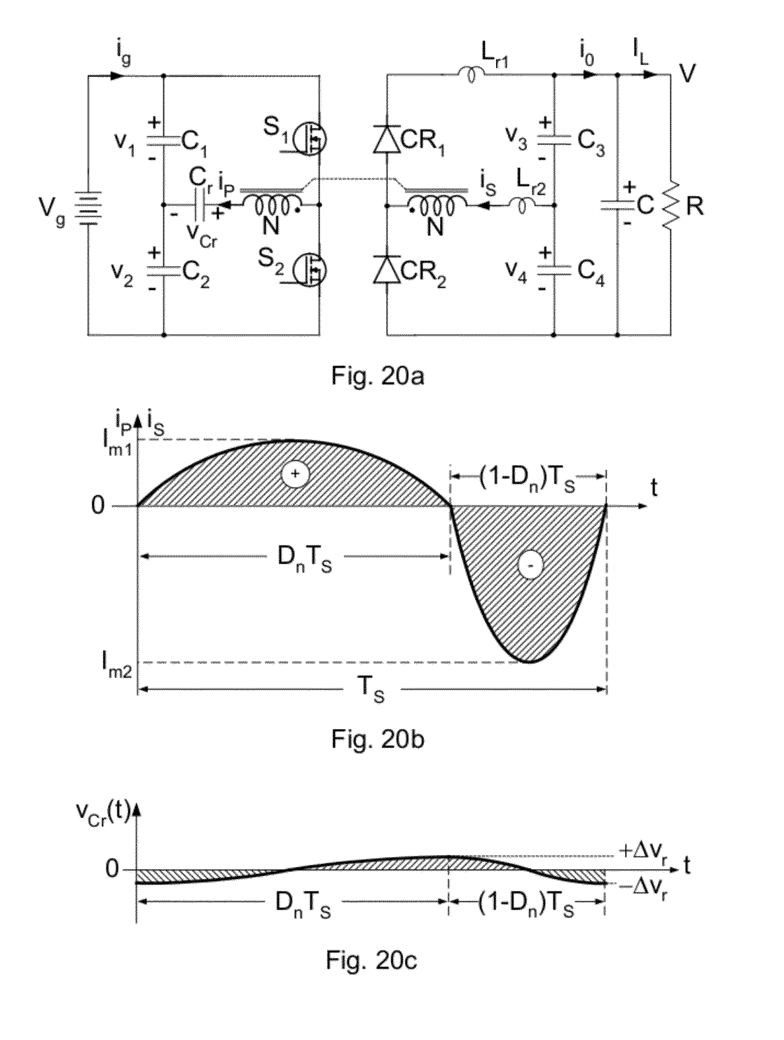

Now we can combine the two resonances: one for ON-time interval and another for OFF-time interval into a complete resonant currents and resonant voltages of the converter. We can demonstrate this also on another embodiment of the present invention illustrated in FIG. 20a. In this configuration, an additional capacitor Cᵣ is inserted in series with the primary winding to play the role of the equivalent resonant capacitor Cᵣₑ in previous configurations. Thus, the input capacitors are therefore renamed C₁ and C₂ and output capacitors C₃ and C₄ to signify the fact that they do not determine the resonance anymore, since they are now chosen to be larger (three or more times) then the resonant capacitor Cᵣ that is:

Cᵣ<<C₁, C₂, C₃, C₄ (32)

Note that the previous resonant circuit analysis applies equally and results in the same equations as above, except for Cᵣ=Cᵣₑ.

We can now combine the two resonances and show both the resonant current iᵣ and resonant voltage v_{Cr} solutions for both ON-time and OFF-time intervals in FIG. 20b and FIG. 20c respectively. To connect the two separate resonant inductor currents is straightforward as their values at the point of intersection are identical to zero as illustrated in FIG. 20b.

In the derivation of the two resonances, we assumed that the resonant capacitor voltages Δvᵣ₁ and Δvᵣ₂ have two different values in the two intervals. Here we now see, that it is the same physical capacitor Cᵣ which takes part in both resonance's and connects their solutions in two intervals. As a voltage on capacitor must be continuous and cannot have a jump at the point of transition, the capacitor Cᵣ voltage must be equal at the transition from one interval to the other as shown by smooth ripple voltage of the resonant capacitor vᵣ(t) with Δvᵣ ripple magnitude at transition as shown in FIG. 20c. Thus:

Δvᵣ₁=Δvᵣ₂=Δv₁ (33)

One can also see that the resonant capacitor current i_{Cr} waveform must be charge-balanced in the steady-state otherwise resonant capacitor Cᵣ would never reach a steady-state DC voltage. Now it is interesting to determine what that resonant capacitor steady-state DC voltage V_{Cr} must be. Following the same resonant analysis developed previously, but now with the separate resonant capacitor Cᵣ inserted in series with the transformer primary and for 1:1 transformer turns ratio, the AC flux balance on the transformer imposes for the nominal duty ratio D=Dₙ:

V₁=V₃=DₙV_{g} (34)

V₂=V₄=(1−Dₙ)V_{g} (35)

V=V_{g} (36)

Note that under the above DC conditions, the first resonant circuit model for ON-time interval has the capacitors C₁ and C₃ in series but with the magnitudes of DC voltages satisfying (34). However, their polarities in the model will be such as that their DC voltages subtract. Similarly will be the case for input voltage and output voltage polarities but with their magnitudes given by (36). The net result is that the resonant circuit model for ON-time interval will reduce to the simple series resonant circuit model as before, but with the resonant capacitor DC voltage V_{Cr}=0. The same analysis applies to the OFF-time interval and will also result in V_{Cr}=0. This is further reinforced by the waveform on the resonant capacitor illustrated in FIG. 20c showing zero DC voltage on the resonant capacitor and AC ripple superimposed on it. Note that this is condition obtained for the special case when the two resonances are combined as described above. The DC voltage on this resonant capacitor will, however, start to appear for duty ratios other than this nominal case where D=Dₙ. Thus, under the conditions described above, even for 400V input DC voltage, the resonant capacitor will have a zero DC voltage. Once again, this is another clearly distinguishing feature of this new resonant method in comparison with prior-art resonant methods.

Direct consequence of the charge balance on this resonant capacitor is that resonant capacitor Cᵣ conducts no net DC current, which imposes the same on the transformer primary and secondary currents shown on FIG. 20b. Therefore, this transformer has ideally desirable feature of not having a DC bias in either transformer primary or transformer secondary. Therefore, it can be built on a core with high permeability magnetic material and without any air-gap to result in large magnetizing inductance, small magnetizing current and hence effectively no DC storage. Note also that this feature is available for any operating duty ratio D. This is further explained in a later section on the transformer comparison with prior-art converters.

Hence an appropriate name for this converter would be Isolated Storageless Converter to signify the fact that there is no DC energy storage in the magnetic components of the converter. All known prior-art isolated converters have a DC energy storage either in the transformer (flyback, etc.) or in the inductors (forward converter, bridge-type converters, SEPIC and other known converter topologies).

Primary transformer current shown in FIG. 20b is shown shaded with two areas marked + and − to reflect the fact that the areas under the primary and secondary current are identical resulting in no net DC current in transformer. This condition and equations (18) and (24) show that the peaks of the two resonant currents are not independent but related by the formula:

Iₘ₁=Iₘ₂√Lᵣ₂/Lᵣ₁ (37)

As we have combined two half resonant intervals into one complete switching period we can now determine the composite resonant period as:

Tᵣ=0.5Tᵣ₁+0.5Tᵣ₂; fᵣ=2fᵣ₁fᵣ₂/(fᵣ₁+fᵣ₂) (38)

where fᵣ is a composite resonant frequency.
As will be described in more details in the section on the control and regulation methods for the output voltage control, the variable duty ratio control will be applicable when

f_{S}≦fᵣ (39)

that is when switching frequency is smaller than composite resonant frequency. Another resonant control method is also available when operating at fixed nominal duty ratio but with switching frequency increase above the composite resonant frequency given by (38).

Transformer current is shown to be a composite of the half-sine wave currents of the individual resonant currents excited by two resonant inductors. This is a unique feature of the new resonant method using two independent resonance's (one for ON-time interval and another for OFF-time interval and the duty ratio control of the output voltage at constant switching frequency. This is in clear contrast to other resonant methods in which resonance's are not coinciding with the ON-time interval and OFF-time intervals and which use fixed 50% duty ratio and variable switching frequency for control of output DC voltage.

We now look into the transformer flux to determine its size relative to prior-art isolated converters.

### Transformer Flux and Transformer Size

We have already established that for the composite resonant current waveform of FIG. 20b we have:

V_{G}=0 (40)

By applying the criteria that the transformer magnetizing inductance must be volt-second balanced on the 1:1 turns ratio transformer of the converter in FIG. 20a we can apply the volt-second balance criteria to the transformer to get:

V₁DT_{S}=V₂(1−D)T_{S} (41)

and using

V₁+V₂=V_{g} (42)

from half-bridge connection on input side (FIG. 20a).
We solve for V₁ and V₂ as:

V₁=(1−D)V₂ (43)

V₂=DV_{g} (44)

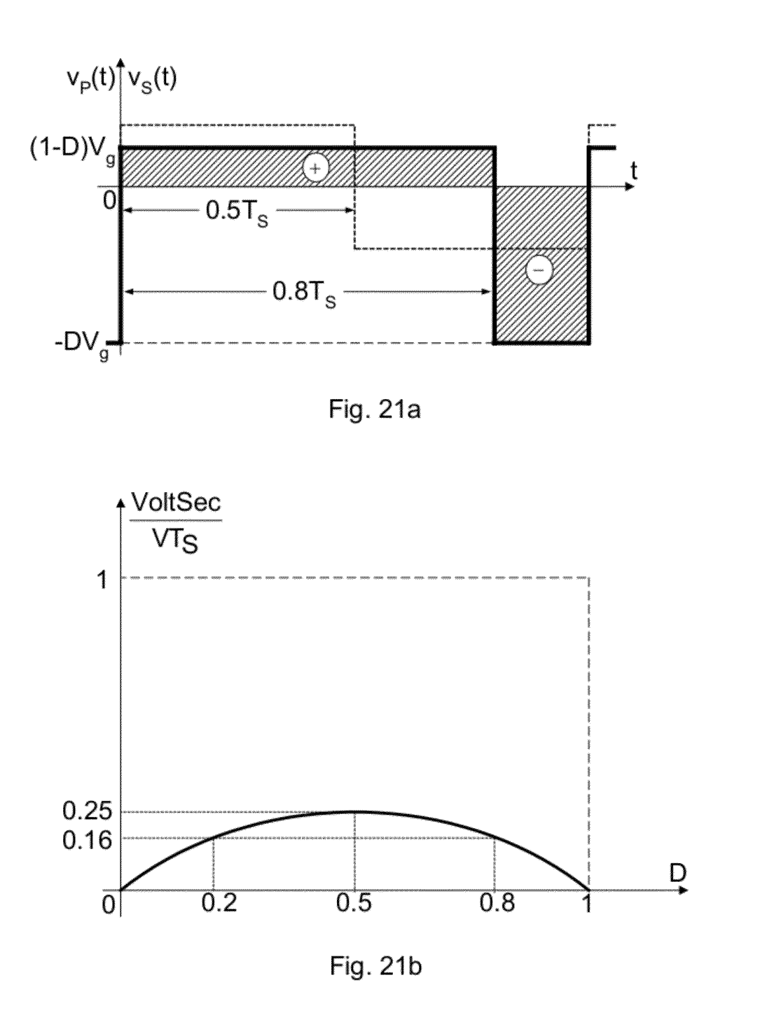

Based on the results (43) and (44) the salient waveform of the transformer primary is shown as a square-wave like voltage with the voltage levels given by (43) and (44) in FIG. 21a. From this one can derive the transformer primary flux φ relative to output DC voltage V and single turn output winding as:

φ/VT_{S}=D(1−D) (45)

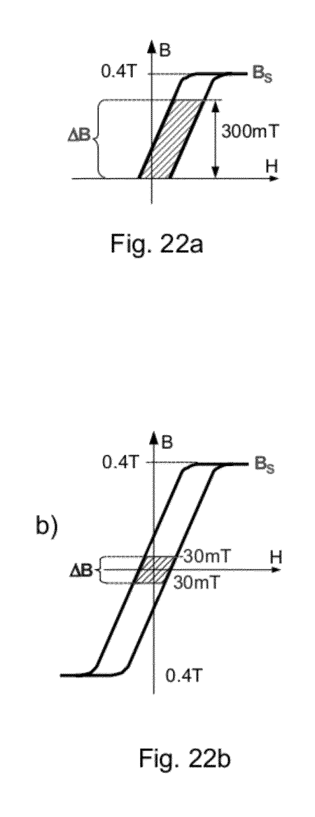

which is shown plotted in the graph of FIG. 21b. As a reference, the dotted lines at the level of one show the flux level of the prior-art converters (forward, bridge-type extensions, etc.) as also shown earlier in FIG. 6c. Comparison reveals the rather large reduction of the flux level in the transformer of the present invention compared to the prior art isolation transformers. For example, when operating at 50% duty ratio the converter of present invention has 4 times smaller flux and thus its transformer can use at least four (4) times smaller core-cross-section to result in much smaller transformer size. In addition, operation at duty ratio of D=0.8 as shown in FIG. 21a and FIG. 21b, for example, would result in flux and magnetic core cross-section reduction of six (6) times. Actual reductions could be even bigger. For example, the transformer in the forward converter can only operate with unidirectional flux excursions effectively utilizing only half the core flux capability. Thus, the transformer of present invention when compared with forward converter can be made using magnetic cores having even smaller core-cross sections. As the core losses are proportional not only to flux density but also to core volume, the significantly reduced core volume makes it possible to use even bigger reduction of the magnetic core size as higher flux density operation would not have such a negative thermal impact on the core. This is illustrated by the core flux excursions shown for the forward converter in FIG. 22a and for present invention in FIG. 22b. Note the unidirectional flux excursions of the flux in the isolation transformer of the forward converter and the high flux level of 300 mT as compared to the bi-directional flux excursions and the flux level of 60 mT in the present invention.

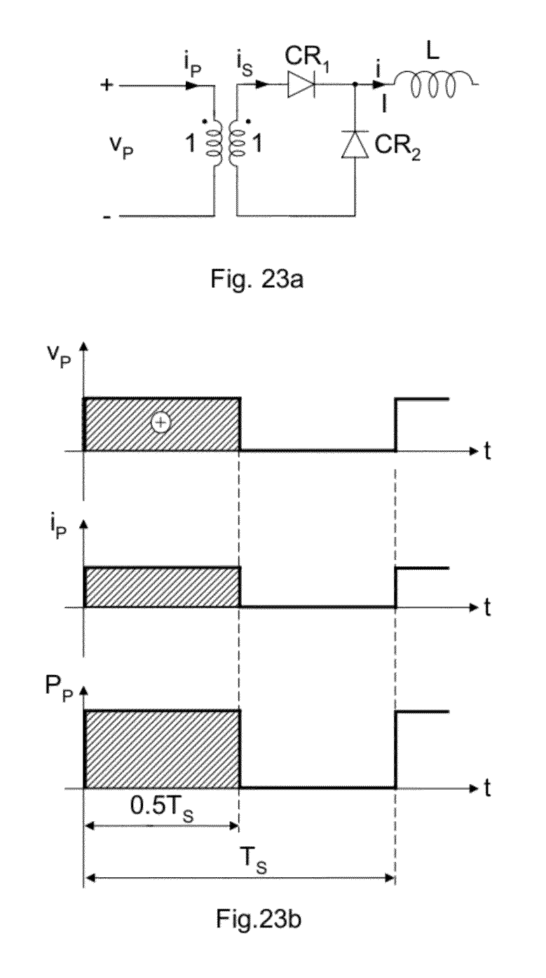

The winding utilization of the two transformers is compared with reference to FIG. 23a and FIG. 23b describing first operation of the transformer in the forward converter. Note that the power is transferred only during time CR₁ diode conducts while for the rest of interval both primary and secondary winding are idling (actually only conducting a small reset current).

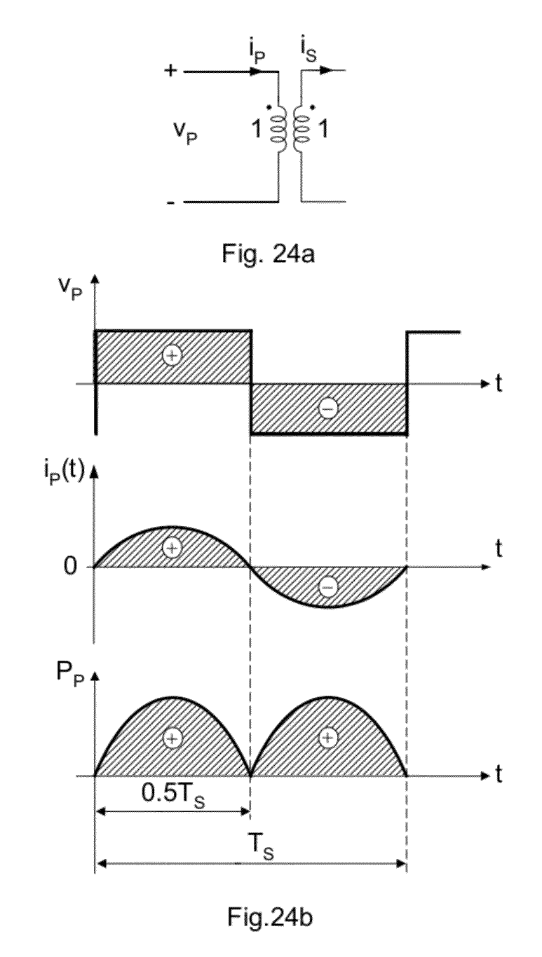

The transformer of the present invention operates as a true AC transformer as shown in FIG. 24a and FIG. 24b, as it conducts the power from primary to secondary during both switching intervals, ON-time interval and OFF-time interval. In FIG. 24b, the special case when D=0.5 is highlighted showing a half-sinusoidal primary and secondary currents, and the instantaneous power transfer during both intervals.

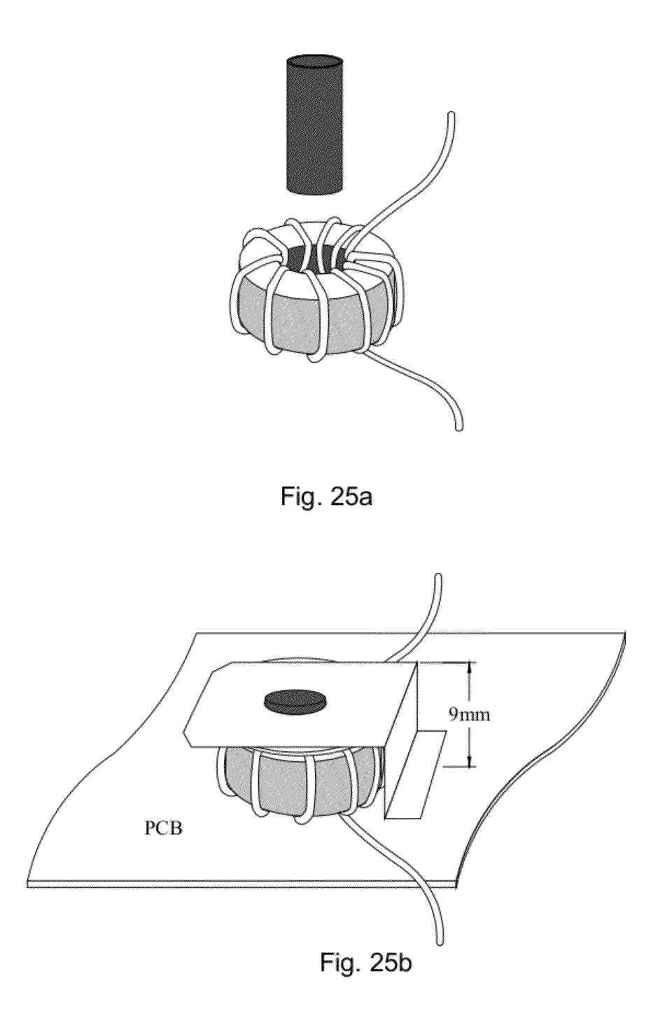

The above ideal transformer features, low AC flux and ability to use an un-gapped core, is further underscored by the fact that even a toroidal magnetic core implementation of the transformer of the present invention is possible as illustrated in FIG. 25b. Due to low AC flux, a single turn could be used for secondary winding, even in case of applications with 12V or 15V output voltage leading to 15V per turn design. The primary winding is then wound directly on the toroidal core, while the single turn secondary winding is made out of a single cylindrical foil passed through the center of the toroid. This not only provides a good magnetic coupling, but also very small compact size and high efficiency as the winding lengths are minimized.

An alternative practical design is to use low-profile LP cores or EER core types. Then primary winding with say 15 turns in one layer could be implemented, while the single turn secondary foil winding could be wound at the top of primary for very good magnetic coupling with primary, which also provides a very simple termination for the single turn secondary foil winding.

### Comparison of the Isolation Transformers

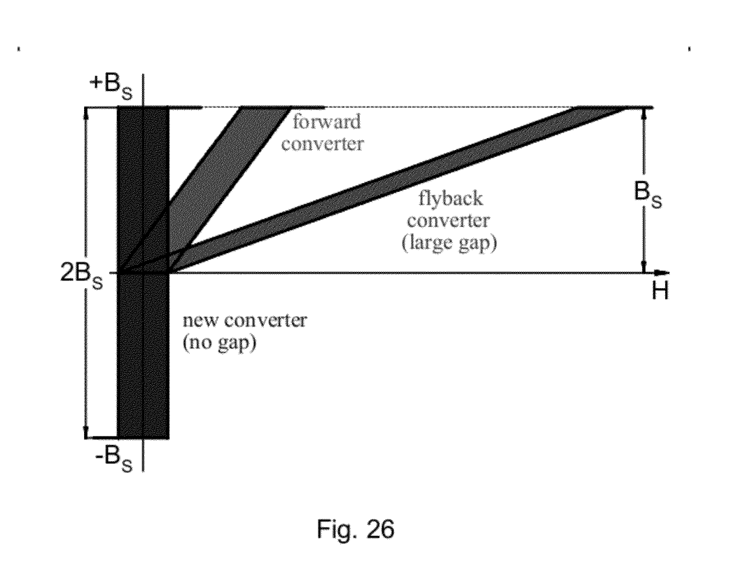

The isolation transformers of the switching converters can be broadly divided into the there types, highlighted with the B-H lop characteristics illustrated in FIG. 26:
1. Bi-directional flux capability, no DC-bias, and automatic core reset such as in tuk converter.
2. Unidirectional flux capability and no DC-bias as in forward converter, which requires additional circuit to reset the magnetic core.
3. Unidirectional flux capability and the DC-bias, requiring the use of the air-gap such as in flyback converter. The larger the DC-bias the bigger is DC storage and the air-gap and smaller the magnetizing inductance of the transformer.

The present invention utilizes a tuk-type single ended (no bridge-type) isolation transformer and thus has no DC storage and uses an un-gapped core to obtain highest possible magnetizing inductance and lowest magnetizing current. It has automatic bi-directional flux capability so it fully utilizes the magnetic core flux capability.

### Output and Input Ripple Currents

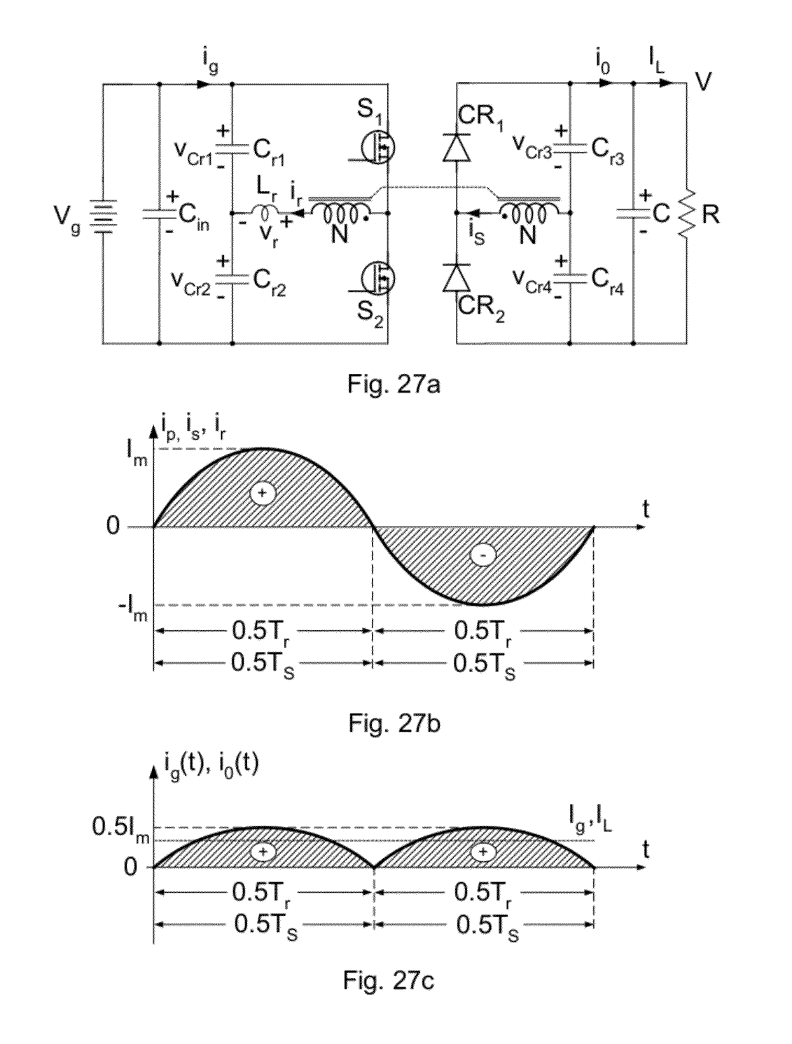

We now analyze the ripple current distribution in the converter of FIG. 27a assuming once again that the input and output capacitors are once again taking the role of effective equivalent resonant capacitors as analyzed before. The resonant inductor is shown as an external inductor in series with the primary of the isolation transformer. This time, the objective is to find the actual wave shape of the currents iₒ and i_{g} highlighted in FIG. 27a. For simplicity a 1:1 turns ratio of the transformer is chosen and the operation at 50% nominal duty ratio Dₙ although the similar benefits would be obtained at other duty ratios. FIG. 27b shows that the resonant inductor current iᵣ is split equally between the two capacitors on the output side as shown in FIG. 27c and likewise between the two capacitors on the input side.

This now points out yet another important advantage of the present invention. Despite the absence of either inductor on input side or the absence of the inductor on output side, both the output current and input currents are continuous, as though they do contain inductors maintaining current continuity. This performance is attributed solely due to the half-bridge connection on the input side and half-bridge connection on the output side and dual resonant method.

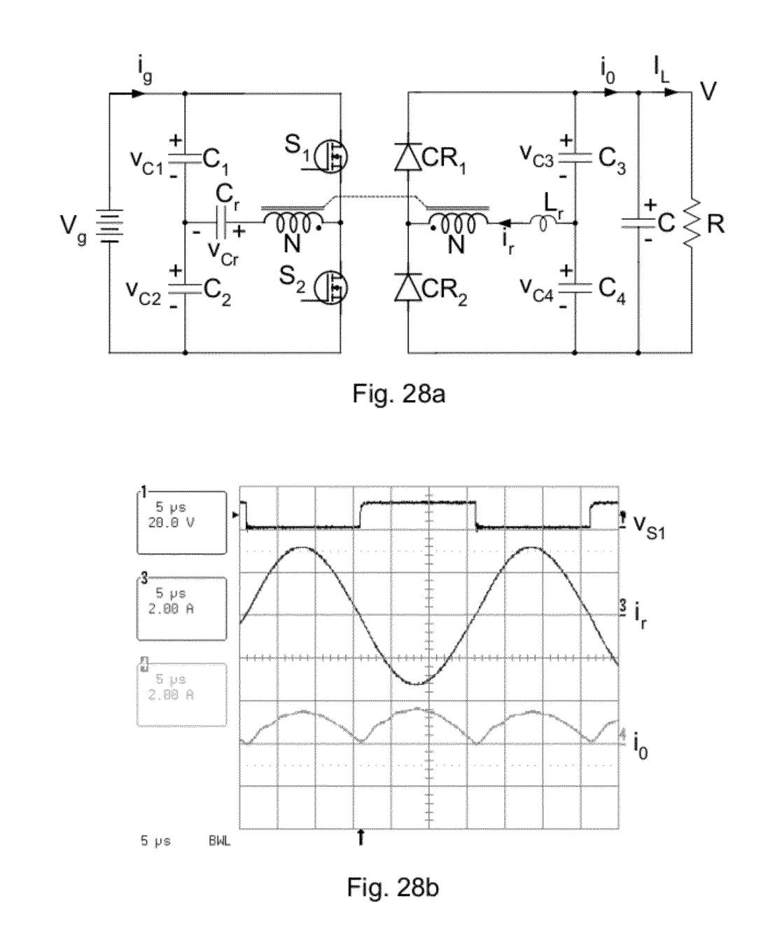

To confirm this, an experimental circuit is made by use of yet another embodiment of the converter as shown in FIG. 28a in which the resonant inductor Lᵣ=12 μH is placed in the transformer secondary together with an external resonant capacitor Cᵣ=1 μF in series with transformer primary which determine the resonant frequency of 32 kHz. Due to operation at 50% duty ratio this is also the switching frequency. For the input voltage of 32V and DC load current of 1A, the measured resonant current is shown in FIG. 28b as the second trace. The third trace shows the measured current i₀, which has a shape of a rectified resonant current, but with half the magnitude. We can now correlate the peak of the resonant currents to the DC load current I_{L}. For this special case of equal resonant frequencies, the DC load current I_{L} can be correlated to the resonant currents magnitudes as:

Iₘ₁=Iₘ₂=πI_{L} (46)

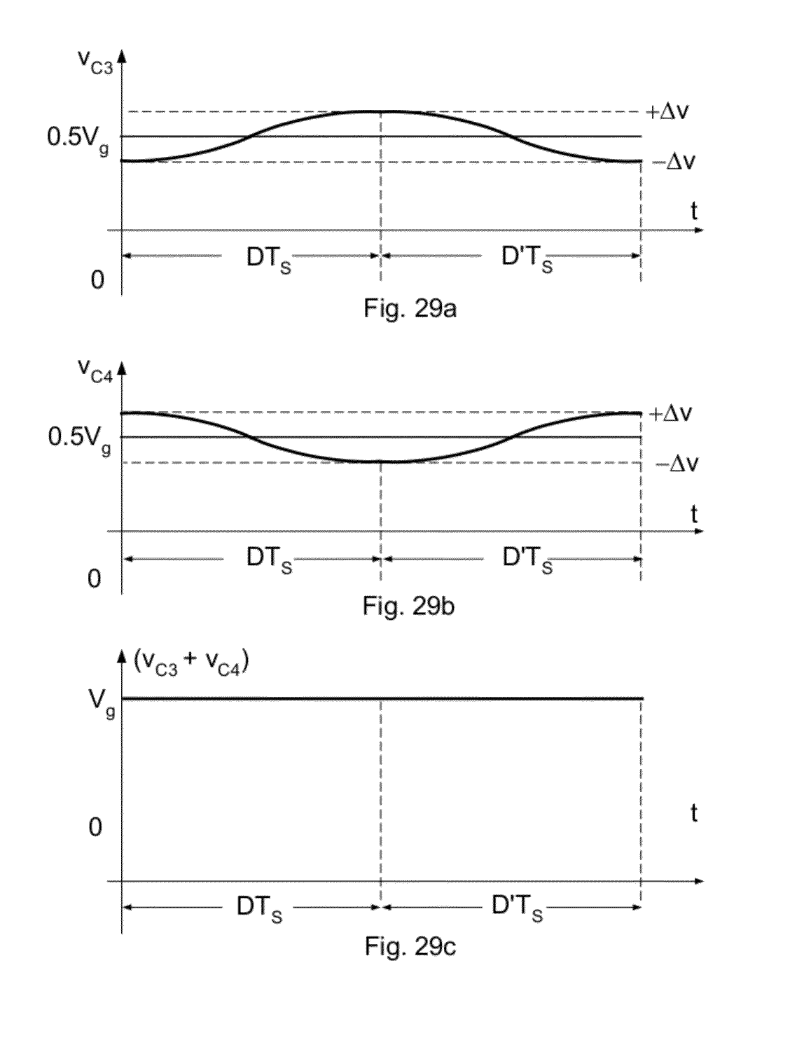

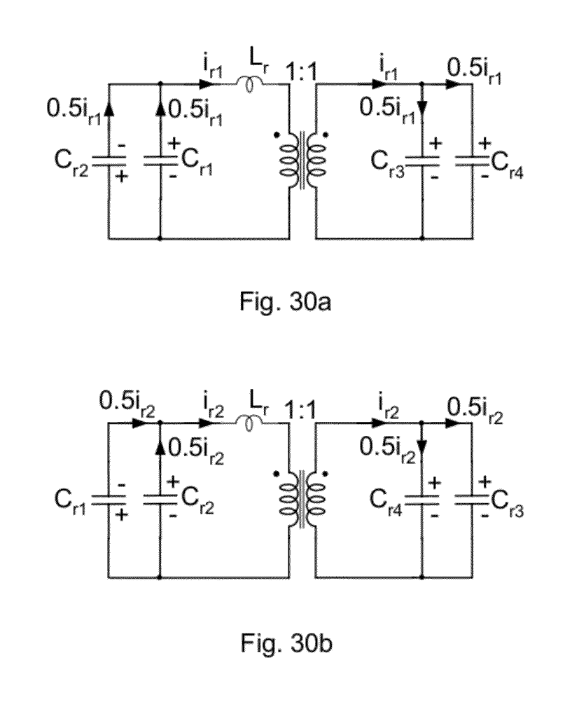

Note that the output capacitors C₃ and C₄ have DC voltages to which a sinusoidal ripple voltage is added. However, as seen in FIG. 29a and FIG. 29b their DC voltages add together, while their AC voltages are out of phase and effectively subtract from each other, so that the total voltage across the output is theoretically a pure DC voltage with no AC ripple as shown in FIG. 29c. This theoretical prediction is backed up by the equivalent circuit models of FIG. 30a and FIG. 30b that both resonant inductor currents are split not only between the two output capacitors but also between the two input capacitors. Furthermore the equivalent circuit models show that the AC ripple voltages are also out of phase.

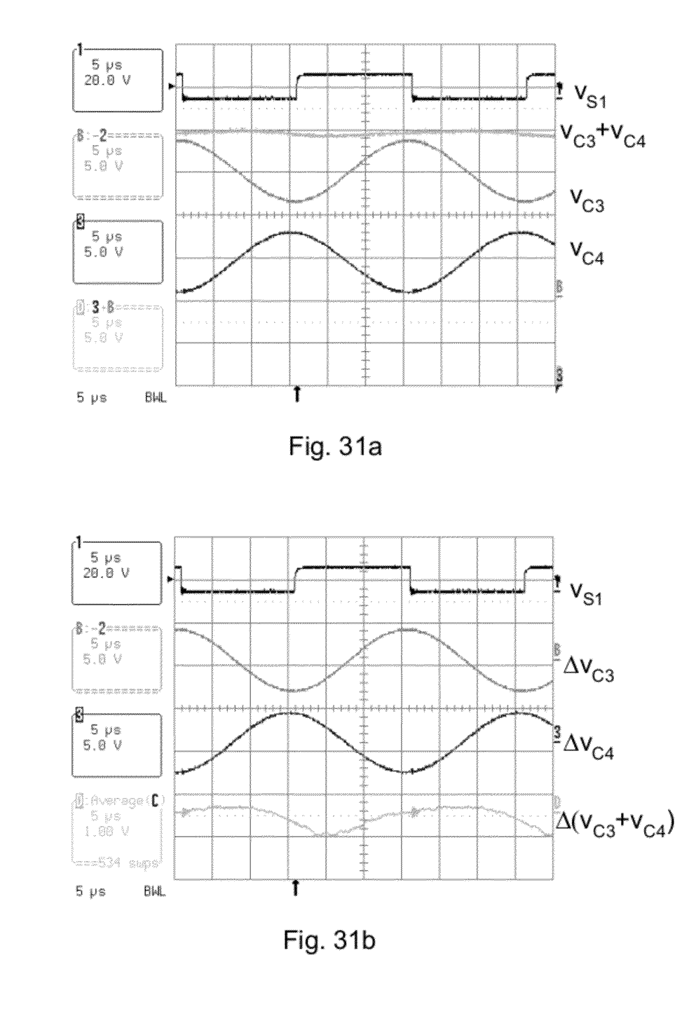

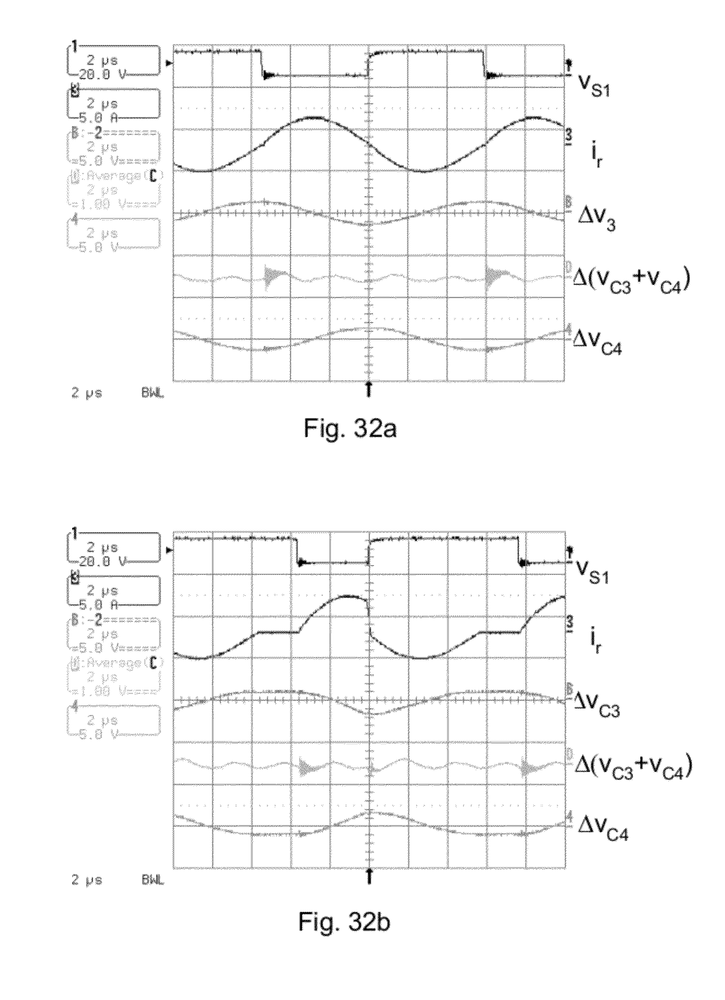

To verify the magnitude of this ripple voltage cancellation effect, the experimental waveforms with DC and superimposed AC ripple voltages are shown in FIG. 31a the output is maintained even in the face of the DC voltage change on the output by duty ratio reduction when converter is operating in the regulation region with output DC voltage reduced from 1:1 conversion ratio as illustrated by the measured waveforms in FIG. 32b (fourth trace from top).

### Zero Current Switching of All Switches

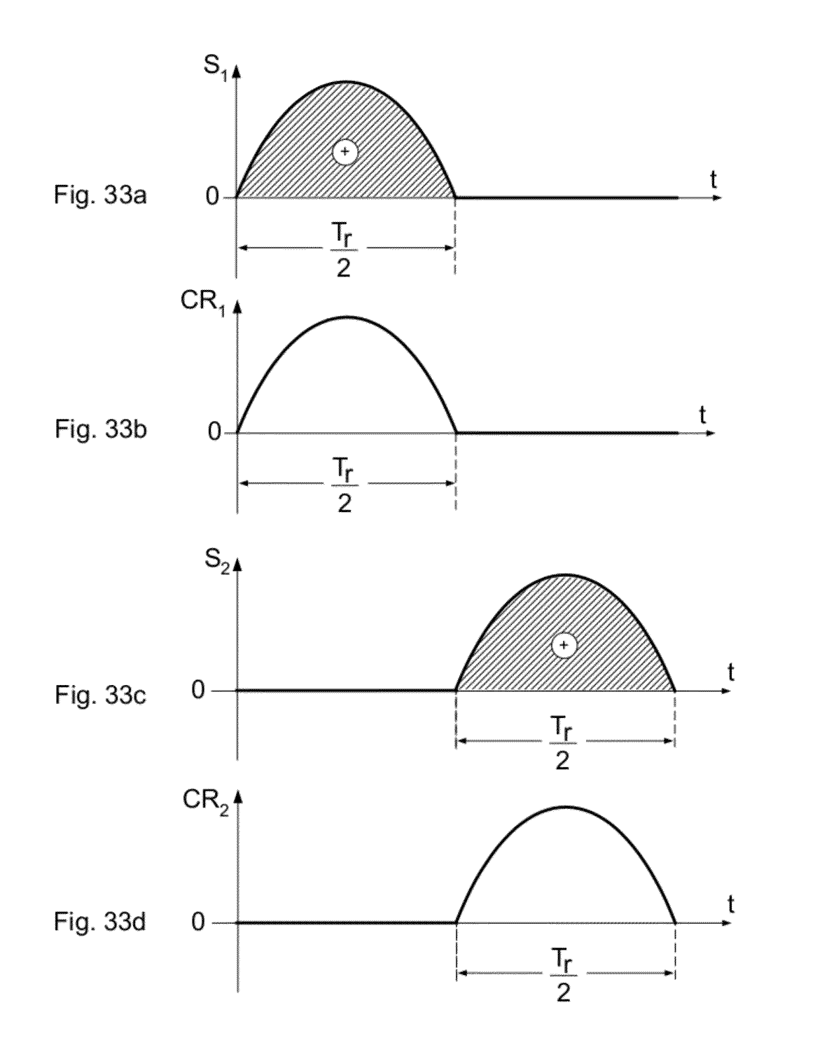

The previous analysis confirmed that all switches used in the present invention have the minimum possible voltage rating and voltage stresses. Now, it can be easily seen, that all switches also have another very desirable feature: all switches have a zero current switching at both their turn-ON and at their turn-OFF as seen in the switch current waveforms on FIG. 33a, FIG. 33b, FIG. 33c, and FIG. 33d. This feature is very desirable as it helps eliminate the switching losses as well minimizes the stress of switching devices at the switching instances.

### Zero Voltage Switching of Primary Side Switches

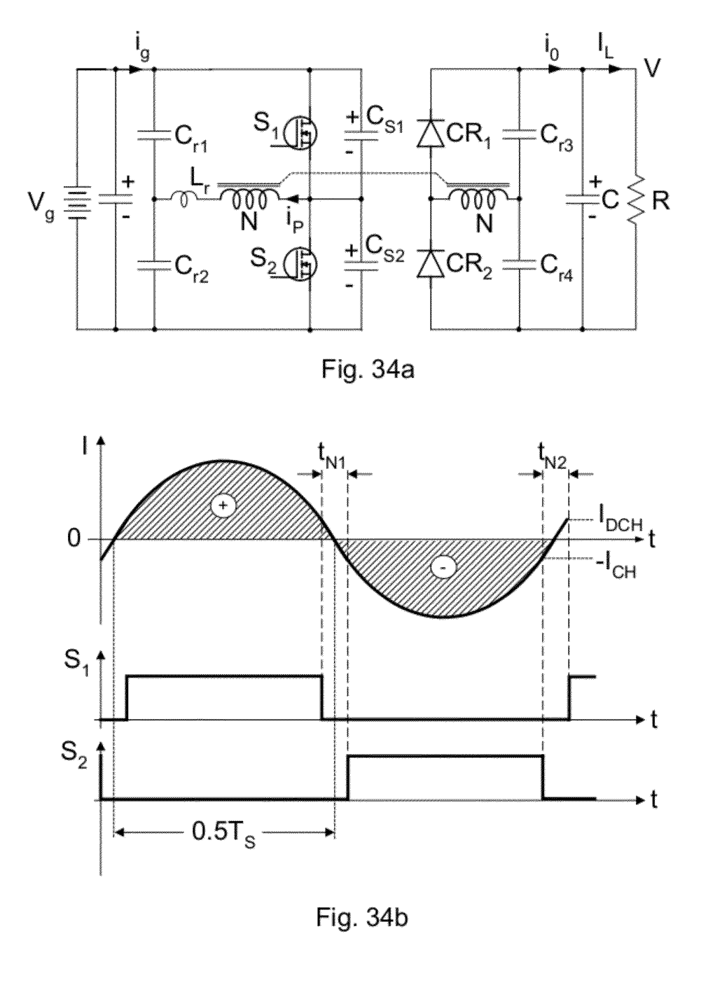

In applications with high input voltage, such as from rectified AC line or 400V DC, the switches on primary high voltage side, have a rather high parasitic drain-to-source capacitances, as illustrated by capacitances C_{S1} and C_{S2} in FIG. 34a. These capacitances store significant charge when the switches are OFF which is subsequently dissipated when the switches are turned ON resulting in significant switching losses and reduction of efficiency. The converter of present invention is capable of eliminating these losses by exchanging stored charges between the two switches in a lossless manner. As seen in FIG. 34b the primary side switches are operated so that a small dead time is created during which neither switch is conducting to result in two natural transition intervals. In practice, this is simply implemented by first adjusting the resonant current frequency and switching frequency to result in zero current crossing of the resonant current at 50% duty ratio. Let us assume that this is achieved at 50 kHz switching and resonant frequency. The switching frequency is then slightly raised, say to 55 kHz, so that now the resonant inductor current has some positive current value I_{DCH} at beginning of first transition t_{N1} and some small negative current value −I_{CH} at the beginning of second transition t_{N2} as shown in FIG. 34b.

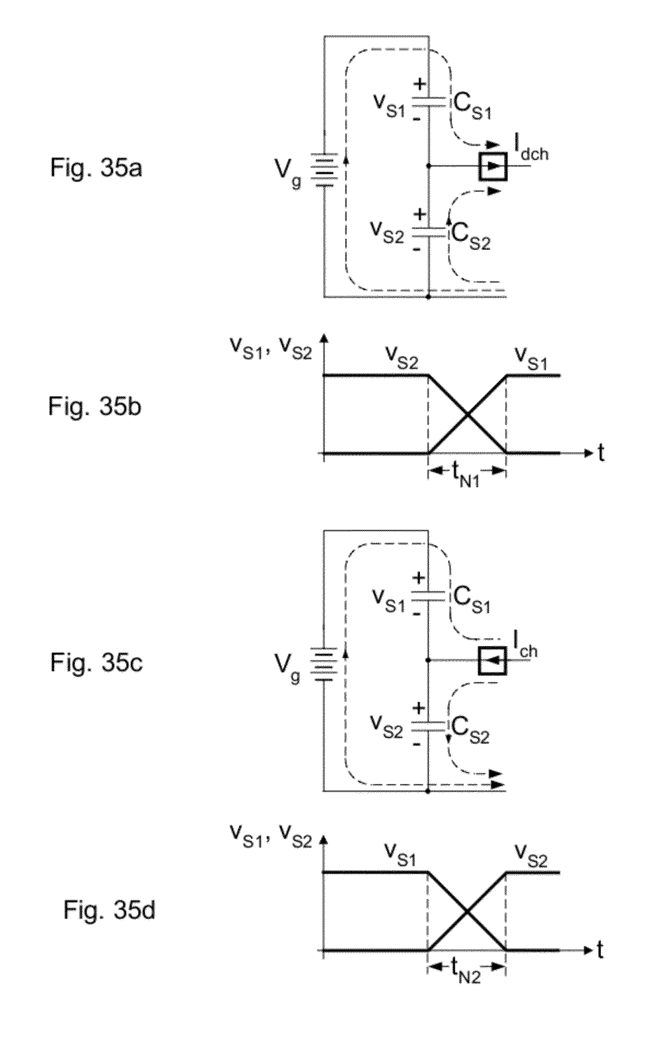

During the first transition resonant inductor current effectively discharges capacitor C_{S2} as seen from FIG. 35a by transferring its charge to the other capacitor C_{S1} and causes a linear drop in the voltage across the switch. When this voltage reaches zero as seen in FIG. 35b, the respective body diode of switch S₂ will turn ON to prevent opposite charge and the switch S2 could be turned ON at zero voltage with no losses. In practice, the body-diode conduction is detrimental and for highest efficiency the switch S₂ is turned ON at low voltage but not at zero to prevent any body-diode conduction. Note that the resonant inductor current changes from positive to negative during OFF-time interval as seen in FIG. 35c, which results in current source I_{ch} of opposite polarity resulting in now discharging capacitor C_{S1} reducing the voltage of S₁ switch to zero at which instant it could also be turned-ON with zero switching losses as seen in FIG. 35d. Zero voltage switching is verified experimentally and included in the last section in which other key and salient features of the present invention are verified on an experimental 120V to 5V and 170V to 12V experimental prototypes.

The above zero-voltage switching method is very effective at the full load and half-load currents. However, at very light load, such as 10% and at no load, the total resonant current is too small in magnitude to make zero voltage switching based on this method effective. Another method for zero-voltage switching, which is effective from full-load to no-load operation is available and will be introduced in later section.

### Stressless Switching

The primary side switches turn ON at near zero voltage and near zero current, thus much reducing the switching losses but also reducing the stresses on the switches resulting in their more reliable operation. The secondary side current rectifier switches operate at zero current and zero voltage at both turn-ON and turn-OFF, thus operating at minimum stress conditions. In other converters the output switches turn OFF at high current, which is another source of high turn-OFF losses, which often are even higher then the turn-ON switching losses. Similarly the current rectifiers on the secondary side turn OFF at zero current, hence eliminating undesirable losses due to reverse recovery time of the diodes. Zero current of output current rectifiers therefore also results in low stresses on the switches. Thus, one of the unique features of the present invention is that all of its switches are operated in a stressless manner in addition to having the minimum possible voltage stresses and low switching losses. The added benefit is that such operation of the switches results in much reduced EMI noise as well.

### Other Embodiments

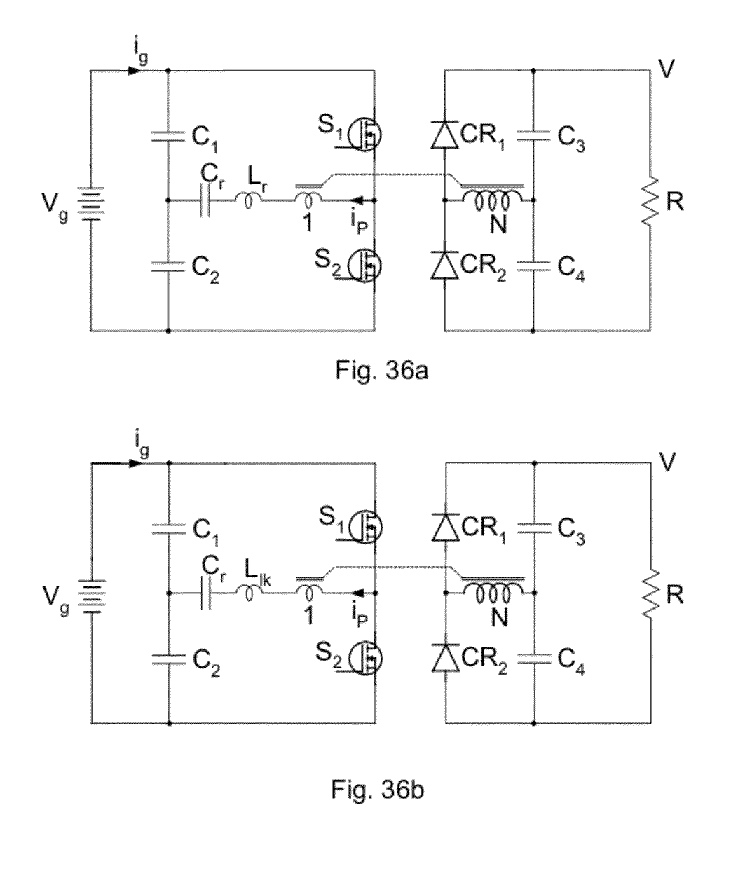

Several variants of the present invention are illustrated next. FIG. 36a illustrates a high voltage converter with 1:N step-up transformer and with both resonant capacitor and resonant inductor located on the transformer primary side. In some applications, one could design the isolation transformer so that its leakage inductance serves as the resonant inductor, thus eliminating the need for separate external resonant inductor as illustrated in FIG. 36b.

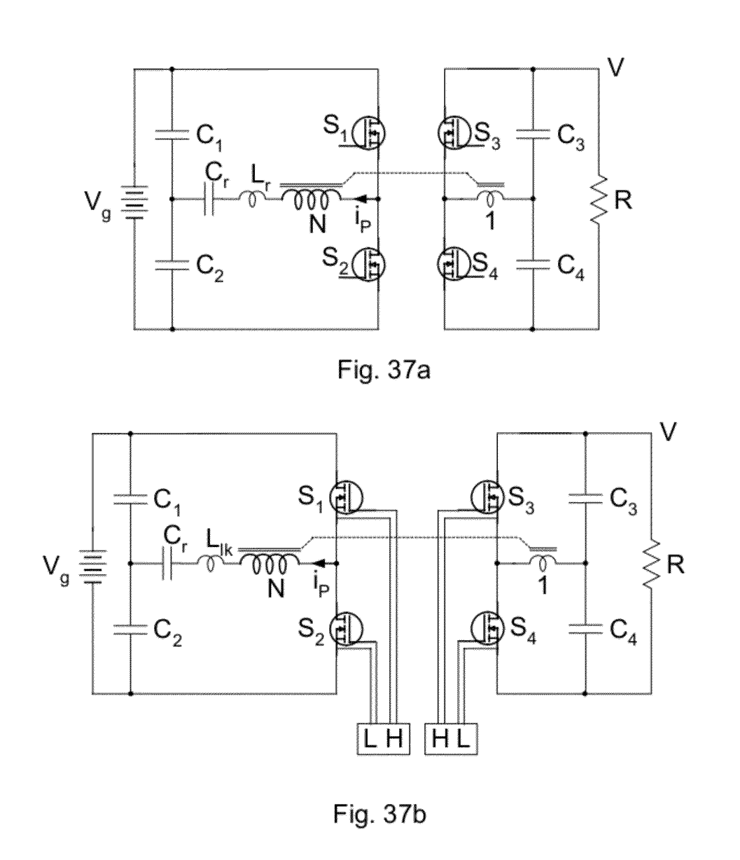

For low voltage application a N:1 step-down transformer as in FIG. 37a is preferred. In addition to reduce conduction losses of output switches, MOSFET synchronous rectifiers, as illustrated in FIG. 37a, replace the current rectifiers. The primary side switches could then be driven with a primary low-side/high-side driver, while the secondary side switches could be driven with another low-side/high-side driver referenced to secondary side as illustrated in FIG. 37b.

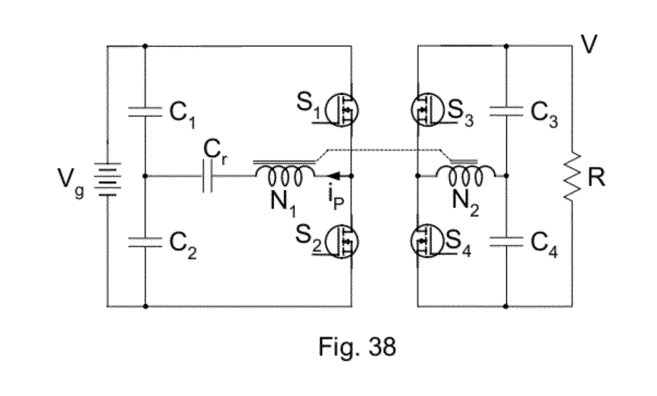

Finally, when the leakage inductance of the isolation transformer is used as a resonant inductor another embodiment shown in FIG. 38 is obtained. These converter embodiments with all MOSFET switch implementations could be operated at 50% duty ratio for simplicity of the drives. Although in that case, they would provide a nominal fixed-conversion ratio determined by the transformer turns ratio, they could also provide a continuous regulation around that operating point by use of duty ratio control as described in next section.

### Continuous Control of the Output DC Voltage

The prior-art resonant converters based on single or multiple resonance's are limited to only one method of control and regulation and that is the increase of switching frequency relative to resonant frequency which is limited especially for wide range of load current changes. The present invention makes it for the first time possible to implement the continuous control and regulation of the output DC voltage by use of duty ratio control as described next.

At first it may appear that the DC-gain of the converter is fixed and equal to 1 so that the output DC voltages cannot be controlled at all in a continuous way as in conventional switching converters. This is, however, not the case, as two methods with variable duty ratio are described first:
a) Variable duty ratio D, constant OFF-time period;
b) Variable duty ratio D, constant switching frequency.

These methods of duty ratio control have not been available in the past for control of any type of the resonant converters, as they could only be controlled by operating at 50% duty ratio and by varying the ratio of the switching frequency to the resonant frequency.

However, if so desired, the present invention is also capable of utilizing the conventional resonant methods of output voltage control, by operating at fixed duty ratio and then varying the switching frequency. In that case, however, the resonant method is not restricted to operate at fixed 50% duty ratio, as other resonant converters, but any duty ratio is equally applicable.

### Duty Ratio Control

The two methods described below are both based on the modulation of the duty ratio of the switches and not on the resonant method of control. This new duty ratio control method is analogous to the duty ratio control of the conventional switching converters but operated in the discontinuous inductor current mode (usually taking place at light load currents in conventional PWM converters) in which the output voltage is not only function of the duty ratio but also dependent on the load current. The same phenomenon takes place here but for all load currents from full load to no load. However, as the converter is operated in the closed loop, this simply results in the duty ratio adjustment made by the feedback loop which will keep the output voltage regulated despite the changes in the input voltage or changes in the load current.

### First Case

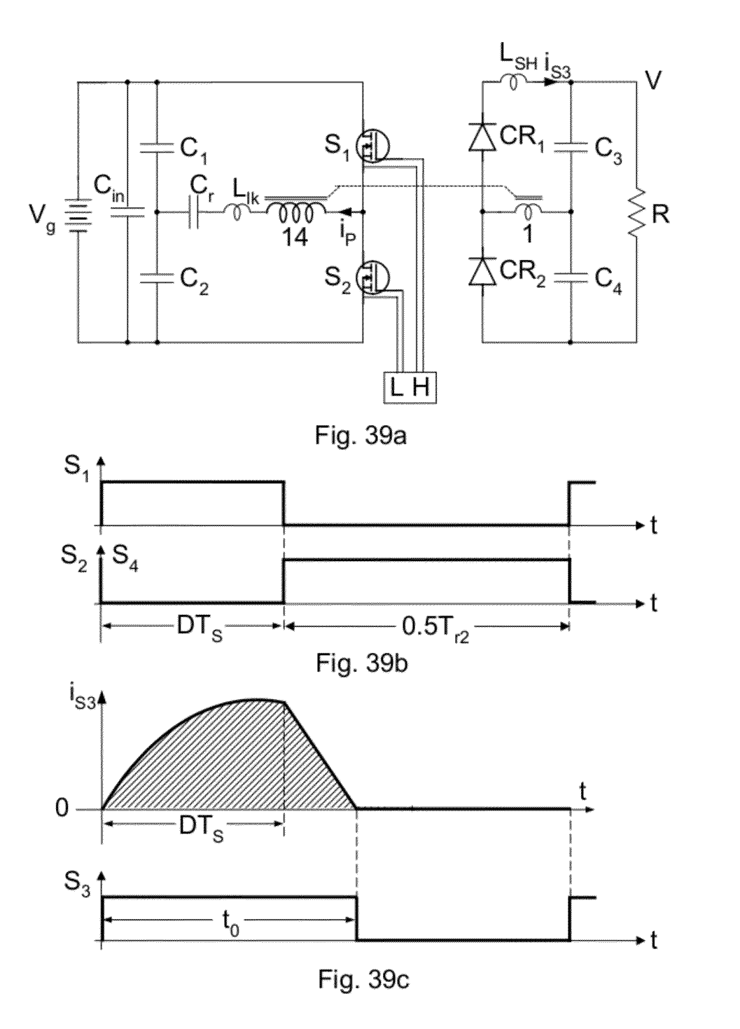

First, we highlight the duty ratio control with constant OFF-time interval. The first method is based on the converter in FIG. 39a in which one resonant inductor is in series with the current rectifier CR₁ while the other is in series with transformer primary. In such a case, the resonant inductors position prevents the simultaneous conduction of the two output current rectifiers.

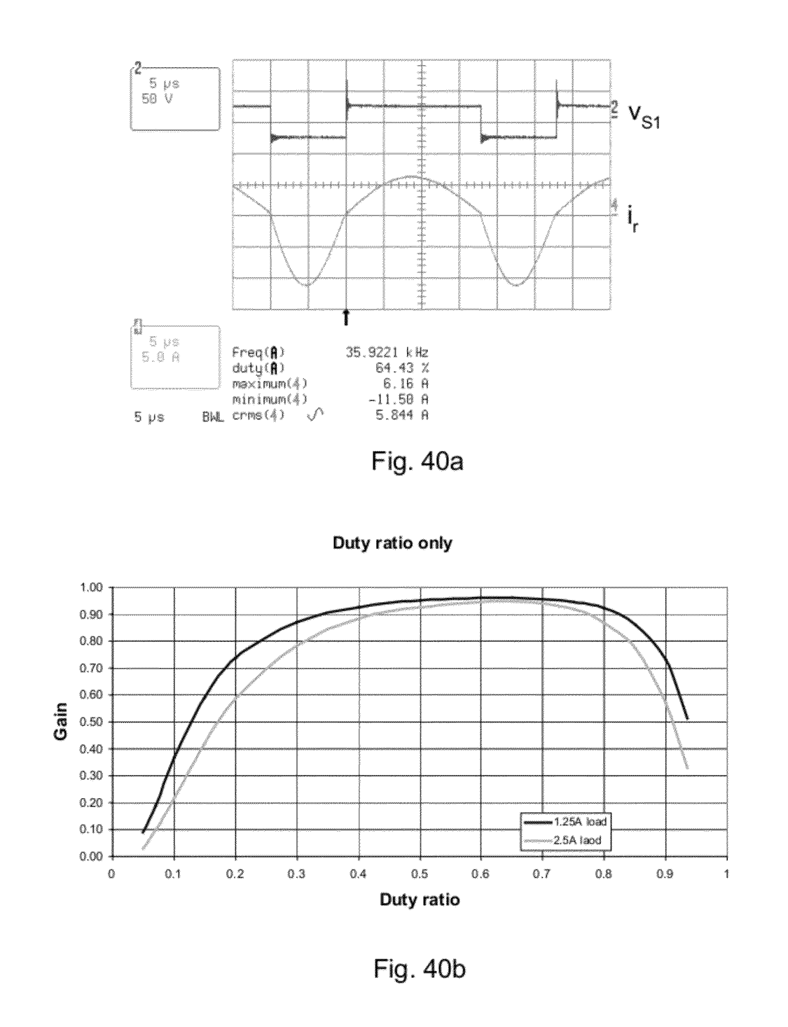

Let us first review the first case of FIG. 39a. When this converter is operated the continuous control of output DC voltage (reduction of it) is obtained by changing the duty ratio control of the main switch S₁, which was initially adjusted to 0.66 duty ratio (see FIG. 40a) resulting in near unity DC voltage gain. By turning this S₁switch OFF at duty ratio less than 0.66, the input current flow is interrupted. However, the presence of the resonant inductances L_{SH} and Lₗₖ maintains the flow of the current i_{CR1} in the current rectifier CR₁ resulting in its linear discharge into the load as shown by the current i_{CR1} in FIG. 39c whose conduction interval t₀ is determined by the current rectifier CR1 conduction. Therefore, when this current rectifier CR₁ switch is implemented by a MOSFET transistor, this transistor must be made to conduct only during the same time as its body diode would conduct. Proper sensing and control must be implemented to insure that this condition is satisfied under all operating conditions. Such MOSFET transistor implementation is only needed for low voltage applications where use of MOSFETs will reduce conduction losses. Only when the linear current stops at zero current level is second current rectifier CR₂ allowed to turn ON and effectively start the second resonant interval at that instant. For best efficiency operation, it is desirable that the OFF-time interval be kept constant and equal to a half of second resonant period, so as to prevent the zero coasting interval (when S₄ switch is current rectifier) or bi-directional current flow of second resonant current when S₄ switch is MOSFET. This will inevitably result in variable switching frequency control and variable duty ratio control. Nevertheless, by proper drive control of the two secondary side MOSFET switches, the constant switching frequency could be maintained over all operating conditions with a slight impact on efficiency.

The resonant current is shown in FIG. 40a adjusted first for zero current crossovers. The DC voltage gain for the converter in FIG. 39a is shown in FIG. 40b for two DC load currents. The above description covers the voltage step-down conversion for duty ratio D smaller than the nominal duty ratio Dₙ=0.66. Note, however, that the duty ratio increase above 0.66 will also result in reduction of the output DC voltage as illustrated by the DC voltage gain measurements in FIG. 40b. This follows another mode of operation, which will not be discussed here in the detail, as anyone skilled in the art could determine following the previous example.

### Second Case

The second case is related to resonant inductor placements as in FIG. 15a in which the two current rectifiers conduct simultaneously during the portion of the switching interval. In that case also the duty ratio change modulates the resonant currents to change the ratio of the DC load current to DC source current continuously and thereby change also the DC voltage current conversion ratio continuously.

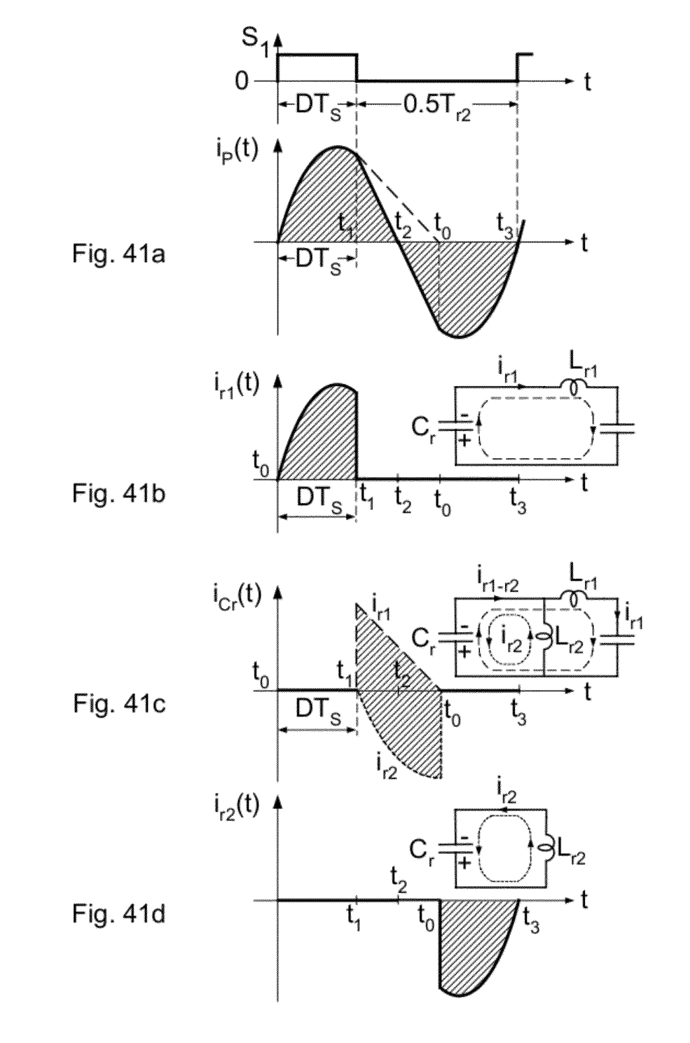

Second case of the DC voltage control for converter with resonant inductors placements as in FIG. 15a, is shown illustrated in FIG. 41a, FIG. 41b, FIG. 41c, and FIG. 41d with corresponding equivalent circuit models. Note the overlapping conduction of both current rectifiers during the interval from t₁ to t₀ and the resulting resonant capacitor current, which is still charge-balanced (equal positive and negative areas under the resonant capacitor current waveform in FIG. 41a).

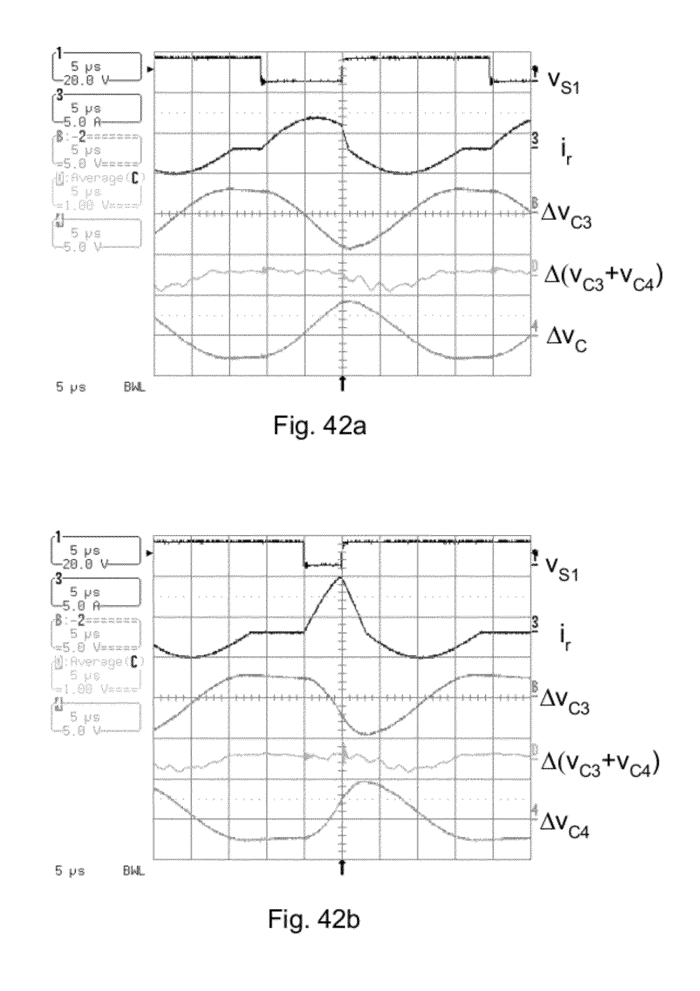

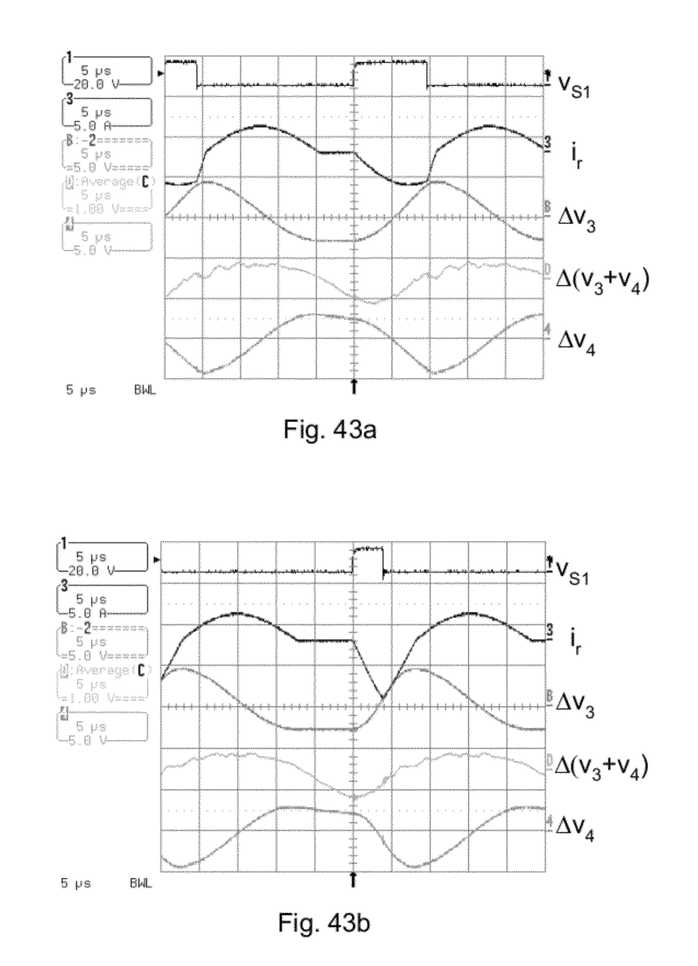

Experimental waveforms in FIG. 42a and FIG. 42b illustrate the modulation of the resonant current during the reduction of duty ratio below 0.66 and operation at constant switching frequency, while the waveforms in FIG. 43a and FIG. 43b illustrate the modulation of resonant current when duty ratio is increased above 0.66 also at constant switching frequency. Both are resulting in continuous reduction of the output voltage as shown in the measurements of FIG. 40b. Note the presence of zero coasting interval, during which resonant capacitor is neither charging nor discharging. These measurements also show the duty ratio control of the output voltage under the two different currents: full load (thin lines) and at half-load (thick-lines) confirming duty ratio control under load current changes as well.

### Resonant Control Method

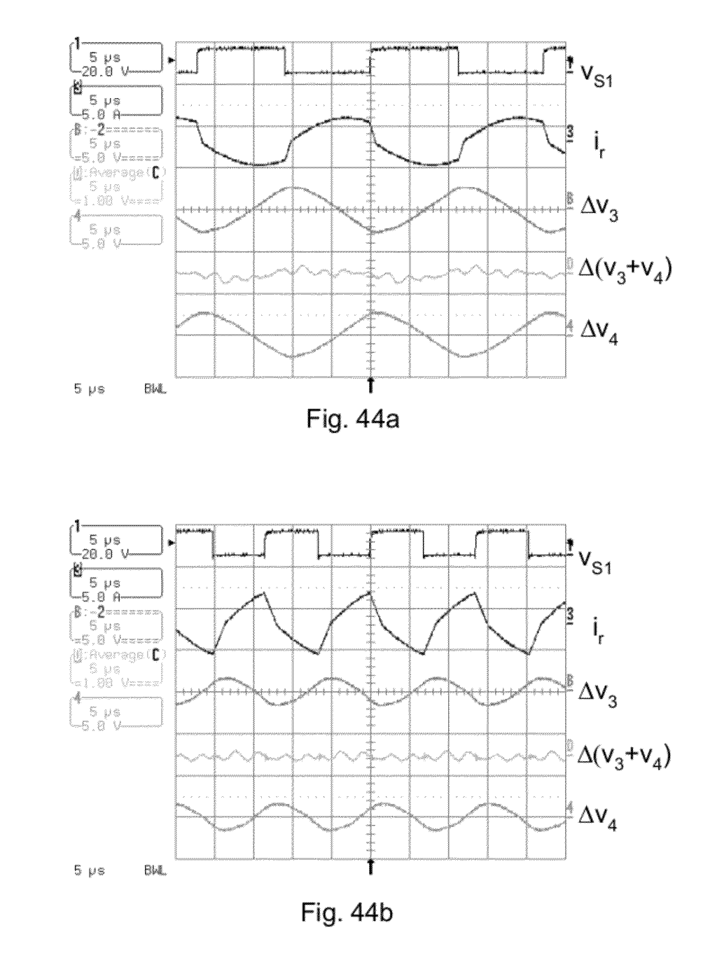

The output voltage of the present invention can also be controlled and reduced by increase of switching frequency above the composite resonant frequency defined by (39) as illustrated by the resonant current waveforms in FIG. 44a and FIG. 44b. Converter is operated first at the 50% duty ratio and lower switching frequency to result in the waveforms shown in FIG. 44a illustrating that it is already away from zero current crossing adjustment and already providing some continuous step-down of output voltage by duty ratio control. Further increase of switching frequency will result in further continuous reduction of the output voltage and in salient waveforms illustrated in FIG. 44b.

### Experimental Verification

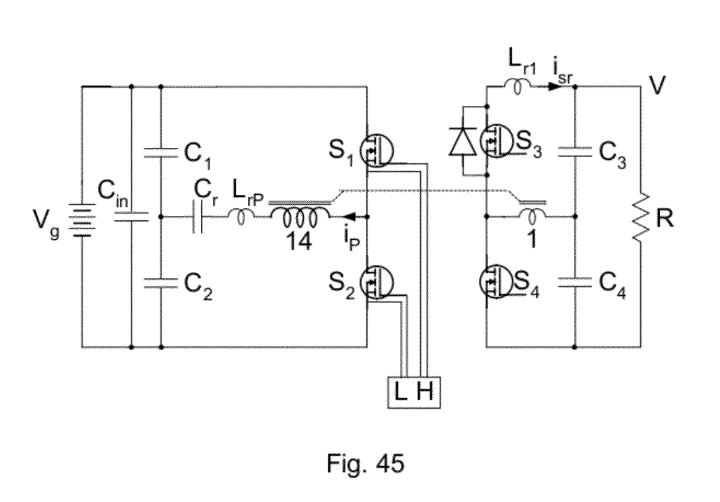

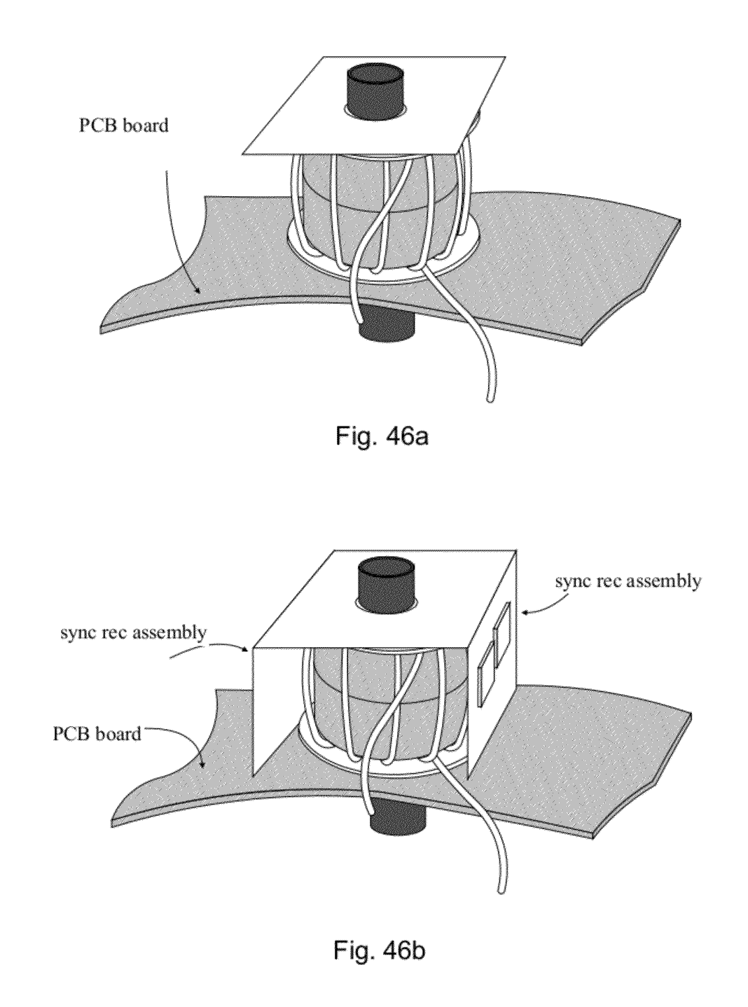

The several features of the present inventions, such as zero voltage switching, efficiency, transient response and output ripple voltage are verified on the experimental prototype built based on the converter configuration shown in FIG. 45. The isolation transformer is built using two stacked toroidal ferrite magnetic cores, illustrated in FIG. 46a and FIG. 46b, each having 33 mm² cross section. Primary winding was 14 turns of Litz wire and secondary winding was one turn made as a copper tube cylinder and inserted into center of the toroid as one turn secondary, which provided a good magnetic coupling and illustrated a no need for air-gap in the magnetic core.

The experimental prototype is built with the following values:

C₁=C₂=9.4 μF C₃=C₄=470 μF L_{rP}=6 μH Lᵣ₁=100 nH Cᵣ=1 μF

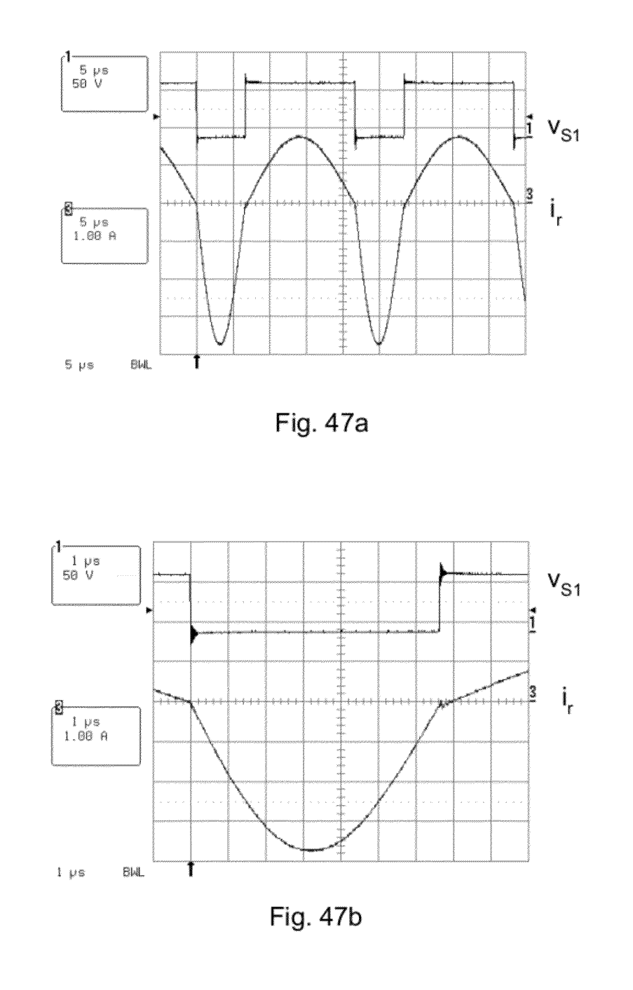

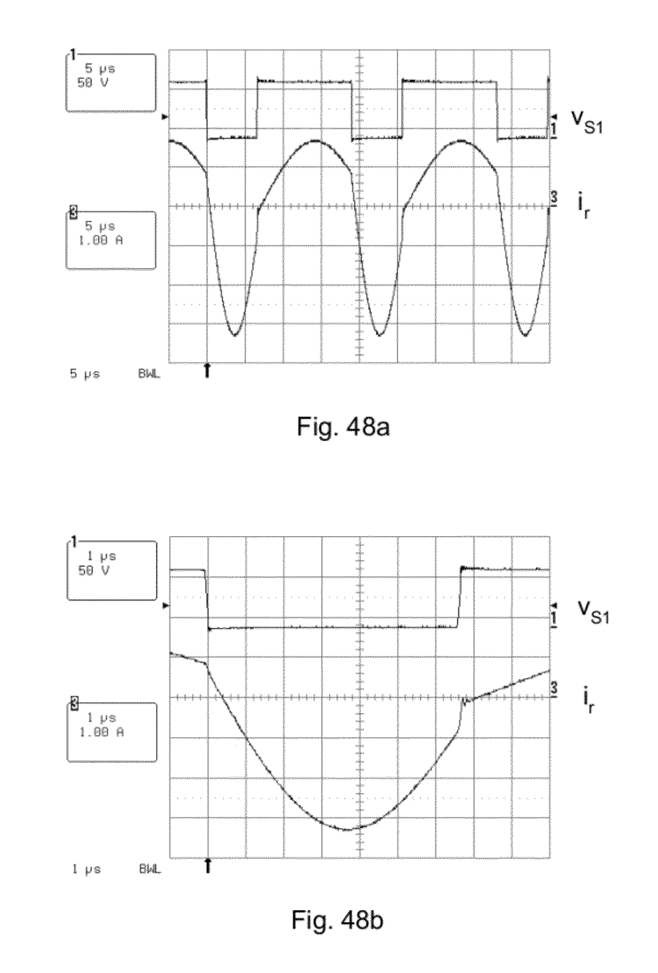

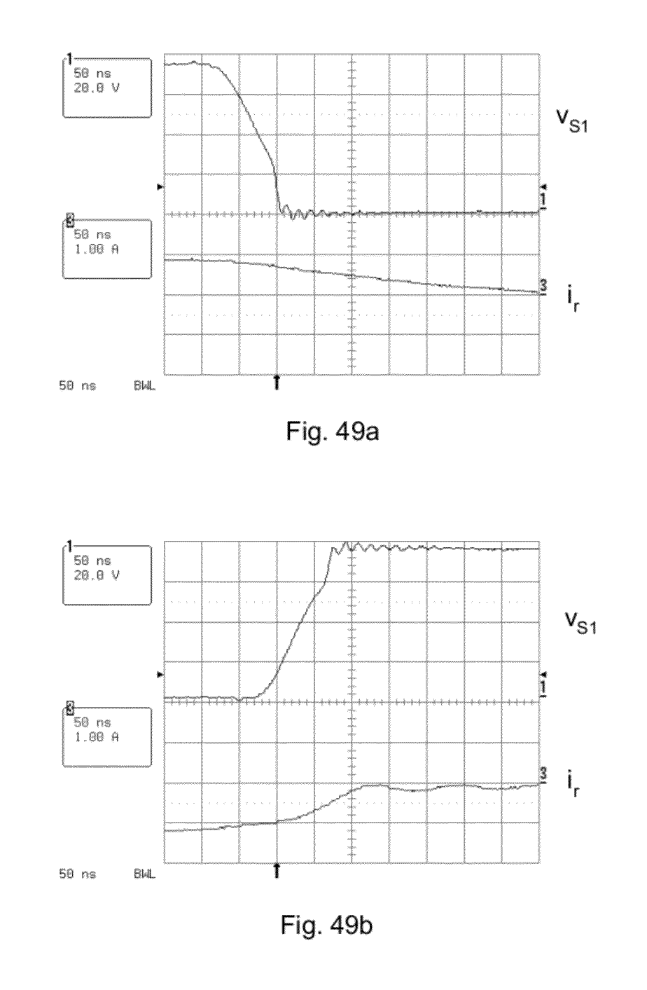

Input voltage is 72V and output 5V. At the switching frequency of 47 kHz the resonant current with zero current crossovers is obtained. As described before, the switching frequency is then raised slightly to 52 kHz to provide some positive and negative current for zero voltage switching as illustrated in FIG. 47a, FIG. 47b, FIG. 48a, FIG. 48b, and FIG. 49a and FIG. 49b.

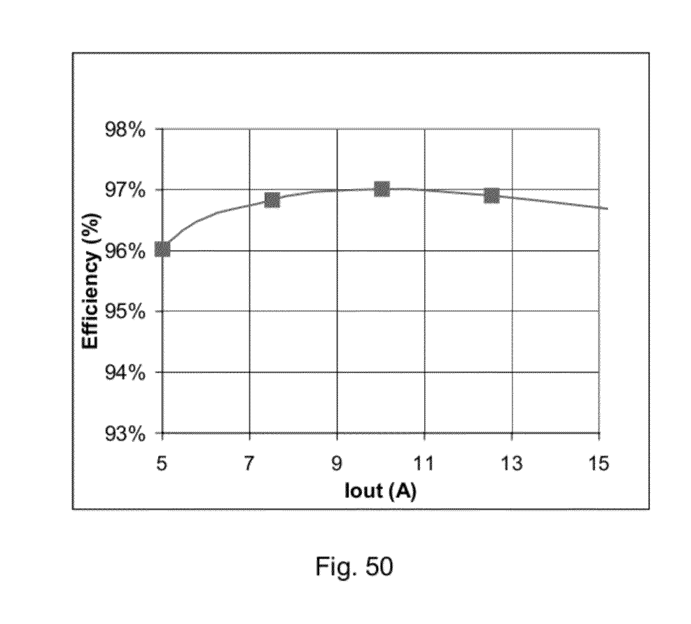

The nominal design was for 5V, 15 A output voltage. The measurement of efficiency is illustrated in FIG. 50.

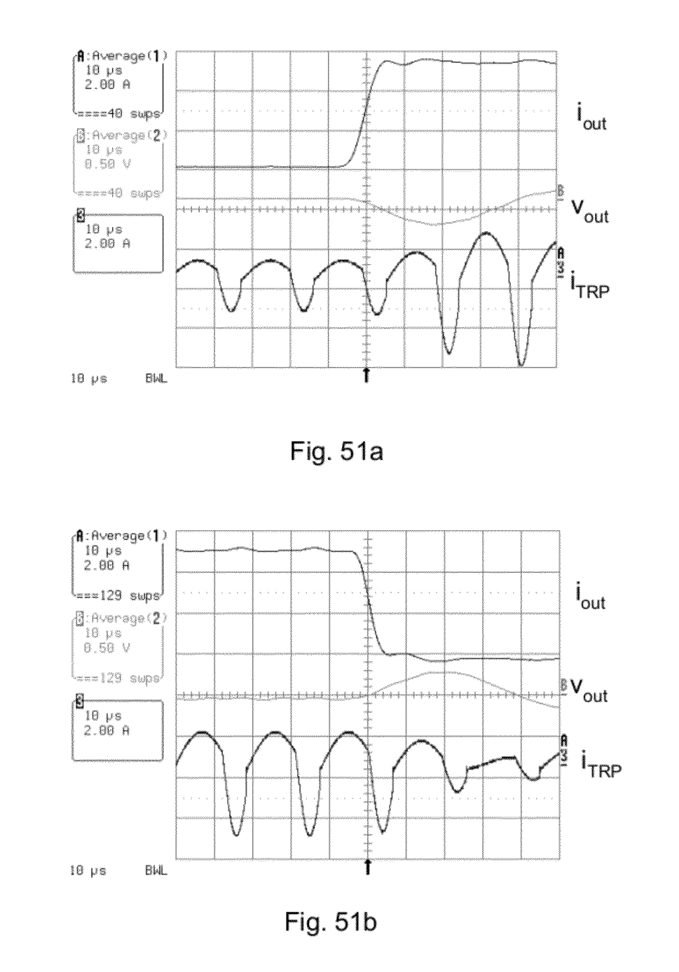

The step-load current measurements of FIG. 51a and FIG. 51b confirm the fast output DC voltage transient and no storage of DC energy in the converter.

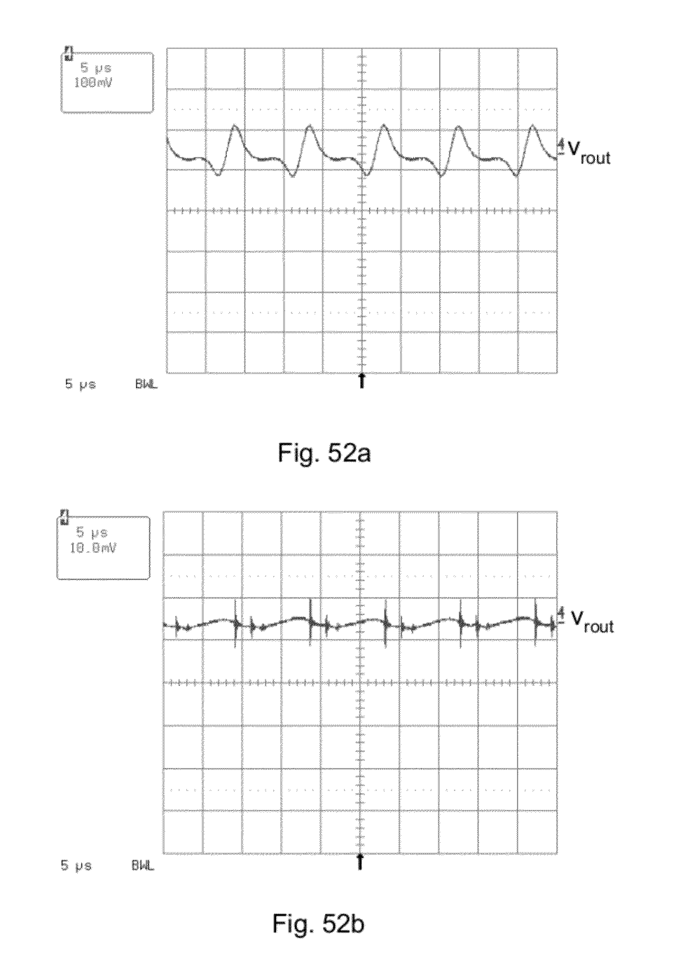

The output ripple voltage measurement in FIG. 52a (without output filter) and FIG. 52b (with output filter) confirm the low ripple voltage characteristic of the converter.

### Utilization of Secondary Side Switches

The above experimental example points out also how the present low voltage switches are inadequate for this standard application for 5V output. Since present converter topologies imposed voltage stress 3 to 4 times the output voltage, for typical applications like this 5V output, the secondary side switches will require devices with 30V rating. Therefore, presently known best low ON-resistance MOSFETs are not offered in voltage ratings below 25V.

Yet present invention could instead of 30V rated switches, use 7.5V rated switches (with all associated advantages in reduction of losses) and/or reduction of the cost of devices or both.

### Applications to Low Voltage Conversion of 12V to 1V

The present invention could also find the application for low output voltages such as for 12V to 1V, 50A converters needed for modern microprocessors power supplies. The absence of the losses due to the transformer's leakage inductance (see last section) and low voltage ratings of the secondary side switches carrying all high current, would result in a very small, high efficiency converter with 5 to 10 times reduction in the cost of silicon used for the switches when compared to the conventional solution based on the synchronous rectifier buck converter.

### Alternative Zero-voltage Switching Method

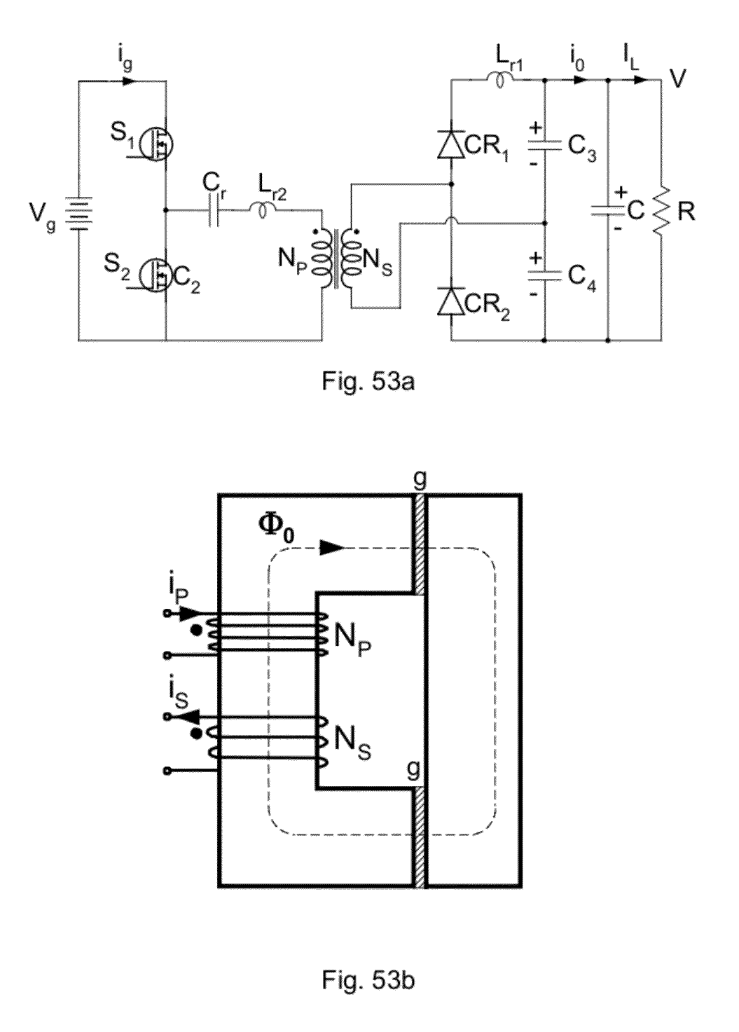

An alternative method described here provides zero-voltage switching of the primary high voltage switching devices effectively over the full load current range from full load to no load. This method is illustrated on yet another embodiment of the present invention, which has a single ended connection of the primary side switches and half-bridge connection of the secondary side current rectifiers and the placement of the two resonant inductors as illustrated in FIG. 53a. Note also that the transformer is now made with a small air-gap as illustrated in FIG. 53b.

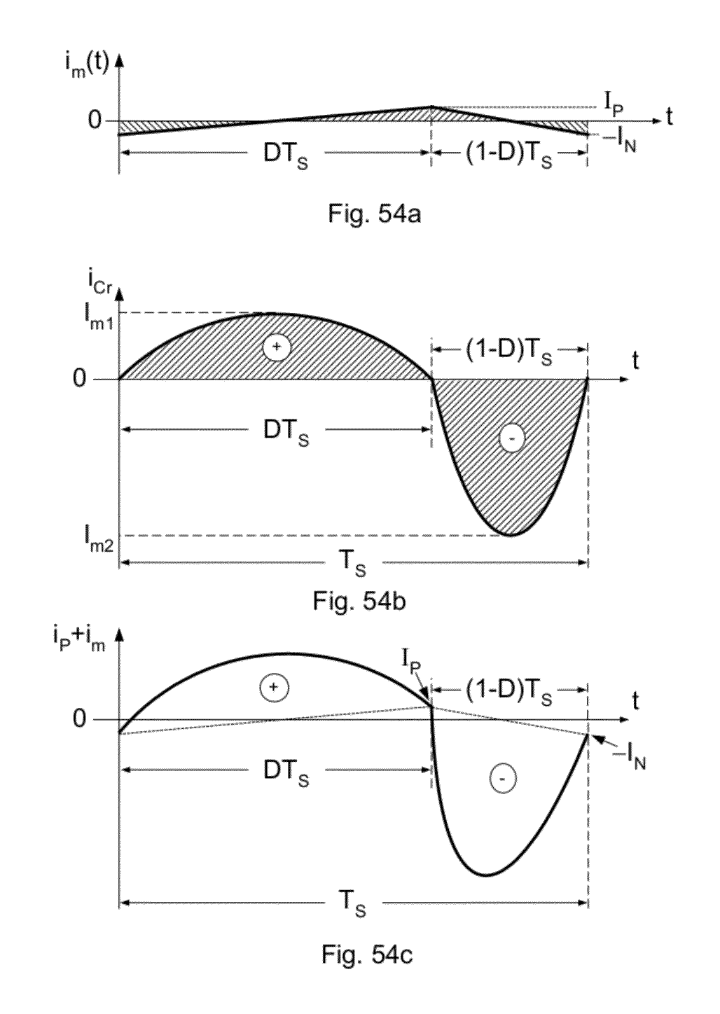

Shown in FIG. 54a is magnetizing current of the isolation transformer increased by insertion of a small air-gap on the order of 1/1000 of an inch. Note that this magnetizing current is centered around zero DC current level as the transformer has bi-directional flux capability introduced earlier. Therefore, increase of magnitude of the magnetizing current raises both positive I_{P} and negative −I_{N} peak value equally.

When this increased magnetizing current is superimposed on the ideal resonant current shown in FIG. 54b, the actual resonant capacitor current (and transformer primary current) is as shown in FIG. 54c. If the two primary side switches are now provided with appropriate dead times at both transition instances, the positive current I_{P} will assure zero voltage switching at first transition and negative current −I_{N} will insure zero voltage switching at second transition just as it was illustrated before in FIG. 48a, FIG. 48b, FIG. 49a and FIG. 49b. Note that this still small magnetizing current will provide low conduction losses at no low and insure excellent no load efficiency, since all resonant currents will be reduced to zero only leaving this small circulating magnetizing current.

Note that two methods described for zero voltage switching of primary side high voltage switches described before with respect to FIG. 48b and FIG. 54c can also be implemented together so that at full load, the higher currents are available, while at light load and especially no load, the remaining transformer magnetizing current is sufficient to perform zero voltage switching.

### Single-sided Embodiment

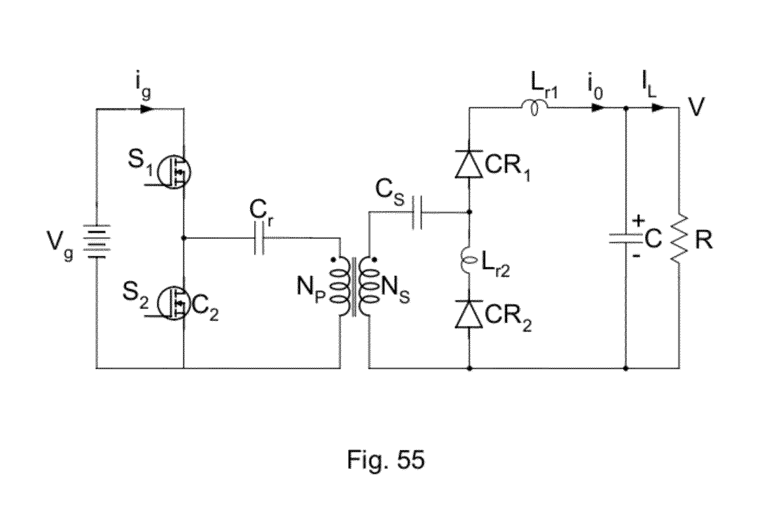

Yet another embodiment of the present invention is shown in FIG. 55 with the secondary side also having a single sided connection. Note also the placement of the two resonant inductors in the branches with the respective current rectifiers. Note, however, that this embodiment will have both the source and load current drawn only during the ON-time interval and would therefore require bigger input and output capacitors to obtain the desirable low output voltage ripples.

Unlike the rectification on the secondary side of the forward converter discussed before, here the two resonant inductors insure a well-behaved transition from ON-time interval to OFF-time interval and vice versa, without the accompanying voltage and current spikes and EMI noise. As before, both current rectifiers conduct the current during this transitional interval

Application to AC-DC converters

### First Case

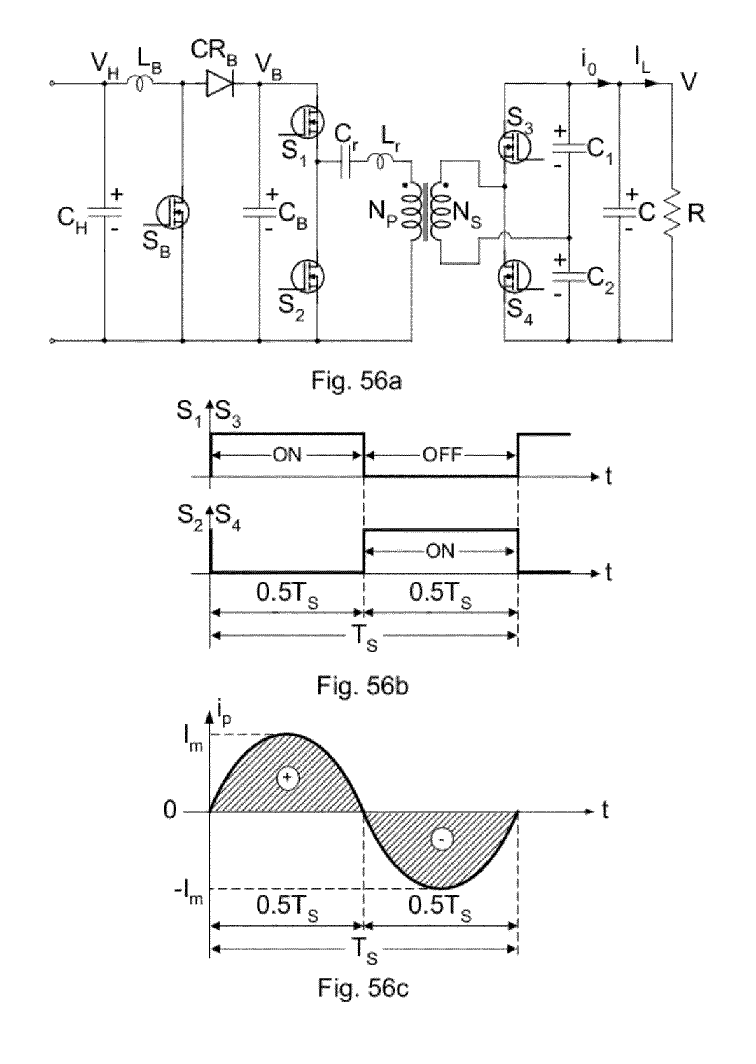

To meet the low harmonic distortion requirements imposed by regulations for any consumer applications exceeding 75W modern AC-DC converters require a front-end active Power Factor Correction in order to force the line current to be in phase and proportional with the line voltage and thus operate at Unity Power Factor. Hence, the front-end of the AC-DC converter is typically composed of a full-wave bridge rectifier followed by a boost converter operated as PFC converter to result in the voltage on its hold-up output capacitor C_{H}=400V shown as a voltage source for the composite converter shown in FIG. 56a. The hold-up capacitor is sized so that it can store enough energy to provide a power to the Isolated DC-DC converter during the time when one cycle of the AC line voltage is missing. Typical requirements call for a 20 miliseconds hold-up time. During that time, the voltage on the hold-up capacitor will be reduced to 250V DC, for example, before the next cycle of the AC power starts supporting the load.

In addition, in order to preserve the high quality of the input sinusoidal current and power factor near one, the PFC boost converter must have a low bandwidth of much less than 120 Hz, on the order of 10 Hz or lower. Thus, the voltage V_{H} on the hold-up capacitor is regulated at 400V with a slow feedback loop resulting in the PFC boost converter unable to respond to fast load current requirements. Therefore, this objective is delegated to a separate isolated DC-DC converter, which clearly must have a voltage regulation and wide bandwidth capability. The converter of the present invention is therefore well suited for this application as it meets both of these criteria.

### Second Case

The present invention provides another alternative in conjunction with a DC-DC sub-boost converter added in front such as illustrated in FIG. 56a.

### Operation During the Hold-up Time Period

Note that the sub-boost converter during normal operation (99.999% of the time) when the AC line is present, will actually not be switching and only its diode will directly pass the power to output sub-boost capacitor. Hence, this will contribute only small conduction losses of this diode and sub-boost inductor winding L_{B} (no core losses in the inductor!) and efficiency loss of 0.2% or less.

During the rare instances of loss of one cycle of the AC line voltage, this boost converter will operate but only during 20 msec time to step-up the declining voltage of the hold up capacitor V_{H} and keep the output voltage of the sub-boost converter at V_{B}=400V. This means, that even during this interval the downstream isolated DC-DC converter needs to provide only a fixed 400V to 12V voltage conversion and not a regulation so that the isolated converter could be optimized for highest efficiency and smallest size.

The present invention is well suited to that task, since when operated at 50% duty ratio as illustrated in FIG. 56b the converter will have only conduction losses as all other losses are eliminated as explained earlier. In addition, all four switches are implemented as MOSFET switches and are operated at 50% duty ratio. The converter may be also implemented with isolation transformer only in which case the leakage inductance of the isolation transformer will play the role of the resonant inductor as explained earlier.

Note that the efficiency and thermal management of the sub-boost converter during the hold-up time period is irrelevant due to such short time of operation of 20msec so that a small size MOSFET switch S_{B} and inductor L_{B} could be used. However, this leaves still open question how will this alternative method handle the fast load current transients.

### Operation for Fast Load Current Transients

First we observe that the fast load current transients have the two opposing requirements:
1. During the fast increase of the load current, the hold-up capacitor C_{H} voltage V_{H} will dip in voltage perhaps as much as 40V to 50V as PFC converter is not capable to quickly deliver that current due to a low bandwidth. This is where the sub-boost DC-DC converter with its wide bandwidth is stepping in and keeping its output voltage regulated at V_{B}=400V. Hence once again, the second-stage DC-DC converter can still operate as fixed 400V to 12V converter.
2. During the fast decrease of the load current (unloading) the hold-up capacitor voltage V_{H} would tend to increase some 40V to 50V. Under that condition, the diode of the sub-boost converter should pass the voltage of the hold-up capacitor to the sub-boost capacitor C_{B}. This is now where the step-down voltage gain of the present invention comes into operation to change the duty ratio quickly and keep the output voltage regulated under the step-down current transient. Note that this unloading transient could be also handled effectively with either of the two control methods discussed earlier: duty ratio control or resonant method control.

The net result is that the converter is again operating during nominal conditions with the ideal fixed voltage step-down of 400V to 12V and its step-down regulation is used for one transient (unloading) while sub-boost converter is used for the other transient (loading). Of course the control circuit should be implemented so that both of the controls are not engaged at the same time. Thus, it is combination of the step-up of the sub-boost converter and step-down gain of the present invention, which makes this operation possible so that sub-boost converter never operates under normal condition and in absence of the large load current transients.

The alternative case described above is very general and instead of the Isolated DC-DC converter of the present invention other isolated converters with the step-down voltage gain could also be used as the second stage, such as PWM converters with duty ratio control or even prior-art converters using the conventional resonant method regulation of the output voltage by varying the switching frequency.

### Additional Embodiments

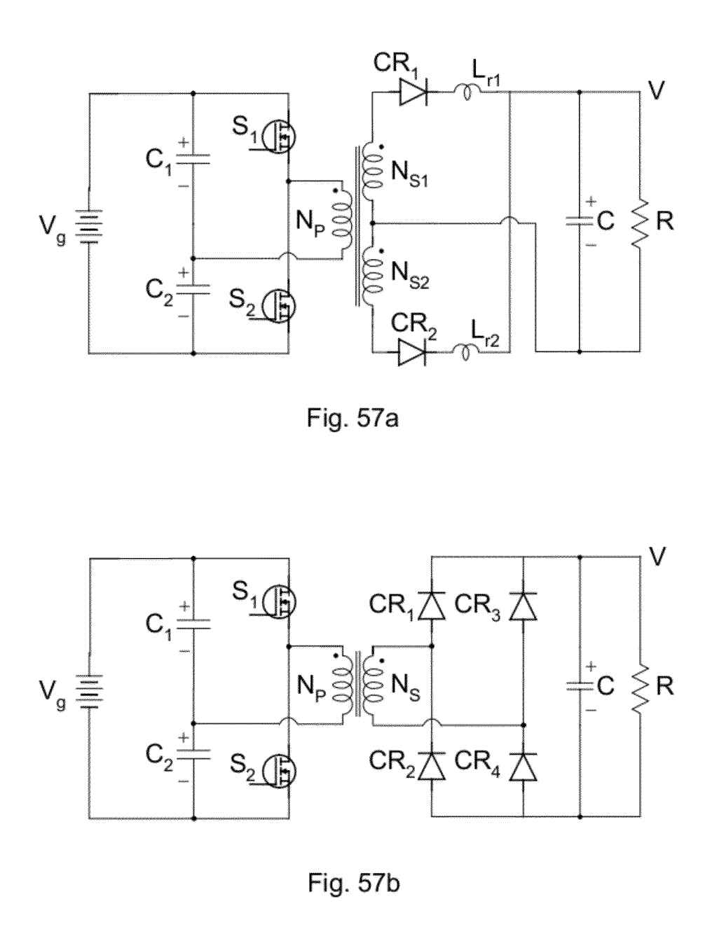

Another embodiment of the present invention is shown in FIG. 57a in which the secondary side is a commonly used center-tap configuration. This configuration will also have the same benefit of the voltage control using the same described mechanism with duty ratio control. However, it does have two disadvantages when compared to the preferred configuration of FIG. 15a and its variants.

First, the isolation transformer will have zero DC-bias only when the converter is operated at 50% duty ratio but will have increasing DC-bias for other duty ratios.

Second, the AC flux (volt-seconds per turn of the transformer) will be doubled thus resulting in larger transformer size.

Third, the current rectifiers on the output are exposed to the twice the output voltage stress: for 12V output they will have a 24V voltage stress when compared to 12V voltage stress of the preferred implementation of FIG. 15a.

Yet another embodiment is shown in FIG. 57b with the full-bridge rectification on the secondary side. The same duty ratio control applies again. Once again, transformer will have no DC-bias only at 50% duty ratio. While the voltage stresses of output current rectifiers will be equal to the DC output voltage, there will always be two rectifiers in series resulting in additional conduction losses and cost which precludes it from most applications especially the low output voltage applications.

### Three-phase Embodiment

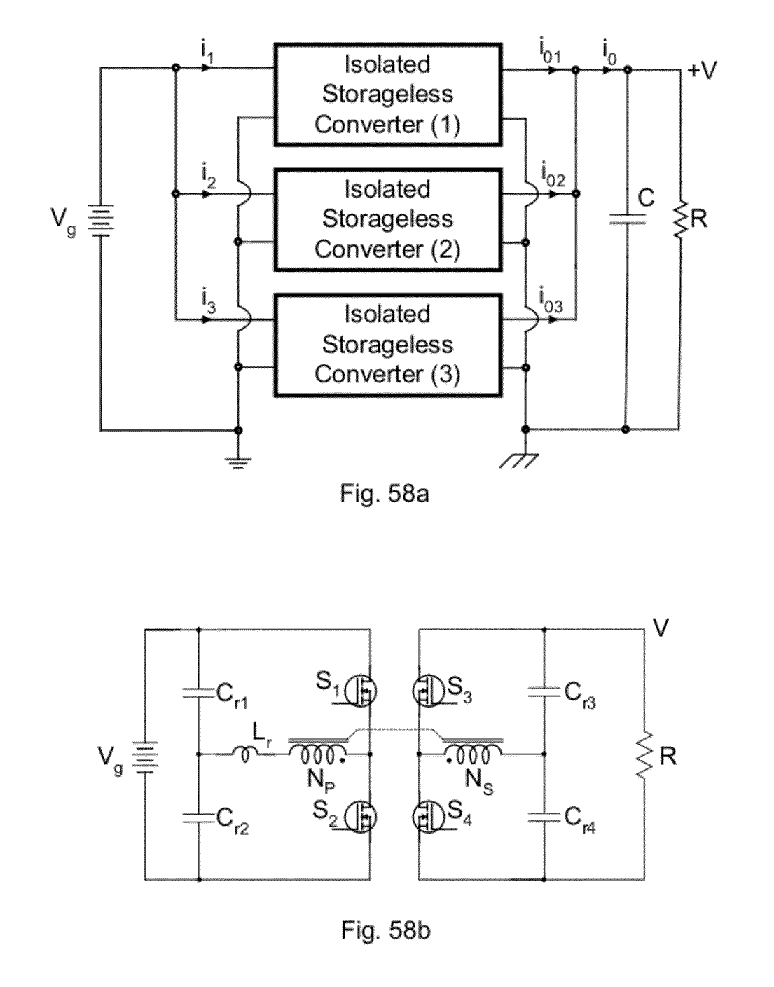

The present invention also has a unique converter topology and operation, which makes it possible to have a three-phase extension, which consists of the three identical modules connected in parallel as illustrated in FIG. 58a with each converter module shown in FIG. 58b. Each module is operated at nominal 50% duty ratio and with an all MOSFET implementation. There is a single resonant inductor in series with the primary winding of the transformer. As described earlier this resonant inductor could be eliminated and the role of the resonant inductor replaced by the leakage inductance of the isolation transformer, which leads to the simplest implementation with only one magnetic component, the isolation transformer. Two equal resonance's (one for ON-time interval and another for OFF-time interval) are provided by the two input resonance capacitors in the half-bridge configuration and by the two resonant capacitors on the output connected in the half-bridge configuration. The alternative method described in previous section is used to operate the switching devices on the primary sides with zero voltage switching which is equally effective from full load to no load. Therefore, the converter operates with effectively all switching losses eliminated resulting in conduction losses and high efficiency.

The overall Three-phase DC-DC converter of FIG. 58a then retains the same efficiency as individual modules since the input power is processed in parallel and divided equally among the three modules, thus each module carrying the third of the input power.

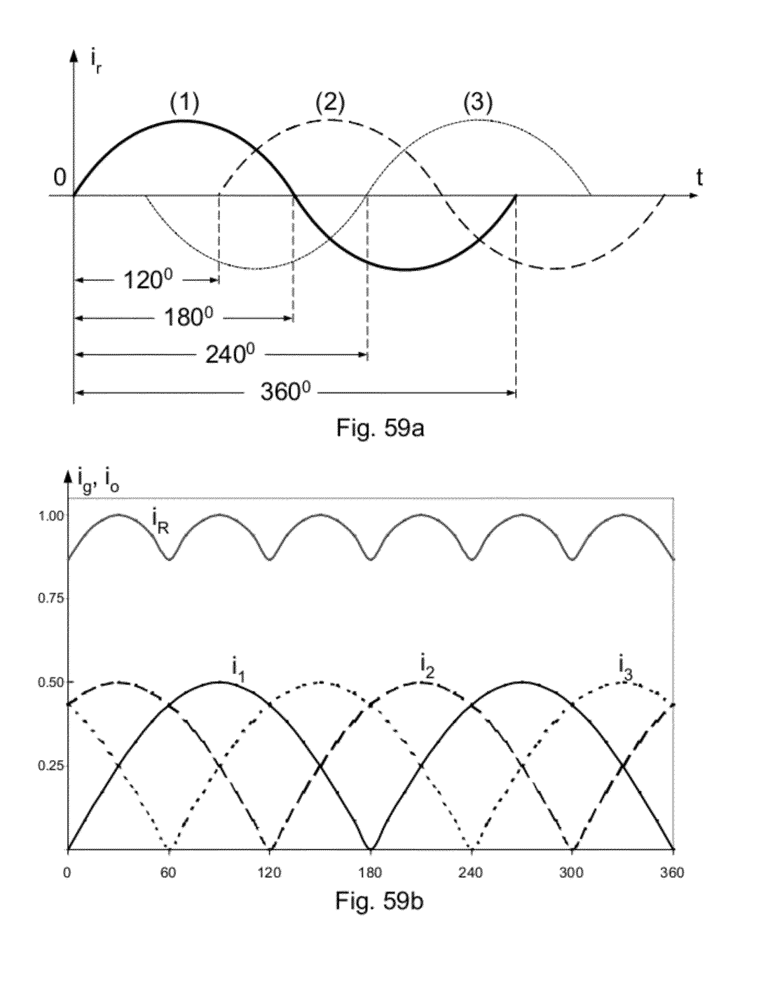

Each module in Three-phase DC-DC converter is operated with identical composite resonant frequency but also under special operating conditions. Instead of operating each module so that their composite resonant frequencies are synchronized and in phase with each other, they are operated as follows:
a) Composite resonant frequency of second module is phase-shifted in time by 120 degrees from the composite resonant frequency of the first module as illustrated by the waveforms marked (1) and (2) in FIG. 59a.
b) Composite resonant frequency of the third module is phase-shifted in time from the second module by 120 degrees as illustrated by the waveform marked (2) and (3) in FIG. 59a.

The net result is that both the input and output current of each module consist of the rectified one-half of the composite resonant current of the respective modules as depicted in the waveforms marked on FIG. 59b. The addition of all these rectified currents for each module result in a small total ripple current (half of peak-to-peak ripple current) of 5% of the DC load current as seen in the top trace on FIG. 59b. Note also that this ripple current is at frequency, which is 6 times the switching frequency. Hence, for 100 kHz switching frequency the ripple current is at an effective 600 kHz switching rate so that a rather small output and input capacitors would be needed to reduce input and output ripple voltages to a very small value. This Three-phase DC-DC converter extensions makes possible effective scaling the power by a factor of three times, maintains the high efficiency of each module and at the same time reduces significantly the size as the large filtering capacitors required for each module operated separately are eliminated resulting in significantly reduced cost and size.

### Bi-directional Power Converter for DC Transmission System

The solar electric power conversion is now being used to generate the renewable electric power from the solar cells. The solar cells generate the DC voltage so it would be natural to provide that power directly to a DC utility grid based on DC Power distribution system. Another motivation for DC distribution grid is that the high voltage DC lines produce lower losses per distance than Three-phase AC distribution and can be distributed with the underground cables more efficiently and not on high voltage transmission lines above the ground.

Three-phase AC grid, however, had a traditional advantage that via three-phase 60 Hz high efficiency AC transformers (98% or higher) to convert low voltage, high current input power into a high voltage, low current output power for efficient distribution to long distances and then re-converted back to low voltage, high current by transformers at the point of use.

As AC transformers do not work at DC, the DC-DC transmission grid needed an efficient replacement for the AC transformer, which did not exist as efficiency of present high voltage converters are below 95%. Additional problem is that the DC converters until now used large inductors, which stored DC energy. Thus, when the power is interrupted on such a DC grid, the stored DC energy in these inductors needs to be dumped quickly to prevent damage to DC-DC converters and/or transmission system.

The present invention is well suited to perform both large DC voltage step-up on generator side or large DC voltage step-down on the user side, without any DC stored energy and complications arising from that storage. The high efficiency of the conversion and ability to regulate the voltage on the transmission grid are also added benefits. The Three-phase DC-DC converter would minimize the requirement for capacitive filtering on either input or output side. Finally, the isolation transformers used have no DC stored energy so there would be no dangerous transformer saturation or inductor saturation due to high DC transient load currents as is the case in conventional DC-DC converter solutions.

### Outstanding Features

Several outstanding features of the present invention are now highlighted.

### No Energy Storage in Magnetics

The single magnetic piece, the isolation transformer, does not store any DC energy at any operating point in the regulation region, so the converter can be scaled up to high power with the smallest increase in size of the transformer and converter could be designated as isolated storageless converter. This performance is not available in any presently known switching converters.

### Zero-voltage Switching of Primary Side Switches

High voltage switches have associated with them a relatively high parasitic capacitance between the drain and source C_{Ds} which, when switches are operated in hard switching mode result in large switching losses proportional to switching frequency as per formula:

P_{SW}=½V_{DS}²f_{S} (44)

where V_{DS} is the drain to source voltage. For high voltage of 650V and high switching frequency of 200 kHz or more, these losses can amount to 3% to 5% of the total power. For two switches on primary side the actual looses in hard-switching mode would be double of that given by (44).

The present invention, however, has a very effective Zero-voltage switching alternative method, which eliminates practically all of these switching losses not only at full load but even more importantly at no load. It achieves so with only a small increase in the transformer magnetizing inductance, which only adds a relatively small conduction loss to the transformer.

### Elimination of the Transformer Leakage Inductance Losses

All present isolated switching converters have one fundamental problem, which is associated with the transformer leakage inductance L₁ referred to the transformer primary side. This problem is specially visible in the converter with a high step-down conversion ratio, such as 33:1 in which even a inductance of the traces on the secondary side of 10 nH becomes a rather large inductance of 10 mH on the primary side due to reflection through the transformer turns ratio. This, does not even account for the additional native leakage inductance of the transformer itself resulting from the inability to obtain tight coupling of the winding for large turns ratio step-down.

The losses due to the energy stored in this transformer leakage inductance are also proportional to switching frequency and are given by:

P_{L}=½L₁I_{P}² (45)

where I_{P} is a peak primary current of the transformer at turn-OFF. Once again this stored energy in the transformer leakage inductance is normally dissipated as a loss and in present converters dealt with either dissipative or partially dissipative snubbers to prevent undesirable effect in form of high voltage spikes on the switches.

In the present invention, the transformer leakage inductance is not the problem, but actually a solution as it plays the role of the resonant inductor itself. Note that during the ON-time interval, the current in this leakage inductance first increases from zero in sinusoidal fashion, reaches maximum and then by the end of ON-time interval decreases again to zero at which instant the leakage inductance has no stored energy and primary current can be turned in the other direction with no losses incurred. The same occurs during the OFF-time interval. Therefore, the losses due to transformer leakage inductance (45) are for all practical purposes eliminated. Thus converter could be designed to operate at high switching frequencies to reduce the size of magnetics, without incurring detrimental leakage loses. Furthermore, the voltages on the switches will be free from spikes originating from reversal in the transformer primary current.

### Elimination of Secondary Side Switching Losses

Secondary side current rectifiers at the nominal duty ratio Dₙ also operate under ideal condition of turning ON and turning OFF at zero current which also eliminates their switching losses. In particular, the usually high turn-OFF looses of current rectifiers due to their reverse recovery time are eliminated as they are turned OFF at zero current. The converter of present invention at nominal operating point Dₙ has only conduction losses and therefore high efficiency.

### Low Voltage Stress of All Switches

The two primary side switches have the minimum voltage stress, which is equal to input voltage while the output current rectifiers have the voltage stress equal to the output voltage. Note that this unique feature is available for the entire duty ratio operating range from zero to one.

### CONCLUSION

The isolated step-down switching converter of present invention has key advantages over the prior-art isolated converters in several key areas and provides:
1. High efficiency.
2. Small size of the isolation transformer and ultra small size of resonant inductors.
3. Inherently fast transient response due to load current response on a single switching cycle basis.
4. Smaller overall converter size and large power capability as transformer and converter size scale up well with increased power.
5. New method of zero voltage switching for high voltage primary side switches, which are equally effective for all load conditions from no load to full load.
6. Elimination of all switching losses under special operating condition.
7. Control of the DC voltage conversion ratio by use of unique duty ratio control method heretofore not present in any of the existing prior-art resonant-type isolated DC-DC switching converter.
8. Alternative resonant control method to control the output DC voltage by increase of the switching frequency.

### REFERENCES

1. Slobodan Cuk, “Modeling, Analysis and Design of Switching Converters”, PhD thesis, November 1976, California Institute of Technology, Pasadena, Calif., USA.
2. Slobodan Cuk, R. D. Middlebrook, “Advances in Switched-Mode Power Conversion”, Vol. 1, II, and III, TESLAco 1981 and 1983.
3. Vatche Vorperian, “Resonant Converters”, PhD thesis, May 1, 1984, California Institute of Technology, Pasadena, Calif.;
4. Stephen Freeland, “I. A Unified Analysis of Converters with Resonant Switches II. Input-Current Shaping for Single Phase ACC-DC Power Converters”, PhD thesis, Oct. 20, 1987, California Institute of Technology, Pasadena, Calif., USA
5. Dragan Maksimovic, “Synthesis of PWM and Quasi-Resonant DC-to-DC Power Converters”, PhD thesis, Jan. 12, 1989, California Institute of Technology, Pasadena, Calif., USA.

What is claimed is:

1. An isolated switching DC-to-DC converter for providing power from a DC voltage source connected between an input terminal and a common input terminal to a DC load connected between an output terminal and a common output terminal, said converter comprising:
a first switch with one end connected to said input terminal;
a second switch with one end connected to another end of said first switch and another end connected to said common input terminal;
a first input capacitor with one end connected to said input terminal;
a second input capacitor with one end connected to another end of said first input capacitor and another end connected to said common input terminal;
a resonant capacitor with one end connected to said another end of said first input capacitor;
a primary winding of an isolation transformer with a dot-marked end connected to said one end of said second switch and another end connected to another end of said resonant capacitor;
a first resonant inductor with one end connected to said output terminal;
a second resonant inductor with one end connected to said common output terminal;
a first output capacitor with one end connected to said output terminal;
a second output capacitor with one end connected to another end of said first output capacitor and another end connected to said common output terminal;
a first current rectifier switch with a cathode end connected to another end of said first resonant inductor;
a second current rectifier switch with a cathode end connected to an anode end of said first current rectifier switch and an anode end connected to another end of said second resonant inductor;
a secondary winding of said isolation transformer with dot-marked end connected to said cathode end of said second current rectifier switch and another end connected to said one end of said second output capacitor;
switching means for keeping said first switch ON and said second switch OFF during T_{ON} time interval DT_{S}, and keeping said first switch OFF and said second switch ON during T_{OFF} time interval (1−D)T_{S}, where T_{ON} and T_{OFF} are complementary time intervals within one switch operating cycle T_{S} and where D is a controllable duty ratio;
wherein said resonant capacitor has capacitance value significantly smaller than capacitance of said first input capacitor, said second input capacitor, said first output capacitor, and said second output capacitor;
wherein said first resonant inductor and said resonant capacitor form a first resonant circuit during said T_{ON} time interval and define a first resonant frequency and corresponding first resonant period;
wherein said second resonant inductor and said resonant capacitor form a second resonant circuit during said T_{OFF} time interval and define a second resonant frequency and corresponding second resonant period;
wherein sum of one half of said first resonant period plus one half of said second resonant period form a composite resonant period which is equal to said operating cycle T_{S};
wherein a nominal duty ratio Dₙ is set to make a nominal ON-time interval DₙT_{S} equal to said one half of said first resonant period;
wherein during said nominal ON-time interval DₙT_{S} only one-half of a positive half-sinusoidal resonant current of said first resonant circuit flows from said DC source into said DC load;
wherein during a nominal OFF-time interval (1−Dₙ)T_{S} only one-half of a positive half-sinusoidal resonant current of said second resonant circuit flows from said DC source into said DC load;
wherein said controllable duty ratio D could be changed from said nominal duty ratio Dₙ down to zero, or up to one;
wherein a turns ratio of said isolation transformer is a number of turns of said primary winding divided by number of turns of said secondary winding;
whereby said converter operating at said nominal duty ratio Dₙ has a DC voltage conversion ratio equal to said turns ratio of said isolation transformer;
whereby said DC voltage conversion ratio is continuously controlled by changing said controllable duty ratio D;
whereby voltage stresses on said first switch and said second switch are equal to voltage of said DC voltage source;
whereby voltage stresses on said first current rectifier switch and said second current rectifier switch are equal to voltage of said DC load;
whereby at said nominal duty ratio Dₙ all switches are turned ON and turned OFF at zero current level with no switching losses;
whereby said isolation transformer does not store energy at any operating duty ratio D and does not have an air-gap;
whereby flux density of said isolation transformer is significantly smaller compared to isolation transformers flux density of other converters.

2. An isolated switching converter as defined in claim 1,
wherein said first switch and said second switch are semiconductor MOSFET transistors.

3. An isolated switching converter as defined in claim 1,
wherein said switching means increase or decrease said operating cycle T_{S} to change a switching frequency of said converter;
wherein said composite resonant period is constant and related composite resonant frequency is constant;
whereby said DC voltage conversion ratio is changed with change of said switching frequency.

4. An isolated switching converter as defined in claim 1,
wherein said second resonant inductor is disconnected from said common output terminal and said anode end of said second current rectifier switch;
wherein said anode end of said second current rectifier switch is connected to said common output terminal;
wherein said second resonant inductor is inserted between said another end of said resonant capacitor and said another end of said primary winding of said isolation transformer;
wherein said first resonant inductor, said second resonant inductor, and said resonant capacitor form a first resonant circuit during said T_{ON} time interval and define a first resonant frequency and corresponding first resonant period;
wherein said second resonant inductor and said resonant capacitor form a second resonant circuit during said T_{OFF} time interval and define a second resonant frequency and corresponding second resonant period;

5. An isolated switching converter as defined in claim 1,
wherein said resonant capacitor is shorted;
wherein said first input capacitor, said second input capacitor, said first output capacitor, and said second output capacitor form an equivalent resonant capacitor during said T_{ON} time interval and during said T_{OFF} time interval;
wherein said first resonant inductor and said equivalent resonant capacitor form a first resonant circuit during said T_{ON} time interval and define a first resonant frequency and corresponding first resonant period;
wherein said second resonant inductor and said equivalent resonant capacitor form a second resonant circuit during said T_{OFF} time interval and define a second resonant frequency and corresponding second resonant period;
wherein during said nominal ON-time interval DₙT_{S} only one-half of a positive half-sinusoidal resonant current of said first resonant circuit flows from said DC source into said DC load;
wherein during said nominal OFF-time interval (1−Dₙ)T_{S} only one-half of a positive half-sinusoidal resonant current of said second resonant circuit flows from said DC source into said DC load;

6. An isolated switching converter as defined in claim 1,
wherein said second resonant inductor is removed and said anode end of said second current rectifier switch connected to said common output terminal;
wherein said second resonant inductor is inserted in series with said secondary winding of said isolation transformer;
wherein said first resonant inductor, said second resonant inductor, and said resonant capacitor form a first resonant circuit during said T_{ON} time interval and define a first resonant frequency and corresponding first resonant period, and
wherein said second resonant inductor and said resonant capacitor form a second resonant circuit during said T_{OFF} time interval and define a second resonant frequency and corresponding second resonant period.

7. An isolated switching converter as defined in claim 2,
wherein the switching frequency is raised slightly above the composite resonant frequency so as to generate positive resonant capacitor discharge current at first transition from ON-time interval to OFF-time interval, and negative resonant capacitor discharge at the second transition from OFF-time interval to ON-time interval, sufficient to reduce the drain-to-source voltage of the respective MOSFET transistor to zero before that transistor is turned-ON;
whereby the switching losses of the primary side MOSFET transistors due to energy stored on their drain-to-source capacitance is much reduced, and
whereby the loss reduction is dependent on the load current and is most effective at full load current.

8. An isolated switching converter as defined in claim 2,
wherein an air-gap is inserted in the isolation transformer so as to raise the positive and negative peak of its magnetizing current so as to generate positive resonant capacitor discharge current at first transition from ON-time interval to OFF-time interval, and negative resonant capacitor discharge at the second transition from OFF-time interval to ON-time interval, sufficient to reduce the drain-to-source voltage of the respective MOSFET transistor to zero before that respective transistor is turned-ON;
whereby the switching losses of the primary side MOSFET transistors due to energy stored on their drain-to-source capacitance is much reduced, and
whereby the loss reduction is independent on the load current and is equally effective at all load currents.

9. An isolated switching converter as defined in claim 2,
wherein the switching frequency is raised slightly above the composite resonant frequency so as to generate positive resonant capacitor discharge current at first transition from ON-time interval to OFF-time interval, and negative resonant capacitor discharge at the second transition from OFF-time interval to ON-time interval, sufficient to reduce the drain-to-source voltage of the respective MOSFET transistor to zero before that transistor is turned-ON;
wherein an air-gap is inserted in the isolation transformer so as to raise the positive and negative peak of its magnetizing current so as to generate additional positive resonant capacitor discharge current at first transition from ON-time interval to OFF-time interval, and additional negative resonant capacitor discharge at the second transition from OFF-time interval to ON-time interval, sufficient to reduce the drain-to-source voltage of the respective MOSFET transistor to zero before that respective transistor is turned-ON;
whereby the switching losses of the primary side MOSFET transistors due to energy stored on their drain-to-source capacitance is much reduced, and
whereby the loss reduction is very effective at full load but also effective at no load and light loads as well.

10. An isolated switching converter as defined in claim 1,
wherein the input voltage source is the hold-up capacitor of the front-end Power Factor Correction (PFC) converter;
whereby the isolated switching converter provides the regulated output voltage from the energy stored on the hold-up capacitor in the case of a missing single cycle of the line frequency, and
whereby the isolated switching converter provides the regulated output voltage with a wide bandwidth for fast transient response due to load current changes.

11. An isolated switching DC-to-DC converter for providing power from a DC voltage source connected between an input terminal and a common input terminal to a DC load connected between an output terminal and a common output terminal, said converter comprising:
a first switch with one end connected to said input terminal;
a second switch with one end connected to another end of said first switch and another end connected to said common input terminal;
a resonant capacitor with one end connected to said another end of said first switch;
a second resonant inductor with one end connected to another end of said resonant capacitor;
a primary winding of an isolation transformer with a dot-marked end connected to another end of said first resonant inductor and another end connected to said common input terminal;
a first output capacitor with one end connected to said output terminal;
a second output capacitor with one end connected to another end of said first output capacitor and another end connected to said common output terminal;
a first resonant inductor with one end connected to said output terminal;
a first current rectifier switch with a cathode end connected to another end of said first resonant inductor;
a second current rectifier switch with an anode end connected to said common output terminal and a cathode end connected to an anode end of said first current rectifier switch;
a secondary winding of said isolation transformer with dot-marked end connected to said anode end of said first current rectifier switch and another end connected to said one end of said second output capacitor;
switching means for keeping said first switch ON and said second switch OFF during T_{ON} time interval DT_{S}, and keeping said first switch OFF and said second switch ON during T_{OFF} time interval (1−Dₙ)T_{S}, where T_{ON} and T_{OFF} are complementary time intervals within one switch operating cycle T_{S} and where D is a controllable duty ratio;
wherein said resonant capacitor has capacitance value significantly smaller than capacitance of said first output capacitor and said second output capacitor;
wherein said first resonant inductor, said second resonant inductor, and said resonant capacitor form a first resonant circuit during said T_{ON} time interval and define a first resonant frequency and corresponding first resonant period;
wherein said second resonant inductor and said resonant capacitor form a second resonant circuit during said T_{OFF} time interval and define a second resonant frequency and corresponding second resonant period;
wherein sum of one half of said first resonant period plus one half of said second resonant period is equal to said operating cycle T_{S};
wherein a nominal duty ratio Dₙ is set to make a nominal ON-time interval DₙT_{S} equal to said one half of said first resonant period;
wherein during said nominal ON-time interval DₙT_{S} only one-half of a positive half-sinusoidal resonant current of said first resonant circuit flows from said DC source into said DC load;
wherein during a nominal OFF-time interval (1−Dₙ)T_{S} only one-half of a positive half-sinusoidal resonant current of said second resonant circuit flows from said DC source into said DC load;
wherein said controllable duty ratio D could be changed from said nominal duty ratio Dₙ down to zero, or up to one;
wherein a turns ratio of said isolation transformer is a number of turns of said primary winding divided by number of turns of said secondary winding;
whereby said converter operating at said nominal duty ratio Dₙ has a DC voltage conversion ratio equal to said turns ratio of said isolation transformer;
whereby said DC voltage conversion ratio is continuously controlled by changing said controllable duty ratio D;
whereby voltage stresses on said first switch and said second switch are equal to voltage of said DC voltage source;
whereby voltage stresses on said first current rectifier switch and said second current rectifier switch are equal to voltage of said DC load;
whereby at said nominal duty ratio Dₙ all switches are turned ON and turned OFF at zero current level with no switching losses;
whereby said isolation transformer does not store energy at any operating duty ratio D and does not have an air-gap;
whereby flux density of said isolation transformer is significantly smaller compared to isolation transformers flux density of other converters.

12. An isolated switching DC-to-DC converter for providing power from a DC voltage source connected between an input terminal and a common input terminal to a DC load connected between an output terminal and a common output terminal, said converter comprising:
a first switch with one end connected to said input terminal;
a second switch with one end connected to another end of said first switch and another end connected to said common input terminal;
a resonant capacitor with one end connected to said another end of said first switch;
a primary winding of an isolation transformer with a dot-marked end connected to another end of said resonant capacitor and another end connected to said common input terminal;
a first resonant inductor with one end connected to said output terminal;
a first current rectifier switch with a cathode end connected to another end of said first resonant inductor;
a second current rectifier switch with an anode end connected to said common output terminal;
a second resonant inductor with one end connected to an anode end of said first current rectifier switch and another end connected to a cathode end of said second current rectifier switch;
a secondary capacitor with one and connected to said anode end of said first current rectifier switch;
a secondary winding of said isolation transformer with a dot-marked end connected to another end of said secondary capacitor and another end connected to said common output terminal;
switching means for keeping said first switch ON and said second switch OFF during T_{ON} time interval DT_{S}, and keeping said first switch OFF and said second switch ON during T_{OFF} time interval (1−Dₙ)T_{S}, where T_{ON} and T_{OFF} are complementary time intervals within one switch operating cycle T_{S} and where D is a controllable duty ratio;
wherein said resonant capacitor has capacitance value significantly smaller than capacitance of said secondary capacitor;
wherein said first resonant inductor and said resonant capacitor form a first resonant circuit during said T_{ON} time interval and define a first resonant frequency and corresponding first resonant period;
wherein said second resonant inductor and said resonant capacitor form a second resonant circuit during said T_{OFF} time interval and define a second resonant frequency and corresponding second resonant period;
wherein sum of one half of said first resonant period plus one half of said second resonant period is equal to said operating cycle T_{S};
wherein a nominal duty ratio Dₙ is set to make a nominal ON-time interval DₙT_{S} equal to said one half of said first resonant period;
wherein during said nominal ON-time interval DₙT_{S} only one-half of a positive half-sinusoidal resonant current of said first resonant circuit flows from said DC source into said DC load;
wherein during a nominal OFF-time interval (1−Dₙ)T_{S} only one-half of a positive half-sinusoidal resonant current of said second resonant circuit flows from said DC source into said DC load;
wherein said controllable duty ratio D could be changed from said nominal duty ratio Dₙ down to zero, or up to one;
wherein a turns ratio of said isolation transformer is a number of turns of said primary winding divided by number of turns of said secondary winding;
whereby said converter operating at said nominal duty ratio Dₙ has a DC voltage conversion ratio equal to said turns ratio of said isolation transformer;
whereby said DC voltage conversion ratio is continuously controlled by changing said controllable duty ratio D;
whereby voltage stresses on said first switch and said second switch are equal to voltage of said DC voltage source;
whereby voltage stresses on said first current rectifier switch and said second current rectifier switch are equal to voltage of said DC load;
whereby at said nominal duty ratio Dₙ all switches are turned ON and turned OFF at zero current level with no switching losses;
whereby said isolation transformer does not store energy at any operating duty ratio D and does not have an air-gap;
whereby flux density of said isolation transformer is significantly smaller compared to isolation transformers flux density of other converters.

13. An isolated switching DC-to-DC converter for providing power from a DC voltage source connected between an input terminal and a common input terminal to a DC load connected between an output terminal and a common output terminal, having three identical modules, a first module, a second module, and a third module, each of said three identical modules comprising:
a first switch with one end connected to said input terminal;
a second switch with one end connected to another end of said first switch and another end connected to said common input terminal;
a first resonant capacitor with one end connected to said input terminal;
a second resonant capacitor with one end connected to another end of said first resonant capacitor and another end connected to said common input terminal;
a resonant inductor with one end connected to said another end of said first resonant capacitor;
a primary winding of an isolation transformer with a dot-marked end connected to said one end of said second switch and another end connected to another end of said resonant inductor;
a third resonant capacitor with one end connected to said output terminal;
a fourth resonant capacitor with one end connected to another end of said third capacitor and another end connected to said common output terminal;
a third switch with one end connected to said output terminal;
a fourth switch with one end connected to another end of said third switch and another end connected to said common output terminal;
a secondary winding of said isolation transformer with dot-marked end connected to said one end of said fourth switch and another end connected to said one end of said fourth resonant capacitor;
switching means for keeping said first switch and said third switch ON and said second switch and said fourth switch OFF during T_{ON} time interval DT_{S}, and keeping said first switch and said third switch OFF and said second switch and said fourth switch ON during T_{OFF} time interval (1−Dₙ)T_{S}, where T_{ON} and T_{OFF} are complementary time intervals within one switch operating cycle T_{S} and where D is a controllable duty ratio;
wherein switch timing by said switching means of said three identical modules is as follows:
said first switch and said third switch of said second module are turned ON after one-third of said operating cycle T_{S} from the moment when said first switch and said third switch of said first module were turned ON, and said first switch and said third switch of said third module are turned ON after one-third of said operating cycle T_{S} from the moment when said first switch and said third switch of said second module were turned ON;
wherein said first resonant capacitor, said second resonant capacitor, said third resonant capacitor, and said fourth resonant capacitor form an equivalent resonant capacitor during said T_{ON} time interval and during said T_{OFF} time interval;
wherein said resonant inductor and said equivalent resonant capacitor form a resonant circuit during said T_{ON} time interval and during said T_{OFF} time interval and define a resonant frequency and corresponding resonant period;
wherein said resonant period is equal to said operating cycle T_{S};
wherein a nominal duty ratio Dₙ, is set to make a nominal ON-time interval DₙT_{S} equal to one half of said resonant period;
wherein during said nominal ON-time interval DₙT_{S} only one-half of a positive half-sinusoidal resonant current of said resonant circuit flows from said DC source into said DC load;
wherein during a nominal OFF-time interval (1−Dₙ)T_{S} only one-half of a negative half-sinusoidal resonant current of said resonant circuit flows from said DC source into said DC load;
wherein said positive half-sinusoidal resonant current and said negative half-sinusoidal resonant current form a composite resonant current during said operating cycle T_{S};
wherein said composite resonant current of said second module lags said composite resonant current of said first module by one-third of said operating cycle T_{S} and said composite resonant current of said third module lags said composite resonant current of said second module by one-third of said operating cycle T_{S};
whereby three said composite resonant currents form a three-phase composite resonant current system;
whereby a load current of said DC load is one-half of a rectified current of said three-phase composite resonant current system with small current ripple;
whereby a source current of said DC voltage source is one-half of a rectified current of said three-phase composite resonant current system with small current ripple;
wherein said controllable duty ratio D could be changed from said nominal duty ratio Dₙ to control and reduce a DC voltage on said DC load;
wherein a turns ratio of said isolation transformer is a number of turns of said primary winding divided by number of turns of said secondary winding;
whereby said converter operating at said nominal duty ratio Dₙ has a DC voltage conversion ratio equal to said turns ratio of said isolation transformer;
whereby said DC voltage conversion ratio is continuously controlled and reduced by changing said controllable duty ratio D;
whereby voltage stresses on said first switch and said second switch are equal to voltage of said DC voltage source;
whereby voltage stresses on said third switch and said fourth switch are equal to voltage of said DC load;
whereby at said nominal duty ratio Dₙ all switches are turned ON and turned OFF at zero current level with no switching losses;
whereby said isolation transformer does not store energy at any operating duty ratio D and does not have an air-gap;
whereby flux density of said isolation transformer is significantly smaller compared to isolation transformers flux density of other converters.

14. An isolated switching converter as defined in claim 13,
wherein said first switch and said second switch are semiconductor MOSFET transistors, and
wherein said third switch and said fourth switch are semiconductor current rectifiers (diodes).

15. An isolated switching converter as defined in claim 14,
wherein said semiconductor current rectifiers are semiconductor MOSFET transistors.

16. An isolated switching converter as defined in claim 13,
wherein said DC load is another DC voltage source;
wherein said switching means and said switch timing could also provide power flow from said another DC voltage source to said DC voltage source, and
whereby converter operates as a bi-directional isolated switching converter.

17. An isolated switching converter as defined in claim 13,
wherein said second resonant inductor is removed and said anode end of said second current rectifier switch connected to said common output terminal;
wherein said second resonant inductor is inserted in series with said secondary winding of said isolation transformer;
wherein said first resonant inductor, said second resonant inductor, and said resonant capacitor form a first resonant circuit during said T_{ON} time interval and define a first resonant frequency and corresponding first resonant period, and
wherein said second resonant inductor and said resonant capacitor form a second resonant circuit during said T_{OFF} time interval and define a second resonant frequency and corresponding second resonant period.

18. An isolated switching DC-to-DC converter for providing power from a DC voltage source connected between an input terminal and a common input terminal to a DC load connected between an output terminal and a common output terminal, said converter comprising:
an input inductor with one end connected to said input terminal;
an input switch with one end connected to another end of said input inductor and another end connected to said common input terminal;
an input current rectifier with an anode end connected to said another end of said input inductor;
an input capacitor with one end connected to a cathode end of said input current rectifier and another end connected to said common input terminal;
a first switch with one end connected to said one end of said input capacitor;
a second switch with one end connected to another end of said first switch and another end connected to said common input terminal;
a resonant capacitor with one end connected to said another end of said first switch;
a resonant inductor with one end connected to another end of said resonant capacitor;
a primary winding of an isolation transformer with a dot-marked end connected to another end of said resonant inductor and another end connected to said common input terminal;
a first output capacitor with one end connected to said output terminal;
a second output capacitor with one end connected to another end of said first output capacitor and another end connected to said common output terminal;
a third switch with one end connected to said output terminal;
a fourth switch with one end connected to said common output terminal and another end connected to another end of said third switch;
a secondary winding of said isolation transformer with dot-marked end connected to said another end of said third switch and another end connected to said one end of said second output capacitor;
switching means for keeping said first switch and said third switch ON and said second switch and said fourth switch OFF during T_{ON} time interval DT_{S}, and keeping said first switch and said third switch OFF and said second switch and said fourth switch ON during T_{OFF} time interval (1−D)T_{S}, where T_{ON} and T_{OFF} are complementary time intervals within one switch operating cycle T_{S} and where D is a controllable duty ratio;
wherein said first switch, said second switch, said third switch, and said fourth switch are semiconductor MOSFET transistors;
wherein said resonant capacitor has capacitance value significantly smaller than capacitance of said first output capacitor and said second output capacitor;
wherein said resonant inductor and said resonant capacitor form a resonant circuit during said T_{ON} time interval and during said T_{OFF} time interval and define a resonant frequency and corresponding resonant period;
wherein said resonant period is equal to said operating cycle T_{S};
wherein a nominal duty ratio Dₙ is set to make a nominal ON-time interval DₙT_{S} equal to one half of said operating cycle T_{S};
wherein during said nominal ON-time interval DₙT_{S} and said nominal OFF-time interval (1−Dₙ)T_{S} only one-half of said resonant current flows from said DC source into said DC load;
wherein said controllable duty ratio D could be changed from said nominal duty ratio Dₙ down to zero, or up to one;
wherein a turns ratio of said isolation transformer is a number of turns of said primary winding divided by number of turns of said secondary winding;
whereby said converter operating at said nominal duty ratio Dₙ has a DC voltage conversion ratio equal to said turns ratio of said isolation transformer;
whereby said DC voltage conversion ratio is continuously controlled by changing said controllable duty ratio D;
whereby voltage stresses on said first switch and said second switch are equal to voltage of said DC voltage source;
whereby voltage stresses on said third switch and said fourth switch are equal to voltage of said DC load;
whereby at said nominal duty ratio Dₙ all switches are turned ON and turned OFF at zero current level with no switching losses;
whereby said isolation transformer does not store energy at any operating duty ratio D and does not have an air-gap,
whereby flux density of said isolation transformer is significantly smaller compared to isolation transformers flux density of other converters, and
whereby said converter maintains constant voltage on said DC load during nominal operation, during fast load transients on said DC load, and during short voltage drops on said DC voltage source.
